(19) United States
(12) Patent Application Publication
(10) Pub. No.: US 2024/0329364 A1
(43) Pub. Date: Oct. 3, 2024

(54) IMAGING LENS AND IMAGING APPARATUS

(71) Applicant: SONY SEMICONDUCTOR SOLUTIONS CORPORATION, Kanagawa (JP)

(72) Inventors: Keiji Matsusaka, Kanagawa (JP); Shinichiro Noudo, Kanagawa (JP); Kensuke Suzuki, Kanagawa (JP); Koji Miyata, Kanagawa (JP); Katsuji Kimura, Kanagawa (JP); Toshihito Iwase, Kanagawa (JP)

(73) Assignee: SONY SEMICONDUCTOR SOLUTIONS CORPORATION, Kanagawa (JP)

(21) Appl. No.: 18/605,009

(22) Filed: Mar. 14, 2024

Related U.S. Application Data
(60) Provisional application No. 63/456,098, filed on Mar. 31, 2023.

(51) Int. Cl. G02B 13/00; H04N 23/55; H04N 23/698

(52) U.S. Cl. CPC G02B 13/0045; H04N 23/55; H04N 23/698

(57) ABSTRACT

Imaging of, with height reduction, a high-quality image with a maximum angle of view of 90 degrees or larger is realized. A lens group forms an optical image of an object on a curved imaging surface. The maximum angle of view is 90 degrees or larger. When a first imaging height half angle of view is 40 degrees and is denoted by Yw, a second imaging height that is a half of the maximum angle of view is denoted by Y, a total optical length is denoted by TL, a focal length of the entire imaging lens is denoted by f, and a focal length of the lens closest to the object is denoted by f1, the following are satisfied: 0.27≤(Yw/Y)²≤0.7, 0.3≤TL/2Y≤0.695, −0.35≤f/f1≤0.73. The present technology can be applied to an ultrawide-angle camera or the like.

### CROSS REFERENCE TO RELATED APPLICATIONS

This application claims the benefit of U.S. Provisional Patent Application Ser. No. 63/456,098, filed Mar. 31, 2023, the entire disclosure of which is hereby incorporated herein by reference.

### TECHNICAL FIELD

The present technology relates to an imaging lens and an imaging apparatus, and more particularly, to an imaging lens and an imaging apparatus capable of realizing imaging of, with height reduction, a high-quality image with a maximum angle of view of 90 degrees or larger.

### BACKGROUND ART

At present, a smartphone equipped with a multi-lens camera (multi-camera) including a main camera such as a standard camera or a wide-angle camera (Wide) and a sub-camera such as an ultrawide-angle camera (Ultra-Wide) or a telecamera (Tele) is widely used.

In such a multi-lens camera, in particular, in an ultrawide-angle camera having a maximum angle of view of 90 degrees or larger, it is difficult to increase a size of an image sensor and improve image quality of a captured image due to restrictions on a total optical length or the like for slimmer smartphones.

Meanwhile, an imaging apparatus having a curved imaging surface has been provided (see, for example, PTL 1).

### CITATION LIST

### Patent Literature

### [PTL 1]

WO 2013/027641

### SUMMARY

### Technical Problem

As described above, in a mobile terminal such as a smartphone, it is difficult to increase a size of an image sensor of an ultrawide-angle camera and improve image quality of a captured image due to restrictions on the total optical length or the like. Hence, there is a demand for a technology for realizing imaging of, with height reduction, a high quality image with a maximum angle of view of 90 degrees or larger, but such a demand has not been sufficiently met.

The present technology has been made in view of such a situation, and it is desirable to realize imaging of, with height reduction, a high-quality image with a maximum angle of view of 90 degrees or larger.

### Solution to Problem

An imaging lens according to a first embodiment of the present technology includes: a lens group of one or more lenses which forms an optical image of an object on an imaging surface having a curved shape. A maximum angle of view is 90 degrees or larger. When a first imaging height that is an imaging height in a case where a half angle of view is 40 degrees is denoted by Yw, a second imaging height that is an imaging height in a case of a maximum half view angle which is a half of the maximum angle of view is denoted by Y, a total optical length that is a distance on an optical axis from an object-side surface of a lens closest to an object in the lens group to the imaging surface is denoted by TL, a focal length of the entire imaging lens is denoted by f, and a focal length of the lens closest to the object is denoted by f1, the following expressions are satisfied.

$$0.27 \leq {( Yw / Y )}^{2} \leq 0.7$$

$$0.3 \leq TL / 2 Y \leq 0.695$$

$$- 0.35 \leq f / f 1 \leq 0.73$$

In the first embodiment of the present technology, the lens group of one or more lenses which forms the optical image of the object on the imaging surface having the curved shape is provided. The maximum angle of view is 90 degrees or larger. When the first imaging height that is the imaging height in the case where the half angle of view is 40 degrees is denoted by Yw, the second imaging height that is the imaging height in the case of the maximum half view angle which is a half of the maximum angle of view is denoted by Y, the total optical length that is the distance on the optical axis from the object-side surface of the lens closest to the object in the lens group to the imaging surface is denoted by TL, the focal length of the entire imaging lens is denoted by f, and the focal length of the lens closest to the object is denoted by f1, the following expressions are satisfied.

$$0.27 \leq {( Yw / Y )}^{2} \leq 0.7$$

$$0.3 \leq TL / 2 Y \leq 0.695$$

$$- 0.35 \leq f / f 1 \leq 0.73$$

An imaging apparatus according to a second embodiment of the present technology includes: an imaging lens include a lens group of one or more lenses which forms an optical image of an object on an imaging surface having a curved shape, have a maximum angle of view of 90 degrees or larger, and satisfy the following expressions, when a first imaging height that is an imaging height in a case where a half angle of view is 40 degrees is denoted by Yw, a second imaging height that is an imaging height in a case of a maximum half view angle which is a half of the maximum angle of view is denoted by Y, a total optical length that is a distance on an optical axis from an object-side surface of a lens closest to an object in the lens group to the imaging surface is denoted by TL, a focal length of the entire imaging lens is denoted by f, and a focal length of the lens closest to the object is denoted by f1; and an imaging element having the imaging surface. The imaging surface has a pixel array portion formed to include a plurality of pixels. Each of the pixels has one or more photoelectric conversion units that convert light corresponding to the optical image formed on the imaging surface into a charge and outputs an electrical signal corresponding to the charge.

$$0.27 \leq {( Yw / Y )}^{2} \leq 0.7$$

$$0.3 \leq TL / 2 Y \leq 0.695$$

$$- 0.35 \leq f / f 1 \leq 0.73$$

In the second embodiment of the present technology, the imaging lens and the imaging element are provided. The imaging lens includes the lens group of one or more lenses which forms the optical image of the object on the imaging surface having the curved shape, and the maximum angle of view is 90 degrees or larger. When the first imaging height that is the imaging height in the case where the half angle of view is 40 degrees is denoted by Yw, the second imaging height that is the imaging height in the case of the maximum half view angle which is a half of the maximum angle of view is denoted by Y, the total optical length that is the distance on the optical axis from the object-side surface of the lens closest to the object in the lens group to the imaging surface is denoted by TL, the focal length of the entire imaging lens is denoted by f, and the focal length of the lens closest to the object is denoted by f1, the following expressions are satisfied.

$$0.27 \leq {( Yw / Y )}^{2} \leq 0.7$$

$$0.3 \leq TL / 2 Y \leq 0.695$$

$$- 0.35 \leq f / f 1 \leq 0.73$$

The imaging element has the imaging surface. The imaging surface has a pixel array portion formed to include a plurality of pixels. Each of the pixels has one or more photoelectric conversion units that convert light corresponding to the optical image formed on the imaging surface into a charge and outputs an electrical signal corresponding to the charge.

An imaging lens according to a third embodiment of the present technology includes a lens group of one or more lenses which forms an optical image of an object on an imaging surface having a curved shape. A maximum angle of view is 90 degrees or larger. When a first imaging height that is an imaging height in a case where a half angle of view is 40 degrees is denoted by Yw, a second imaging height that is an imaging height in a case of a maximum half view angle which is a half of the maximum angle of view is denoted by Y, a total optical length that is a distance on an optical axis from an object-side surface of a lens closest to an object in the lens group to the imaging surface is denoted by TL, and optical distortion at the first imaging height is denoted by Dw, the following expressions are satisfied.

$$0.27 \leq {( Yw / Y )}^{2} \leq 0.7$$

$$0.3 \leq TL / 2 Y \leq 0.6 \; 95$$

$$0.001 \leq \vert Dw / Yw \vert \leq 0.08$$

In the third embodiment of the present technology, the lens group of one or more lenses which forms the optical image of the object on the imaging surface having the curved shape is provided. The maximum angle of view is 90 degrees or larger. When a first imaging height that is an imaging height in a case where a half angle of view is 40 degrees is denoted by Yw, a second imaging height that is an imaging height in a case of a maximum half view angle which is a half of the maximum angle of view is denoted by Y, a total optical length that is a distance on an optical axis from an object-side surface of a lens closest to an object in the lens group to the imaging surface is denoted by TL, and optical distortion at the first imaging height is denoted by Dw, the following expressions are satisfied.

$$0.27 \leq {( Yw / Y )}^{2} \leq 0.7$$

$$0.3 \leq TL / 2 Y \leq 0 \text{.695}$$

$$0.001 \leq \vert Dw / Yw \vert \leq 0.08$$

An imaging apparatus according to a fourth embodiment of the present technology includes: an imaging lens configured to include a lens group of one or more lenses which forms an optical image of an object on an imaging surface having a curved shape, have a maximum angle of view of 90 degrees or larger, and satisfy the following expressions, when a first imaging height that is an imaging height in a case where a half angle of view is 40 degrees is denoted by Yw, a second imaging height that is an imaging height in a case of a maximum half view angle which is a half of the maximum angle of view is denoted by Y, a total optical length that is a distance on an optical axis from an object-side surface of a lens closest to an object in the lens group to the imaging surface is denoted by TL, and optical distortion at the first imaging height is denoted by Dw; and an imaging element having the imaging surface. The imaging surface has a pixel array portion formed to include a plurality of pixels. Each of the pixels has one or more photoelectric conversion units that convert light corresponding to the optical image formed on the imaging surface into a charge and outputs an electrical signal corresponding to the charge.

$$0.2 7 \leq {( Yw / Y )}^{2} \leq 0.7$$

$$0. 3 \leq TL / 2 Y \leq 0 \text{.695}$$

$$0. 001 \leq \vert Dw / Yw \vert \leq 0.08$$

In the fourth embodiment of the present technology, the imaging lens and the imaging element are provided. The imaging lens includes the lens group of one or more lenses which forms the optical image of the object on the imaging surface having the curved shape, and the maximum angle of view is 90 degrees or larger. When a first imaging height that is an imaging height in a case where a half angle of view is 40 degrees is denoted by Yw, a second imaging height that is an imaging height in a case of a maximum half view angle which is a half of the maximum angle of view is denoted by Y, a total optical length that is a distance on an optical axis from an object-side surface of a lens closest to an object in the lens group to the imaging surface is denoted by TL, and optical distortion at the first imaging height is denoted by Dw, the following expressions are satisfied.

$$0.27 \leq {( Yw / Y )}^{2} \leq 0.7$$

$$0.3 \leq TL / 2 Y \leq 0 \text{.695}$$

$$0.001 \leq \vert Dw / Yw \vert \leq 0.08$$

The imaging element has the imaging surface. The imaging surface has a pixel array portion formed to include a plurality of pixels. Each of the pixels has one or more photoelectric conversion units that convert light corresponding to the optical image formed on the imaging surface into a charge and outputs an electrical signal corresponding to the charge.

### BRIEF DESCRIPTION OF DRAWINGS

FIGS. 1A and 1B are views illustrating an external configuration example of a smartphone including an ultrawide-angle camera that is a first embodiment of an imaging apparatus to which the present technology is applied.

FIG. 2 is a diagram illustrating a configuration example of the ultrawide-angle camera in FIGS. 1A and 1B.

FIG. 3 is a diagram illustrating a configuration example of an imaging element.

FIG. 4 is a diagram illustrating a circuit configuration example of a pixel.

FIG. 5 is a cross-sectional view illustrating a structure example of the imaging element.

FIG. 6 is a top view of the imaging element illustrating an array example of pixels in FIG. 3.

FIGS. 7A and 7B are diagrams illustrating effects of the imaging element.

FIGS. 8A and 8B are diagrams illustrating examples of evaluation values of a same-color sensitivity difference.

FIG. 9 is a view illustrating examples of FOVs of an ultrawide-angle image and a wide-angle image.

FIG. 10 is a view illustrating a method of reading an electrical signal in each imaging mode.

FIG. 11 is a graph illustrating a relationship between a zoom magnification and resolution of a captured image.

FIG. 12 is a top view illustrating a detailed structure example of a base.

FIGS. 13A to 13C are views for illustrating an example of a method of performing adhesion of the imaging element.

FIGS. 14A and 14B are views for illustrating types of imaging lenses.

FIG. 15 is a cross-sectional view illustrating a first configuration example of an imaging lens.

FIG. 16 is a table illustrating examples of various setting values of the entire imaging lens in FIG. 15.

FIG. 17 is a table illustrating examples of various setting values of each lens, an aperture stop, an infrared cut filter, and an imaging surface in FIG. 15.

FIG. 18 is a table illustrating an example of aspherical data of each surface in FIG. 15.

FIG. 19 illustrates graphs of examples of spherical aberration, field curvature, and distortion occurring in the imaging lens in FIG. 15.

FIG. 20 illustrates graphs of examples of lateral aberration occurring in the imaging lens in FIG. 15.

FIG. 21 is a cross-sectional view illustrating a second configuration example of the imaging lens.

FIG. 22 is a table illustrating examples of various setting values of the entire imaging lens in FIG. 21.

FIG. 23 is a table illustrating examples of various setting values of each lens, an aperture stop, an infrared cut filter, and an imaging surface in FIG. 21.

FIG. 24 is a table illustrating an example of aspherical data of each surface in FIG. 21.

FIG. 25 illustrates graphs of examples of spherical aberration, field curvature, and distortion occurring in the imaging lens in FIG. 21.

FIG. 26 illustrates graphs of examples of lateral aberration occurring in the imaging lens in FIG. 21.

FIG. 27 is a cross-sectional view illustrating a third configuration example of the imaging lens.

FIG. 28 is a table illustrating examples of various setting values of the entire imaging lens in FIG. 27.

FIG. 29 is a table illustrating examples of various setting values of each lens, an aperture stop, an infrared cut filter, and an imaging surface in FIG. 27.

FIG. 30 is a table illustrating an example of aspherical data of each surface in FIG. 27.

FIG. 31 illustrates graphs of examples of spherical aberration, field curvature, and distortion occurring in the imaging lens in FIG. 27.

FIG. 32 illustrates graphs of examples of lateral aberration occurring in the imaging lens in FIG. 27.

FIG. 33 is a cross-sectional view illustrating a fourth configuration example of the imaging lens.

FIG. 34 is a table illustrating examples of various setting values of the entire imaging lens in FIG. 33.

FIG. 35 is a table illustrating examples of various setting values of each lens, an aperture stop, an infrared cut filter, and an imaging surface in FIG. 33.

FIG. 36 is a table illustrating an example of aspherical data of each surface in FIG. 33.

FIG. 37 illustrates graphs of examples of spherical aberration, field curvature, and distortion occurring in the imaging lens in FIG. 33.

FIG. 38 illustrates graphs of examples of lateral aberration occurring in the imaging lens in FIG. 33.

FIG. 39 is a cross-sectional view illustrating a fifth configuration example of the imaging lens.

FIG. 40 is a table illustrating examples of various setting values of the entire imaging lens in FIG. 39.

FIG. 41 is a table illustrating examples of various setting values of each lens, an aperture stop, an infrared cut filter, and an imaging surface in FIG. 39.

FIG. 42 is a table illustrating an example of aspherical data of each surface and the imaging surface in FIG. 39.

FIG. 43 illustrates graphs of examples of spherical aberration, field curvature, and distortion occurring in the imaging lens in FIG. 39.

FIG. 44 illustrates graphs of examples of lateral aberration occurring in the imaging lens in FIG. 39.

FIG. 45 is a cross-sectional view illustrating a sixth configuration example of the imaging lens.

FIG. 46 is a table illustrating examples of various setting values of the entire imaging lens in FIG. 45.

FIG. 47 is a table illustrating examples of various setting values of each lens, an aperture stop, an infrared cut filter, and an imaging surface in FIG. 45.

FIG. 48 is a table illustrating an example of aspherical data of each surface in FIG. 45.

FIG. 49 illustrates graphs of examples of spherical aberration, field curvature, and distortion occurring in the imaging lens in FIG. 45.

FIG. 50 illustrates graphs of examples of lateral aberration occurring in the imaging lens in FIG. 45.

FIG. 51 is a cross-sectional view illustrating a seventh configuration example of the imaging lens.

FIG. 52 is a table illustrating examples of various setting values of the entire imaging lens in FIG. 51.

FIG. 53 is a table illustrating examples of various setting values of each lens, an aperture stop, an infrared cut filter, and an imaging surface in FIG. 51.

FIG. 54 is a table illustrating an example of aspherical data of each surface in FIG. 51.

FIG. 55 illustrates graphs of examples of spherical aberration, field curvature, and distortion occurring in the imaging lens in FIG. 51.

FIG. 56 illustrates graphs of examples of lateral aberration occurring in the imaging lens in FIG. 51.

FIG. 57 is a cross-sectional view illustrating an eighth configuration example of the imaging lens.

FIG. 58 is a table illustrating examples of various setting values of the entire imaging lens in FIG. 57.

FIG. 59 is a table illustrating examples of various setting values of each lens, an aperture stop, an infrared cut filter, and an imaging surface in FIG. 57.

FIG. 60 is a table illustrating an example of aspherical data of each surface in FIG. 57.

FIG. 61 illustrates graphs of examples of spherical aberration, field curvature, and distortion occurring in the imaging lens in FIG. 57.

FIG. 62 illustrates graphs of examples of lateral aberration occurring in the imaging lens in FIG. 57.

FIG. 63 is a cross-sectional view illustrating a ninth configuration example of the imaging lens.

FIG. 64 is a table illustrating examples of various setting values of the entire imaging lens in FIG. 63.

FIG. 65 is a table illustrating examples of various setting values of each lens, an aperture stop, an infrared cut filter, and an imaging surface in FIG. 63.

FIG. 66 is a table illustrating an example of aspherical data of each surface in FIG. 63.

FIG. 67 illustrates graphs of examples of spherical aberration, field curvature, and distortion occurring in the imaging lens in FIG. 63.

FIG. 68 illustrates graphs of examples of lateral aberration occurring in the imaging lens in FIG. 63.

FIG. 69 is a cross-sectional view illustrating a tenth configuration example of the imaging lens.

FIG. 70 is a table illustrating examples of various setting values of the entire imaging lens in FIG. 69.

FIG. 71 is a table illustrating examples of various setting values of each lens, an infrared cut filter, and an imaging surface in FIG. 69.

FIG. 72 is a table illustrating an example of aspherical data of each surface in FIG. 69.

FIG. 73 illustrates graphs of examples of spherical aberration, field curvature, and distortion occurring in the imaging lens in FIG. 69.

FIG. 74 illustrates graphs of examples of lateral aberration occurring in the imaging lens in FIG. 69.

FIG. 75 is a cross-sectional view illustrating an eleventh configuration example of the imaging lens.

FIG. 76 is a table illustrating examples of various setting values of the entire imaging lens in FIG. 75.

FIG. 77 is a table illustrating examples of various setting values of each lens, an aperture stop, an infrared cut filter, and an imaging surface in FIG. 75.

FIG. 78 is a table illustrating an example of aspherical data of each surface in FIG. 75.

FIG. 79 illustrates graphs of examples of spherical aberration, field curvature, and distortion occurring in the imaging lens in FIG. 75.

FIG. 80 illustrates graphs of examples of lateral aberration occurring in the imaging lens in FIG. 75.

FIG. 81 is a cross-sectional view illustrating a twelfth configuration example of the imaging lens.

FIG. 82 is a table illustrating examples of various setting values of the entire imaging lens in FIG. 81.

FIG. 83 is a table illustrating examples of various setting values of each lens, an aperture stop, an infrared cut filter, and an imaging surface in FIG. 81.

FIG. 84 is a table illustrating an example of aspherical data of each surface in FIG. 81.

FIG. 85 illustrates graphs of examples of spherical aberration, field curvature, and distortion occurring in the imaging lens in FIG. 81.

FIG. 86 illustrates graphs of examples of lateral aberration occurring in the imaging lens in FIG. 81.

FIG. 87 is a table illustrating values of parameters or expressions in the imaging lens.

FIGS. 88A to 88E are top views of the imaging element illustrating other examples of the array of pixels in FIG. 3.

FIGS. 89A and 89B are views illustrating an external configuration example of a smartphone including an ultrawide-angle camera that is a second embodiment of the imaging apparatus to which the present technology is applied.

FIG. 90 is a diagram illustrating a configuration example of an ultrawide-angle sensor that is a third embodiment of the imaging apparatus to which the present technology is applied.

FIG. 91 is a top view illustrating a configuration example of an imaging element in FIG. 90.

FIGS. 92A to 92F are graphs illustrating effects of the imaging element in FIG. 90.

FIGS. 93A to 93C are top views illustrating other configuration examples of the imaging element in FIG. 90.

FIG. 94 is a block diagram illustrating an example of a schematic configuration of a vehicle control system.

FIG. 95 is an explanatory diagram illustrating an example of an installation position of an imaging section.

### DESCRIPTION OF EMBODIMENTS

A mode for carrying out the present technology (hereinafter, referred to as an embodiment) is hereinafter described. Note that the description will be made in the following order.
1. First Embodiment (Smartphone Configured of Combination of Ultrawide-Angle Camera and Wide-Angle Camera)
2. Second Embodiment (Smartphone Including Ultrawide-Angle Camera and Wide-Angle Camera Individually)
3. Third Embodiment (Ultrawide-Angle Sensor That Generates Ultrawide-Angle Phase-Contrast Image)
4. Example of Application to Mobile Body

Note that the same or similar portions are denoted by the same or similar reference signs in the drawings referred to in the following description. However, the drawings are schematic, and the relationship between the thickness and the plane dimension, the ratio of the thickness of each layer, and the like are different from the actual ones. Furthermore, the drawings may include portions having different dimensional relationships and ratios. Furthermore, definition of directions such as upward and downward directions, and the like in the following description is merely the definition for convenience of description, and does not limit the technical idea of the present disclosure. For example, when an object is rotated by 90° to be observed, the upper and lower sides are changed as the left and right sides, and when the object is rotated by 180° to be observed, the upper and lower sides are reversed.

### 1. First Embodiment

### External Configuration Example of Smartphone

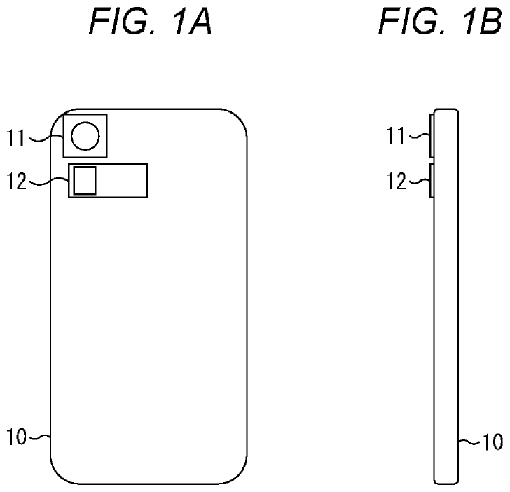

FIGS. 1A and 1B are views illustrating an external configuration example of a smartphone including an ultrawide-angle camera that is a first embodiment of an imaging apparatus to which the present technology is applied.

FIG. 1A is a rear view of a smartphone 10, and FIG. 1B is a side view of the smartphone 10.

As illustrated in FIGS. 1A and 1B, the smartphone 10 includes an ultrawide-angle camera 11 and a telephoto camera 12 as a multi-lens camera. The ultrawide-angle camera 11 is a camera configured of a combination of an ultrawide-angle camera and a wide-angle camera. Specifically, the ultrawide-angle camera 11 has, as imaging modes, an ultrawide-angle mode in which an ultrawide-angle image that is a captured image with an angle of view in a range from a first angle to a second angle is captured, and a wide-angle mode in which a wide-angle image that is a captured image with an angle of view smaller than the second angle is captured. The ultrawide-angle camera 11 functions as an ultrawide-angle camera in a case of performing imaging in the ultrawide-angle mode and functions as a wide-angle camera in a case of performing imaging in the wide-angle mode.

Note that the first angle is the maximum angle of view of the ultrawide-angle camera 11 and is 90 degrees or larger. The first angle can be, for example, 120 degrees or 134 degrees. The second angle can be smaller than the first angle, such as 56 degrees, 67 degrees, 80 degrees, or the like. The telephoto camera 12 may be a bending-type telephoto camera in which an optical path is bent with a prism.

As described above, the ultrawide-angle camera 11 of the smartphone 10 has functions of both the ultrawide-angle camera and the wide-angle camera. Hence, the manufacturing costs of the smartphone 10 can be suppressed as compared with a case where the smartphone 10 includes both the ultrawide-angle camera and the wide-angle camera individually. Furthermore, it is possible to prevent the occurrence of unnatural parallax variations due to switching between cameras that performs imaging from one of the ultrawide-angle camera and the wide-angle camera to the other according to a change of a magnification of digital zoom.

### Configuration Example of Ultrawide-Angle Camera

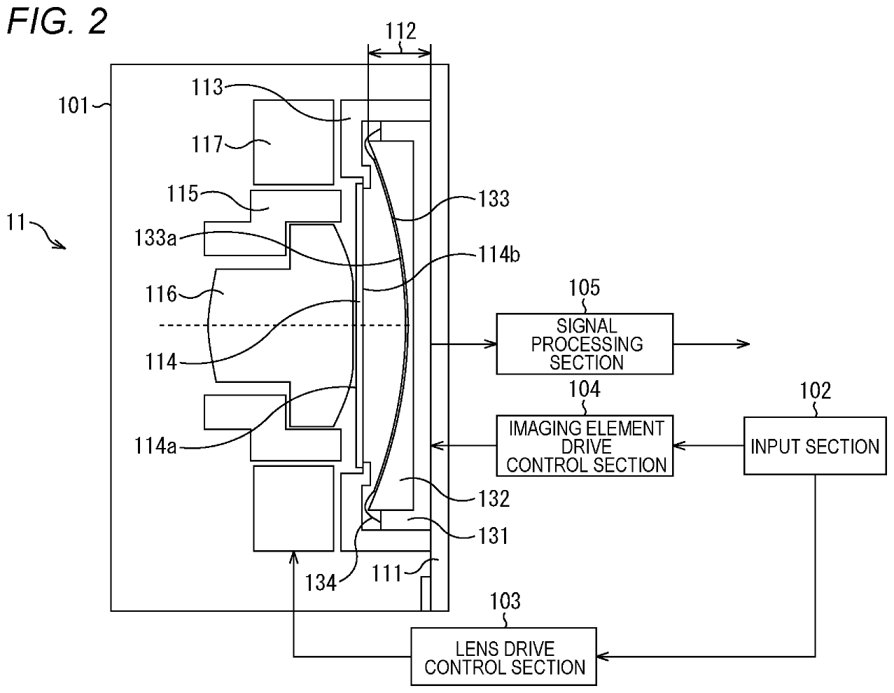

FIG. 2 is a diagram illustrating a configuration example of the ultrawide-angle camera 11 in FIGS. 1A and 1B.

The ultrawide-angle camera 11 in FIG. 2 includes an imaging section 101, an input section 102, a lens drive control section 103, an imaging element drive control section 104, and a signal processing section 105. In FIG. 2, in order to describe a configuration of the imaging section 101, a side cross section including an optical axis of the imaging section 101 is illustrated.

A dotted line in FIG. 2 is the optical axis.

The imaging section 101 includes a circuit board 111, an imaging element unit 112, a filter holder 113, an infrared cut filter 114, a lens holder 115, an imaging lens 116, and an actuator 117.

The circuit board 111 is a flexible printed board. The imaging element unit 112 is packaged and provided on the circuit board 111. The imaging element unit 112 includes a package 131, a base 132, an imaging element 133, and a wire 134.

The package 131 is provided on the circuit board 111 and is electrically connected to the circuit board 111. The base 132 is provided on the package 131 in order to maintain a shape of the imaging element 133 in a shape curved concavely toward an object side (subject side).

An object-side surface of the base 132 is curved concavely toward the object side according to the shape of the imaging element 133. The imaging element 133 adheres to the object-side surface of the base 132. Therefore, both the object-side surface and the base 132-side surface of the imaging element 133 are curved concavely toward the object side.

The imaging element 133 is a charge-coupled device (CCD) sensor or a complementary metal oxide semiconductor (CMOS) image sensor formed on a thin semiconductor substrate and captures an image of an object.

Specifically, an imaging surface 133a is provided on the object-side surface of the imaging element 133. Hence, the imaging surface 133a has a curved shape that is concave toward the object side, that is, curved to fall to the object side from an optical center at an arbitrary position. The imaging surface 133a is desirably formed of a spherical surface which is generally easy to manufacture, but may be formed of an aspherical surface, a free-form surface, or the like depending on design or manufacturing convenience. In a case where the imaging surface 133a is an aspherical surface, a degree of freedom in correcting kinds of aberration including field curvature can be further increased.

On the imaging surface 133a, an optical image of an object is formed by light incident from the object via the imaging lens 116. The imaging element 133 converts light corresponding to the optical image of the object formed on the imaging surface 133a into an electrical signal per pixel and performs AD conversion or the like on the electrical signal, thereby, generating an image signal that is a digital signal.

The imaging element 133 is electrically connected to a circuit formed on a top surface of the package 131 by wire bonding using the wire 134. The image signal generated by the imaging element 133 is supplied to the signal processing section 105 via the circuit of the package 131, the circuit board 111, or the like. The imaging element 133 is driven on the basis of an imaging element drive control signal supplied from the imaging element drive control section 104 via the circuit board 111, a circuit of the package 131, or the like. For example, the imaging element 133 reads an electrical signal of an effective pixel by a method of reading the electrical signal on the basis of the imaging element drive control signal indicating an instruction of the method of reading the electrical signal and the effective pixel which is a pixel from which the electrical signal is read out among all the pixels of the imaging element 133.

The filter holder 113 is formed to surround the periphery of the imaging element unit 112 and holds the infrared cut filter 114. The filter holder 113 fixes the actuator 117.

The infrared cut filter 114 is a parallel flat filter having a surface 114a on the object side and a surface 114b on the imaging surface 133a side. The infrared cut filter 114 transmits light other than infrared light of light emitted from the imaging lens 116 and does not have optical power. The light transmitted through the infrared cut filter 114 is emitted to the imaging surface 133a.

Note that the infrared cut filter 114 may not be provided, or a band pass filter or the like may be provided instead of the infrared cut filter 114. A position of the infrared cut filter 114 can be set to any position that enables the infrared cut filter to be easily formed at the time of manufacturing.

The infrared cut filter 114 may be integrated with a lens constituting the imaging lens 116 or the imaging element 133 by multilayer coating, material addition, or surface application of an infrared absorbent or the like to the lens or the imaging element 133. The infrared cut filter 114 has a film shape and may be integrated with a cover glass (not illustrated), the lens constituting the imaging lens 116, the imaging element 133, or the like by adhering to the cover glass, the lens, the imaging element 133, or the like. In a case where the infrared cut filter 114 is integrated with the cover glass, the lens, the imaging element 133, or the like, it is possible to effectively utilize a space for back focus or to shorten a total optical length of the imaging lens 116.

The lens holder 115 holds the small imaging lens 116 on the object side of the imaging element 133. The imaging lens 116 is an ultrawide-angle lens having a focal length shorter than that of a wide-angle lens having a focal length shorter than 50 mm (in terms of 35 mm), which is about the same as that of human eyes. Specifically, the imaging lens 116 is an ultrawide-angle lens having the maximum angle of view of 90 degrees or larger.

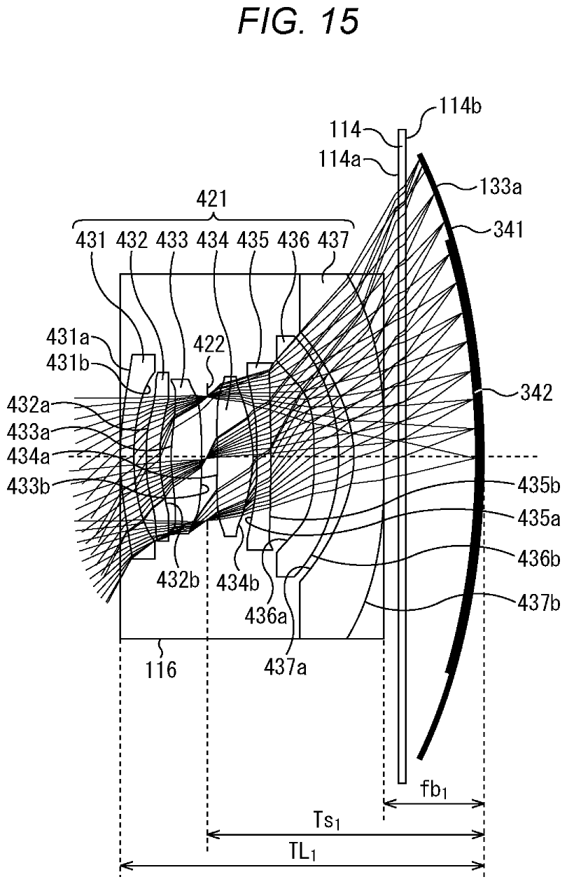

A configuration of the imaging lens 116 will be described with reference to FIGS. 15, 21, 27, 33, 39, 45, 51, 57, 63, 69, 75, and 81 to be described later. The imaging lens 116 collects light from an object and forms an optical image on the imaging surface 133a. The actuator 117 drives a predetermined lens included in the imaging lens 116 in response to a lens drive control signal supplied from the lens drive control section 103.

In the imaging section 101 configured as described above, the light from the object is incident on the imaging surface 133a via the imaging lens 116 and the infrared cut filter 114, and the optical image is formed on the imaging surface 133a. This optical image is converted into an electrical signal by the imaging element 133 and captured.

The input section 102 receives an input from a user or the like and supplies an instruction corresponding to the input to the lens drive control section 103 and the imaging element drive control section 104. For example, the input section 102 receives the input of a magnification of digital zoom from the user and supplies an instruction of the magnification to the imaging element drive control section 104.

The lens drive control section 103 generates a lens drive control signal in response to an instruction from the input section 102 and supplies the lens drive control signal to the actuator 117, thereby driving the imaging lens 116. For example, the lens drive control section 103 generates the lens drive control signal in response to an instruction of an angle of view or the like supplied from the input section 102, thereby driving the imaging lens 116 such that an optical image with the angle of view is formed on the imaging surface 133a.

The imaging element drive control section 104 generates an imaging element drive control signal in response to an instruction from the input section 102. For example, the imaging element drive control section 104 sets the imaging mode to the ultrawide-angle mode or the wide-angle mode on the basis of the instruction of the magnification supplied from the input section 102. The imaging element drive control section 104 generates an imaging element drive control signal on the basis of the imaging mode and the magnification and supplies the imaging element drive control signal to the imaging element 133, thereby driving the imaging element 133.

The signal processing section 105 stores the image signal output from the imaging element 133 in a built-in memory as necessary. The signal processing section 105 (image generating section) performs various types of signal processing such as re-mosaic processing on the image signal and generates and outputs an ultrawide-angle image or a wide-angle image.

The input section 102, the lens drive control section 103, the imaging element drive control section 104, and the signal processing section 105 may be arranged on the circuit board 111 or the package 131 or may be arranged on another board. The substrate of the signal processing section 105 and the semiconductor substrate constituting the imaging element 133 may be stacked.

In the example of FIG. 2, the circuit of the package 131 and the imaging element 133 are electrically connected by wire bonding, but may be electrically connected by a through electrode.

### Configuration Example of Imaging Element

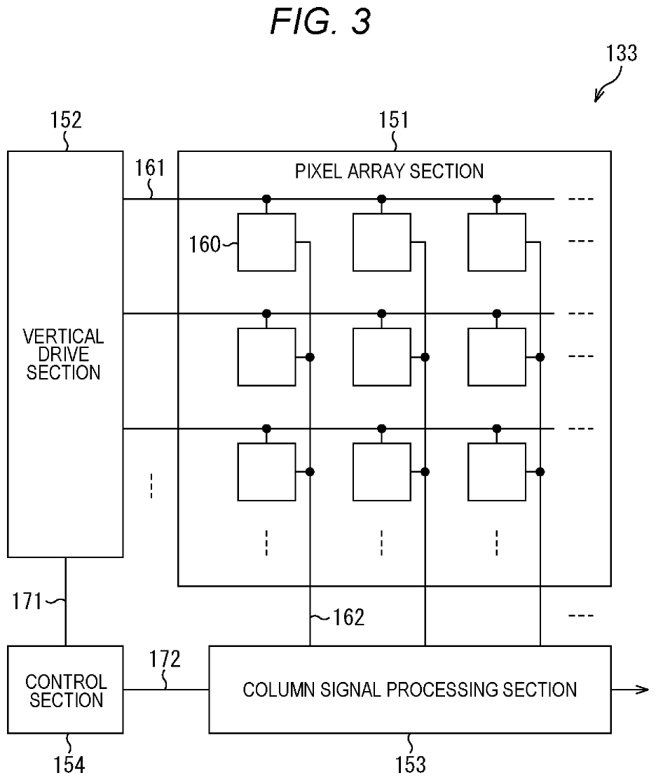

FIG. 3 is a diagram illustrating a configuration example of the imaging element 133 in FIG. 2.

The imaging element 133 in FIG. 3 includes a pixel array portion 151, a vertical drive unit 152, a column signal processing section 153, and a control unit 154.

The pixel array portion 151 is formed on the imaging surface 133a and includes a plurality of pixels 160 arranged in a matrix-like pattern (two-dimensional lattice pattern). The pixel 160 has one photoelectric conversion unit and converts radiated light into a charge. The pixel 160 also has a pixel circuit that generates an electrical signal based on the charge converted by the photoelectric conversion unit. The generation of the electrical signal is controlled by a control signal transmitted from the vertical drive unit 152 via a signal line 161 to be described later.

In the pixel array portion 151, the signal line 161 for transmission of a control signal of a pixel circuit is laid out for each of the pixels 160 on a row basis, and the same signal line 161 is connected to the pixels 160 in the same row. Furthermore, in the pixel array portion 151, a signal line 162 for transmission of an electrical signal generated by the pixel circuit is laid out for each of the pixels 160 on a column basis, and the same signal line 162 is connected to the pixels 160 in the same column. The photoelectric conversion unit and the pixel circuit are formed in a semiconductor substrate.

The vertical drive unit 152 generates the control signals of the pixel circuits of the individual pixels 160 per row and transmits the control signals to the pixels 160 via the signal line 161. The column signal processing section 153 performs various types of processing on the electrical signals transmitted from the individual pixels 160 via the signal lines 162. This processing corresponds to, for example, analog-digital conversion to convert an analog electrical signal generated by the pixel 160 into a digital image signal. The image signal obtained as a result of the processing performed by the column signal processing section 153 is supplied to the signal processing section 105 via the circuit board 111 or the like in FIG. 2.

The control unit 154 controls the entire imaging element 133. Specifically, the control unit 154 generates a control signal to control the vertical drive unit 152 and supplies the control signal to the vertical drive unit 152 via a signal line 171. The control unit 154 generates a control signal to control the column signal processing section 153 and supplies the control signal to the column signal processing section 153 via a signal line 172.

### Circuit Configuration Example of Pixel

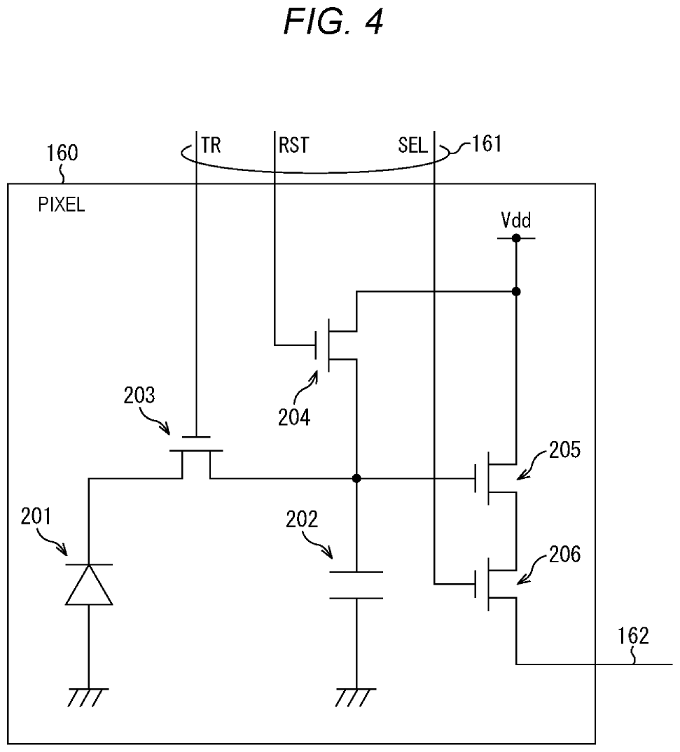

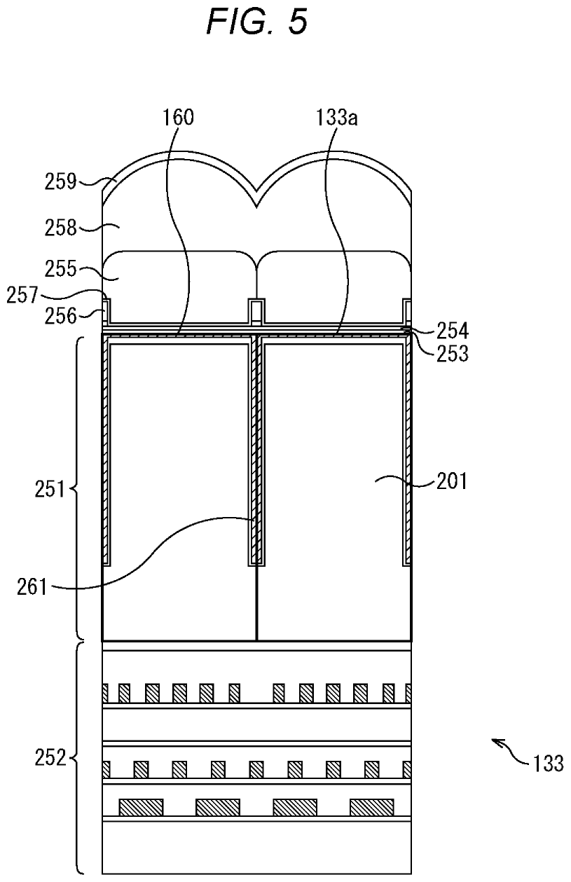

FIG. 4 is a circuit diagram illustrating a circuit configuration example of the pixel 160 in FIG. 3.

The pixel 160 in FIG. 4 includes a photoelectric conversion unit 201, a charge holding unit 202, and MOS transistors 203 to 206.

The photoelectric conversion unit 201 includes a photodiode or the like and generates a charge corresponding to the radiated light. An anode of the photoelectric conversion unit 201 is grounded, and a cathode thereof is connected to a source of the MOS transistor 203.

The charge holding unit 202 and the MOS transistors 203 to 206 constitute the pixel circuit. The charge holding unit 202 includes a capacitor. One end of the charge holding unit 202 is connected to a drain of the MOS transistor 203, a source of the MOS transistor 204, and a gate of the MOS transistor 205. The other end of the charge holding unit 202 is grounded.

A gate of the MOS transistor 203 is connected to a transfer signal line TR of the signal lines 161. A drain of the MOS transistor 204 is connected to a power supply line Vdd, and a gate thereof is connected to a reset signal line RST of the signal lines 161. A drain of the MOS transistor 205 is connected to the power supply line Vdd, and a source thereof is connected to a drain of the MOS transistor 206. A source of the MOS transistor 206 is connected to the signal line 162, and a gate thereof is connected to a selection signal line SEL of the signal lines 161.

In the pixel circuit configured as described above, the MOS transistor 203 transfers the charge generated by the photoelectric conversion unit 201 to the charge holding unit (floating diffusion (FD)) 202 on the basis of the control signal transmitted via the transfer signal line TR. The charge holding unit 202 holds this charge. The MOS transistor 205 generates an electrical signal based on the charge held in the charge holding unit 202. The MOS transistor 206 reads (outputs) the electrical signal to the column signal processing section 153 in FIG. 3 via the signal line 162 on the basis of the control signal transmitted via the selection signal line SEL.

The MOS transistor 204 discharges, on the basis of the control signal transmitted via the reset signal line RST, the charge held in the charge holding unit 202 to the power supply line Vdd before the charge is transferred by the MOS transistor 203. Therefore, the charge holding unit 202 is reset. Note that, at the time of this reset, the photoelectric conversion unit 201 may also be reset by making the MOS transistor 203 conductive. In this manner, the pixel circuit converts a charge generated by the photoelectric conversion unit 201 into an electrical signal.

### Structure Example of Imaging Element

FIG. 5 is a cross-sectional view illustrating a structure example of the imaging element 133.

Note that, in FIG. 5, in order to simplify the illustration, only a region of two pixels 160 with the optical axis as a center of the two pixels in the imaging element 133 is illustrated.

The imaging element 133 in FIG. 5 is a back-illuminated imaging element. Hence, in the imaging element 133, a wiring layer 252 is formed on a front surface side opposite to a back surface side on which the imaging surface 133a of a semiconductor substrate 251 is formed.

The semiconductor substrate 251 is formed of, for example, a silicon substrate. The pixel array portion 151 is formed on the semiconductor substrate 251. Specifically, on the semiconductor substrate 251, the pixels 160 including the photoelectric conversion unit 201 and the pixel circuit (not illustrated) are formed in a matrix-like pattern.

The photoelectric conversion unit 201 includes, for example, a p-n junction photodiode. In this case, the photoelectric conversion unit 201 is configured by forming an n-type semiconductor region over the entire region of the semiconductor substrate 251 in a thickness direction thereof and forming a p-type semiconductor region on a front surface side and a back surface side of the semiconductor substrate 251. The p-type semiconductor region also serves as a hole charge accumulation region for suppressing a dark current.

The MOS transistor 203 constituting a pixel circuit (not illustrated) is configured by forming, via a gate insulating film, a gate electrode on the front surface side of an n-type source region and a drain region formed in a p-type semiconductor region on the front surface side of the semiconductor substrate 251. In the semiconductor substrate 251, an element separation portion 261 that separates the adjacent pixels 160 is also formed.

The element separation portion 261 is formed in a p-type semiconductor region and is grounded, for example. A trench may be formed in a part of the element separation portion 261, a fixed charge film 253 may be formed therein, and an insulating film 254 or the like may be embedded therein. Therefore, crosstalk due to rolling of electrons can be blocked by the insulating film 254, and crosstalk as light can also be suppressed by interface reflection due to a difference in refractive index. Although not illustrated, a support substrate that reinforces and supports the semiconductor substrate 251 or the like in a manufacturing process of the imaging element 133 is bonded to the semiconductor substrate 251 by plasma bonding or an adhesive material. This support substrate is formed of, for example, a silicon substrate. Peripheral circuits such as the vertical drive unit 152, the column signal processing section 153, and the control unit 154 are formed in the support substrate. By forming a connection via-hole between the semiconductor substrate 251 and the support substrate, it is possible to stack the peripheral circuits vertically and reduce a chip size of the imaging element 133. The support substrate can also include a logic circuit such as the signal processing section 105.

In the wiring layer 252, wirings such as the signal lines 161 and 162, the signal lines 171 and 172, and the power supply line Vdd are formed. The wiring layer 252 and the pixel circuit are connected by a via-hole plug. The wiring layer 252 includes multiple layers, and the respective layers are connected by the via-hole plug.

The wiring of the wiring layer 252 can include metal such as Al or Cu, for example. The via-hole plug can include, for example, metal such as W or Cu. For insulation of the wiring layer 252, for example, SiO2 or the like can be used.

The fixed charge film 253 is formed on the semiconductor substrate 251. The fixed charge film 253 has a negative fixed charge due to a dipole of oxygen and plays a role of enhancing pinning. An example of a material of the fixed charge film 253 can include an oxide or nitride containing at least one of Hf, Al, zirconium, Ta, or Ti. The fixed charge film 253 can be formed by chemical vapor deposition (CVD), sputtering, and atomic layer deposition (ALD).

In a case where the fixed charge film 253 is formed by the ALD, it is possible to simultaneously form SiO2 that reduces an interface state during the deposition of the fixed charge film 253, which is preferable. Examples of materials of the fixed charge film 253 can also include an oxide or nitride containing at least one of lanthanum, cerium, neodymium, promethium, samarium, europium, gadolinium, terbium, dysprosium, holmium, thulium, ytterbium, lutetium, or yttrium. A material of the fixed charge film 253 can also include hafnium oxynitride or aluminum oxynitride. Silicon or nitrogen can be added to the fixed charge film 253 in an amount that does not impair insulating properties thereof. Therefore, heat resistance and the like can be improved. The fixed charge film 253 desirably has a function of serving as an antireflection film for the semiconductor substrate 251 by controlling a film thickness or stacking multiple layers.

On the fixed charge film 253, the insulating film 254 that suppresses deterioration of characteristics in the dark is formed. From the viewpoint of antireflection, the insulating film 254 preferably has a refractive index lower than that of an upper film constituting the fixed charge film 253. An example of a material of the insulating film 254 can include SiO2 or a composite containing SiO2 as a main component, such as SiON or SiOC.

On the insulating film 254, a color filter 255 that selectively transmits light of a predetermined color is formed for each pixel 160. As a material of the color filter 255, a pigment or a dye can be used. The color filter 255 may have a different film thickness for each color in consideration of color reproducibility by a spectroscopic spectrum or a sensor sensitivity specification.

A light shielding film 256 that shields stray light leaking from the adjacent pixels 160 is formed between the color filters 255 of the adjacent pixels 160. As a material of the light shielding film 256, any material can be used as long as the material is a material capable of shielding light, but Al, W, copper, or the like which has a strong light shielding property and can be finely processed with high accuracy by etching or the like is preferable. As the material of the light shielding film 256, silver, gold, platinum, Mo, Cr, Ti, nickel, iron, tellurium, or the like, or alloys containing these metals can also be used. The light shielding film 256 can also be formed by laminating a plurality of these materials.

In order to enhance adhesion to the underlying insulating film 254, a barrier metal such as Ti, Ta, W, Co, Mo, alloys thereof, nitrides, oxides, or carbides thereof may be provided under the light shielding film 256.

Note that the light shielding film 256 may also serve to shield light for the pixel 160, which determines an optical black level or may also serve to shield light for preventing noise to the peripheral circuit region. The light shielding film 256 is desirably grounded so as not to be destroyed by plasma damage due to accumulated charges during processing. A grounding structure may be provided outside an effective region to be electrically connected to the entire light shielding film 256.

On the light shielding film 256, a protective film 257 for avoiding a change in a mixing layer caused by contact between the light shielding film 256 and the color filter 255 or a change in the mixing layer caused in a reliability test is formed. An example of a material of the protective film 257 can include SiO2 or a composite containing SiO2 as a main component, such as SiON or SiOC.

On the color filter 255, an on-chip lens 258 is formed per pixel 160. The on-chip lens 258 collects incident light on the photoelectric conversion unit 201 so that vignetting of the incident light does not occur on the light shielding film 256.

Examples of materials of the on-chip lens 258 can include an organic material such as a styrene resin, an acrylic resin, a styrene-acrylic resin, or a siloxane resin. As a material of the on-chip lens 258, a material obtained by dispersing titanium oxide particles in the organic material or a polyimide-based resin can also be used. As a material of the on-chip lens 258, an inorganic material such as silicon nitride or silicon oxynitride can also be used.

An antireflection film 259 having a refractive index different from that of the on-chip lens 258 is formed on a front surface of the on-chip lens 258.

### Array Example of Pixels

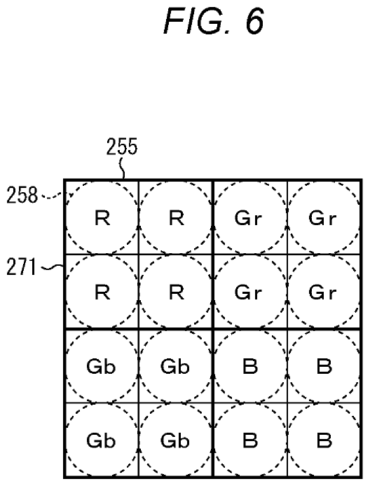

FIG. 6 is a top view of the imaging element 133 illustrating an array example of pixels 160 in FIG. 5.

Note that, in FIG. 6, in order to simplify the drawing, only a region of 4×4 pixels 160 including four pixels arranged in a row direction and four pixels arranged in a column direction in the imaging element 133 is illustrated, and the antireflection film 259 is omitted.

In the example of FIG. 6, the array of 4×4 pixels 160 is a Bayer array of same-color pixel groups 271, that is, a Quad Bayer array, in which each of the same-color pixel groups 271 includes 2×2 pixels 160 having color filters 255 of the same color. Specifically, colors of the color filters 255 of the same-color pixel group 271 including upper left 2×2 pixels 160 of the 4×4 pixels 160 are all red (R), and colors of the color filters 255 of the same-color pixel group 271 including lower right 2×2 pixels 160 are all blue (B). Colors of the color filters 255 of the same-color pixel group 271 including upper right 2×2 pixels 160 and the same-color pixel group 271 including lower left 2×2 pixels 160 are all green (Gr and Gb).

In a case where the pixels 160 have the Quad Bayer array as illustrated in FIG. 6, it is easy to add an electrical signal between adjacent pixels 160.

### <Description of Effects of Imaging Element>

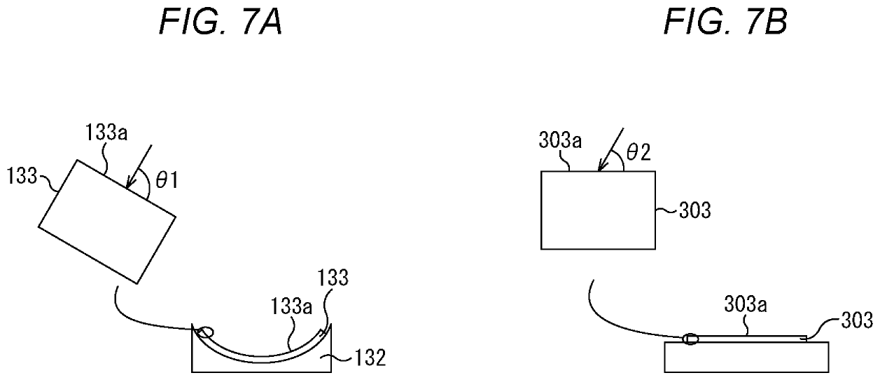

FIGS. 7A and 7B are diagrams illustrating effects of the imaging element 133.

FIG. 7A is a cross-sectional view of the imaging element 133 having a curved shape, and FIG. 7B is a cross-sectional view of an imaging element 303 having a planar shape.

As illustrated in FIG. 7A, the imaging element 133 having a curved shape is curved, for example, according to an incident angle (chief ray angle (CRA)) of light at each imaging height, thereby enabling the incident angle of the light with respect to the imaging surface 133a to be approximate to the right angle on the entire imaging surface 133a. As a result, for example, an incident angle θ1 of light with respect to the imaging surface 133a at an end portion of the imaging surface 133a (an end portion of the maximum angle of view in the ultrawide-angle mode) becomes approximate to 90 degrees. Hence, it is possible to suppress an output difference, that is, a same-color sensitivity difference, between the pixels 160 having the adjacent color filters 255 of the same color due to anisotropy of mixed colors caused by oblique incidence of light at the end portion of the imaging surface 133a. As a result, the signal processing section 105 can improve image quality deterioration such as streaks or artifacts produced in an ultrawide-angle image and a wide-angle image.

On the other hand, as illustrated in FIG. 7B, even when the imaging element 303 having a planar shape has a pupil correction function of adjusting positions of an on-chip lens, a color filter, a light shielding film, and the like according to each imaging height, an effect of the pupil correction function is limited. Hence, the closer the incidence of light occurs to an end portion of an imaging surface 303a, the smaller the incident angle of light with respect to the imaging surface 303a becomes than 90 degrees. For example, an incident angle θ2 of the light with respect to the imaging surface 303a at the end portion of the imaging surface 303a is smaller than 90 degrees.

As a result, image quality degradation such as artifacts or shading occurs on an ultrawide-angle image or a wide-angle image due to the anisotropy of mixed colors caused by oblique incidence of light at the end portion of the imaging surface 303a. Furthermore, due to the oblique incidence of light at the end portion of the imaging surface 303a, a sensitivity difference occurs between pixels having adjacent color filters of the same color depending on whether or not the color filters of the pixels and pixels adjacent to the pixels on the optical axis side are color filters of the same color.

### Examples of Evaluation Values of Same-Color Sensitivity Difference

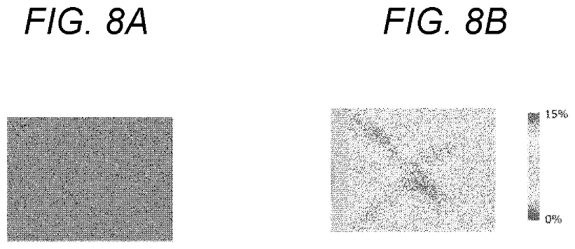

FIGS. 8A and 8B are diagrams illustrating examples of evaluation values of a same-color sensitivity difference between the imaging element 133 and the imaging element 303 in FIGS. 7A and 7B.

In an evaluation in FIGS. 8A and 8B, a pattern box covered with a red filter as a subject is imaged on the same wide-angle lens and point of focus from the same distance and angle such that the entire angle of view converges within the pattern box. A reason why the color of the subject is set to red is that long-wavelength light reaches a deeper portion of the silicon substrate, so that mixed color components are easily noticeable.

FIG. 8A is a heat map illustrating an evaluation value of a same-color sensitivity difference at each position (imaging height) of the imaging surface 133a of the imaging element 133, and FIG. 8B is a heat map illustrating an evaluation value of a same-color sensitivity difference at each position of the imaging surface 303a of the imaging element 303.

In the examples of FIGS. 8A and 8B, the evaluation values of the same-color sensitivity difference are values representing a sensitivity difference in a same-color pixel group including 2×2 pixels having green color filters that are easily affected by mixed colors from pixels having red color filters and are calculated for each same-color pixel group. Specifically, the evaluation value (%) is a value ((Max−Min)/ave×100) obtained by subtracting a minimum value Min from a maximum value Max of pixel values of the pixels in the same-color pixel group for each green pixel group, dividing a result of the subtraction by an average value ave of the pixel values, and multiplying a result of the division by 100.

As illustrated in FIG. 8A, in the imaging element 133, the evaluation value is lower than 2% on the entire imaging surface 133a. On the other hand, as illustrated in FIG. 8B, in the imaging element 303, the evaluation value exceeds 10% at a central end portion of the imaging surface 303a where the anisotropy of mixed colors is strong.

As described above, in the imaging element 133, the same-color sensitivity difference hardly occurs. Hence, on the ultrawide-angle image or the wide-angle image generated using an image signal output from the imaging element 133, image quality deterioration such as streaks due to the same-color sensitivity difference hardly occurs.

### Example of FOV of Ultrawide-Angle Image and Wide-Angle Image

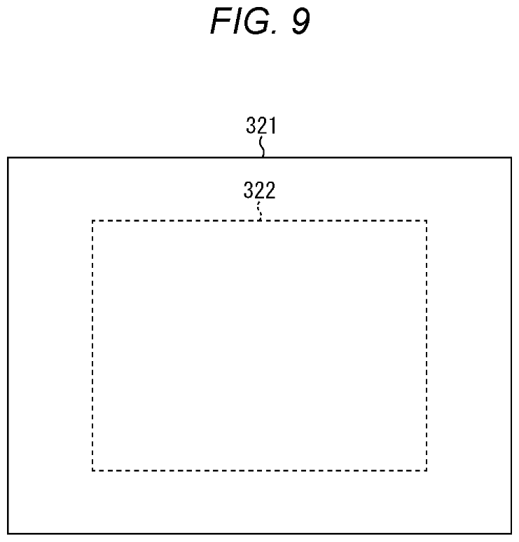

FIG. 9 is a diagram illustrating examples of fields of view (FOVs) of the ultrawide-angle image and the wide-angle image.

As illustrated in FIG. 9, the FOV of the ultrawide-angle image in which an angle of view corresponding to a zoom magnification is a first angle is a region 321 imaged corresponding to the angle of view by all the pixels 160 of the imaging element 133. Meanwhile, the FOV of the wide-angle image in which an angle of view corresponding to a zoom magnification is a second angle is a region 322 imaged corresponding to the angle of view by some pixels 160 of the imaging element 133.

### <Description of Reading Methods in Imaging Modes>

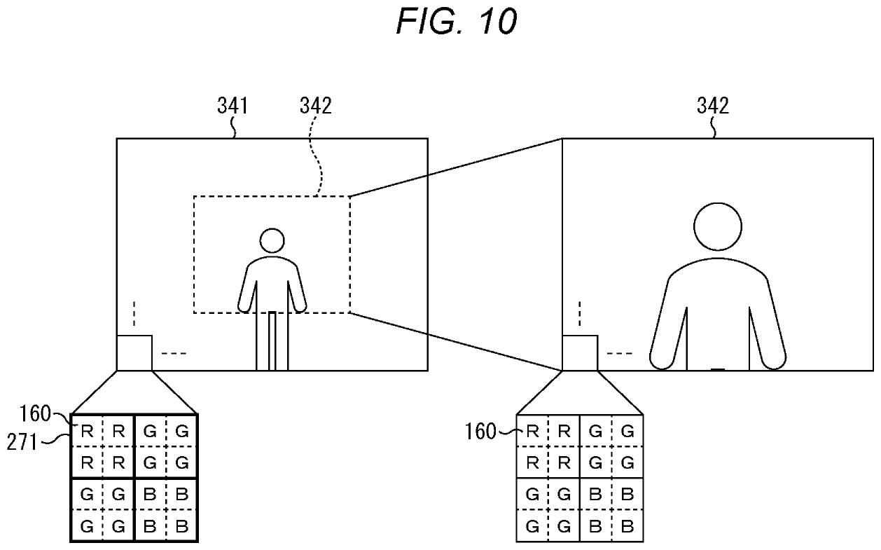

FIG. 10 is a view illustrating a method of reading an electrical signal in each imaging mode.

In the example of FIG. 10, in a case of a zoom magnification of 1× or higher and lower than 2×, an imaging mode is set to the ultrawide-angle mode, and in a case of the zoom magnification of 2× or higher, the imaging mode is set to the wide-angle mode. The angle of view, that is, the first angle, in the case of the zoom magnification of 1× is 134 degrees, and an effective pixel region 341 which is a region of effective pixels in this case includes 16,000×12,000 pixels 160 including 16,000 pixels arranged in the horizontal direction and 12,000 pixels arranged in the vertical direction.

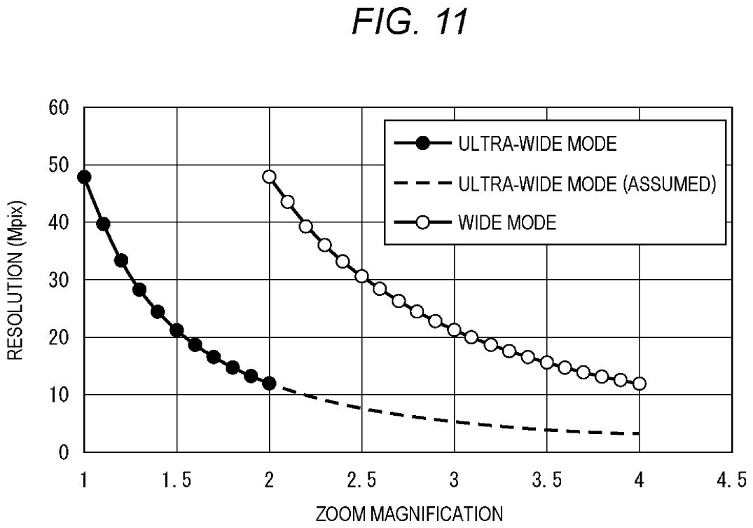

The angle of view, that is, the second angle, in the case of the zoom magnification of 2× is 67 degrees. An effective pixel region 342 which is a region of effective pixels in this case includes 8,000×6,000 pixels 160 including 8,000 pixels arranged in the horizontal direction and 6,000 pixels arranged in the vertical direction in a part of the effective pixel region 341. These are similar in FIG. 11 to be described later. The method of reading the electrical signal in the ultrawide-angle mode is a method of adding and reading electrical signals of individual same-color pixel groups 271 for each pixel block including 4×4 pixels 160. Hence, in the example of FIG. 10, the electrical signals of the individual same-color pixel groups 271 are added and read for each pixel block constituting the effective pixel region 341. As a result, the resolution of the ultrawide-angle image is 48 M (=8,000×6,000) pixels.

As described above, since the electrical signals of the individual same-color pixel groups 271 are added and read in the ultrawide-angle mode, a light amount at the time of low illuminance can be ensured, and a signal/noise (S/N) ratio of the electrical signals can be improved.

As a result, the degradation of the image quality of the ultrawide-angle image can be improved.

As a method of adding and reading the electrical signals of the individual same-color pixel groups 271, for example, there is a method of sharing the charge holding units 202 of the 2×2 pixels 160 constituting the same-color pixel group 271 and reading the electrical signals corresponding to the charges held in the charge holding units 202. In this method, the charge holding unit 202 functions as an addition unit that adds the electrical signals of the 2×2 pixels 160 constituting the same-color pixel group 271. The sharing of the charge holding units of the 2×2 pixels, that is, so-called pixel sharing, has been described in, for example, JP 2008-294218A.

As the method of adding and reading the electrical signals of the individual same-color pixel groups 271, there is also a method of reading an electrical signal for each pixel 160 and adding an image signal corresponding to the electrical signal for each same-color pixel group 271 by the signal processing section 105.

Note that the addition and the reading of the electrical signals in the method of reading the electrical signals in the ultrawide-angle mode may be performed on all the pixel blocks or may be performed only on pixel blocks at a peripheral portion thereof. In the case where the addition and the reading are performed only on the pixel blocks at the peripheral portion, resolution degradation due to the addition and the reading can be suppressed.

The method of reading electrical signals in the wide-angle mode is a method of reading the electrical signals of the pixels 160 individually. Hence, in the example of FIG. 10, the electrical signals of the pixels 160 constituting the effective pixel region 342 are individually read. As a result, the resolution of the wide-angle image is 48 M (=8,000×6,000) pixels. As described above, since the electrical signals of the pixels 160 are individually read in the wide-angle mode, degradation of the resolution of the wide-angle image can be suppressed.

<Relationship between Zoom Magnification and Resolution>

FIG. 11 is a graph illustrating a relationship between a zoom magnification and resolution of a captured image.

In FIG. 11, the horizontal axis represents the zoom magnification, and the vertical axis represents the resolution (Mpix). In the example of FIG. 11, a settable range of the zoom magnification is 1× or higher and 4× or lower.

As illustrated in FIG. 11, in the case of the zoom magnification of 1× or higher and lower than 2×, the imaging mode is set to the ultrawide-angle mode, and the electrical signal is read by the method of reading an electrical signal in an ultrawide-angle mode. Hence, in the case of the zoom magnification is 1×, the resolution of the ultrawide-angle image is 48 Mpix. Then, as the zoom magnification becomes higher than 1×, the resolution decreases from 48 Mpix in inverse proportion to the square of a percentage of the zoom magnification to the zoom magnification of 1×. Hence, when the zoom magnification approaches 2×, the resolution of a captured image approaches 12 M (=1/(2/1)²×48 M) pixels.

In the case of the zoom magnification of 2× or higher, the imaging mode is set to the wide-angle mode, and electrical signals are read by the method of reading an electrical signal in a wide-angle mode. Hence, in the case of the zoom magnification of 2×, the resolution of the wide-angle image is 48 Mpix. Then, as the zoom magnification becomes higher than 2×, the resolution of the wide-angle image decreases from 48 Mpix in inverse proportion to the square of a percentage of the zoom magnification to the zoom magnification of 2×. Hence, when the zoom magnification approaches 4×, the resolution of the wide-angle image approaches 12 M (=1/(4/2)²×48 M) pixels.

As described above, since the method of reading an electrical signal varies depending on the imaging mode, it is possible to reduce the change in the resolution of the captured image according to the change in the zoom magnification.

On the other hand, in a case where the same method of reading an electrical signal is used regardless of the imaging mode, as represented by a dotted line in FIG. 11, the resolution of the wide-angle image in the case of the zoom magnification of 2× or higher decreases in inverse proportion to the square of the percentage of the zoom magnification to the zoom magnification of 1×. Hence, in the case of the zoom magnification of 4×, the resolution of the wide-angle image is 3 M (=1/(4/1)²×48 M) pixels.

### Detailed Structure Example of Base

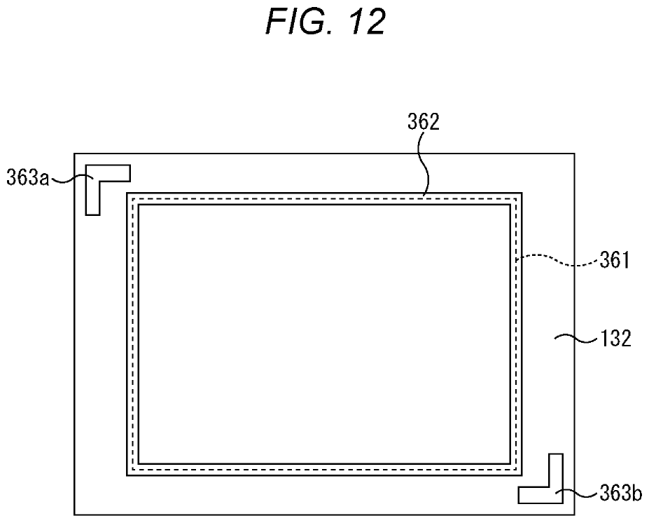

FIG. 12 is a top view illustrating a detailed structure example of a base 132.

As illustrated in FIG. 12, a groove-shaped resin pocket 362 for preventing an adhesive resin from spilling is formed in an outer perimeter portion of a region 361 of the base 132 to which the imaging element 133 adheres. Alignment marks 363a and 363b which are marks for determining an adhesion position of the imaging element 133 are formed outside the resin pocket 362 on an upper left side and a lower right side from the region 361, respectively. The alignment marks 363a and 363b enable an adhesion device that performs adhesion of the imaging element 133 to the base 132 to recognize the region 361 and perform adhesion of the imaging element 133 in the region 361.

Note that the base 132 may have a step or the like instead of the alignment marks 363a and 363b if the step serves as a positioning guideline. A shape of the base 132 viewed from the top surface thereof is desirably a rectangular shape as illustrated in FIG. 12.

### <Method of Performing Adhesion of Imaging Element>

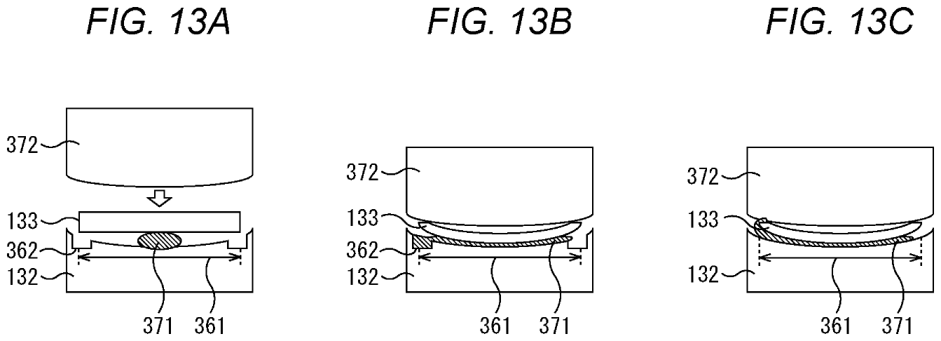

FIGS. 13A to 13C are views illustrating an example of a method of performing adhesion of the imaging elements 133.

As illustrated in FIG. 13A, an adhesion device recognizes the region 361 of a concavely curved surface of the base 132 due to the alignment marks 363a and 363b and drops an adhesive resin 371 near a center of the region 361.

Then, the adhesion device recognizes the region 361 due to the alignment marks 363a and 363b and disposes the imaging element 133 in the region 361 to which the adhesive resin 371 is dropped.

Next, as illustrated in FIG. 13B, the adhesion device performs adhesion of the imaging element 133 along the curved surface of the base 132 by pressing the imaging element 133 by using a pressing portion 372. At this time, a redundant adhesive resin 371 spreads up toward an end portion of the imaging element 133. However, since the resin pocket 362 is provided at the outer perimeter portion of the region 361, the redundant adhesive resin 371 flows into the resin pocket 362.

On the other hand, as illustrated in FIG. 13C, in a case where the resin pocket 362 is not provided in the base 132, the redundant adhesive resin 371 spreads up toward the end portion of the imaging element 133 and spills onto the base 132.

Note that a curing type of the adhesive resin 371 is not particularly limited and may be an ultraviolet curing type, a temperature curing type, a time curing type, or the like. In a case where the curing type of the adhesive resin 371 is the ultraviolet curing type, it is desirable to use a material having high ultraviolet transmittance for the base 132. In a case where the curing type of the adhesive resin 371 is the temperature curing type, it is desirable to use a resin that is cured at 260° C. or lower as the adhesive resin 371 in order to avoid damage to the imaging element 133 due to heat.

### <Description of Types of Imaging Lenses>

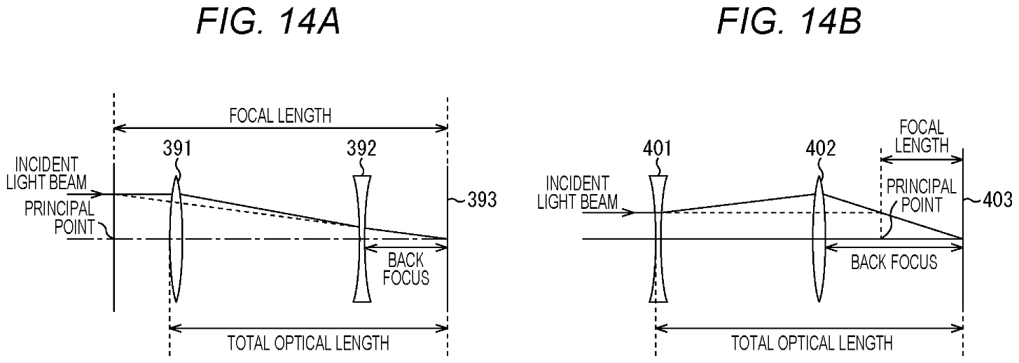

FIGS. 14A and 14B are views for illustrating types of imaging lenses.

In general, if a focal length of the imaging lens becomes shorter, that is, if the imaging lens becomes wider, a total optical length becomes shorter and the back focus also becomes shorter. However, depending on types of imaging lenses, a relationship between the focal length, the total optical length, and the back focus can vary. Specifically, as a type of imaging lens, there is a telephoto-type imaging lens including a convex lens 391 and a concave lens 392 in order from an object side as illustrated in FIG. 14A.

In the telephoto-type imaging lens, even in a case of a long focal length, the total optical length can be shortened, and height reduction of an imaging section can be achieved. Hence, the telephoto-type imaging lens is used for a telephoto lens or the like of a digital single lens reflex camera (DSLR) in which a weight or size reduction effect is important.

However, in the telephoto-type imaging lens, it is difficult to ensure a wider angle or back focus or peripheral illumination at the time of the wider angle. Hence, in the case where the telephoto-type imaging lens is employed as the imaging lens of a standard camera of a mobile terminal such as a smartphone, it is possible to reduce the total optical length, that is, to reduce the height, but it is difficult to have a sufficiently wider angle.

Furthermore, as a type of imaging lens, as illustrated in FIG. 14B, there is a retrofocus-type imaging lens including a concave lens 401 (negative lens) and a convex lens 402 in order from the object side.

In the retrofocus-type imaging lens, it is relatively easy to ensure back focus even at an ultrawide angle, that is, an ultra-short focal length. Hence, a retrofocus-type imaging lens is used for a wide-angle lens of a digital single lens reflex or a projector having long back focus, and the like. Furthermore, in the retrofocus-type imaging lens, it is easy to secure the peripheral illumination at the time of the wider angle.

However, in the retrofocus-type imaging lens, the total optical length is increased, and barrel distortion is likely to occur. Note that this barrel distortion can be suppressed by increasing the number of lenses constituting the imaging lens.

As described above, in the imaging lens, there is a trade-off relationship between height reduction of the imaging section and ensuring of the wider angle and the back focus.

Here, in the imaging element 133, the imaging surface 133a is curved. Hence, in order to avoid physical interference with the imaging surface 133a, it is necessary to ensure back focus (BF) as compared with a case where the imaging surface 133a is a flat surface. Therefore, as the imaging lens 116, a retrofocus-type lens which can easily ensure a wide angle and back focus is used.

### First Configuration Example of Imaging Lens

FIG. 15 is a cross-sectional view illustrating a first configuration example of the imaging lens 116.

The imaging lens 116 in FIG. 15 includes a lens group 421 having optical power and an aperture stop 422.

The lens group 421 includes seven lenses 431 to 437 which are aspherical lenses. The seven lenses 431 to 437 are arranged in order from the object side (left side in FIG. 15) toward the imaging surface 133a side (right side in FIG. 15). The lens 431 has a surface 431a on the object side and a surface 431b on the imaging surface 133a side. Similarly to the lens 431, the lenses 432 to 437 also have surfaces 432a and 432b, surfaces 433a and 433b, surfaces 434a and 434b, surfaces 435a and 435b, surfaces 436a and 436b, and surfaces 437a and 437b, respectively.

The surfaces 431a to 437a and 431b to 436b are aspherical surfaces. Of the lenses 431 to 437, the imaging surface 133a-side surface 437b (last surface) of the lens 437 closest to the imaging surface 133a is an aspherical surface that is concave toward the object side as a whole, in which a sign of inclination of the surface is not reversed as a distance between the surface and the optical axis increases. The aperture stop 422 is disposed between the lenses 433 and 434 and limits light incident on the lens 434 from the lens 433. In the example of FIG. 15, the imaging surface 133a is a spherical surface.

The light incident on the imaging lens 116 from the object is emitted via the lenses 431 to 437 and the infrared cut filter 114 and is collected on the imaging surface 133a. The entire imaging surface 133a is the effective pixel region 341, and a partial region at a center of the imaging surface 133a is the effective pixel region 342.

Note that, hereinafter, the total optical length of the imaging lens 116, which is a distance on the optical axis from the most object-side surface 431a (foremost surface) of the lens 431 closest to the object side of the lenses 431 to 437 to the imaging surface 133a is referred to as TL₁. A distance on the optical axis from the surface 437b to the imaging surface 133a is referred to as fb₁, and a distance on the optical axis from the aperture stop 422 to the imaging surface 133a is referred to as Ts₁.

In the present specification, when the distances on the optical axis such as the total optical length TL₁, the distance fb₁, and the distance Ts₁ are calculated, an air equivalent length are used as all of the thicknesses of parallel flat plates. The same applies to total optical lengths TL₁ to TL₁₂, distances fb₁ to fb₁₂, and distances Ts₁ to Ts₁₂ to be described later.

### First Example of Various Setting Values of Entire Imaging Lens

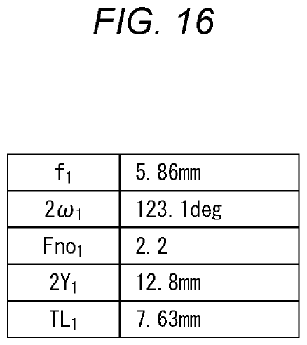

FIG. 16 is a table illustrating examples of various setting values of the entire imaging lens 116 in FIG. 15. As illustrated in FIG. 16, a focal length (effective focal length (EFL)) f₁ of the entire imaging lens 116 in FIG. 15 is 5.86 mm. A maximum angle of view 2ω₁ of the imaging lens 116 is 123.1 deg. An F value Fno₁ of the imaging lens 116 is 2.2 and is 2.5 or less. In addition, 2Y₁, that is, a maximum diameter of an optical image, which is twice a maximum imaging height (second imaging height) Y₁ that is an imaging height when a half angle of view is a maximum half view angle ω₁ that is a half of the maximum angle of view 2ω₁ is 12.8 mm, and the total optical length TL₁ is 7.63 mm.

### First Example of Various Setting Values of Lenses, Aperture Stop, Imaging Surface, and Infrared Cut Filter

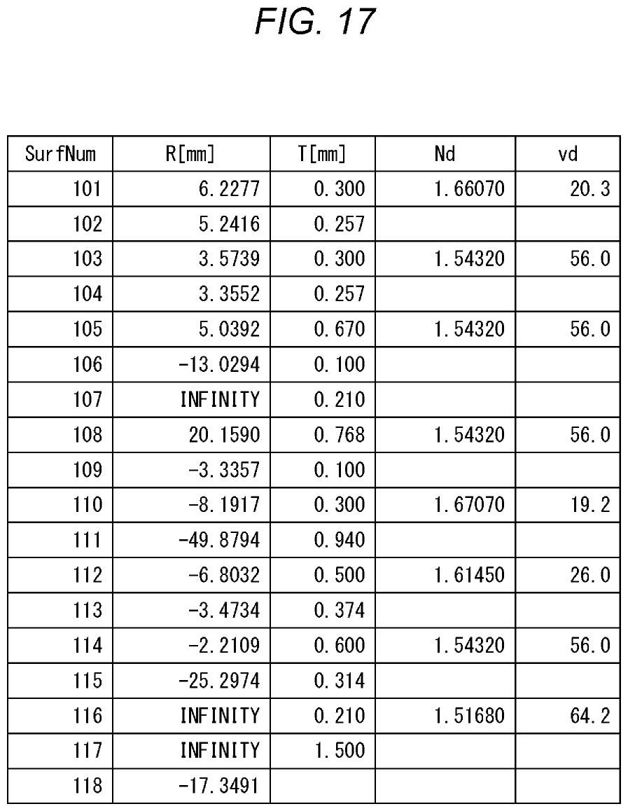

FIG. 17 is a table illustrating examples of various setting values of the lenses 431 to 437, the aperture stop 422, the infrared cut filter 114, and the imaging surface 133a in FIG. 15.

The first row from the top of the table in FIG. 17 shows items corresponding to respective columns. The second and subsequent rows from the top correspond to the surfaces 431a to 437a and the surfaces 431b to 437b, a surface of the aperture stop 422, the surfaces 114a and 114b, and the imaging surface 133a, respectively. The individual columns correspond to items of SurfNum, a curvature radius R (mm) of a center of a surface, a surface interval T (mm) which is an interval on the optical axis from the next surface of SurfNum+1, a refractive index Nd with respect to a d line (wavelength of 587.6 nm), and an Abbe number vd at the d line in order from the left.

SurfNum represents numbers assigned to the surfaces of the imaging lens 116, the surfaces 114a and 114b, and the imaging surface 133a, respectively. In the present specification, SurfNum from 101 to 106 is sequentially assigned to the surfaces 431a, 431b, 432a, 432b, 433a, and 433b. SurfNum from 107 to 118 is sequentially assigned to the surface of the aperture stop 422, the surfaces 434a, 434b, 435a, 435b, 436a, 436b, 437a, 437b, 114a, and 114b, and the imaging surface 133a in FIG. 15. The Abbe number vd is obtained from Vd=(Nd−1)/(NF/NC) where a refractive index with respect to an F line is NF and a refractive index with respect to a C line is denoted by NC.

As illustrated in FIG. 17, the curvature radius R of the surface 431a assigned with SurfNum of 101 is 6.2277, and the surface interval T of the surface 431a from the surface 431b assigned with SurfNum of 102 is 0.300. The refractive index Nd of the surface 431a is 1.66070, and the Abbe number vd thereof is 20.3. The curvature radius R of the surface 431b assigned with SurfNum of 102 is 5.2416, and the surface interval T of the surface 431b from the surface 432a assigned with SurfNum of 103 is 0.257.

Note that, although not described, the curvature radiuses R, the surface intervals T, the refractive indexes Nd, and the Abbe numbers vd of the surfaces 432a to 437a are provided as respective values illustrated in the table of FIG. 17. The curvature radiuses R and the surface intervals T of the surfaces 432b to 437b are provided as respective values illustrated in the table of FIG. 17. Since the surface of the aperture stop 422 and the surfaces 114a and 114b are flat surfaces, the curvature radiuses R corresponding to SurfNum of 107, 116, and 117 are infinity. Note that, although not described, the surface intervals T of the surface of the aperture stop 422 and the surface 114b, and the surface interval T, the refractive index Nd, and the Abbe number vd of the surface 114a are provided as values illustrated in the table of FIG. 17, respectively.

The curvature radius R of the imaging surface 133a assigned with SurfNum of 118 is −17.3491. Since there is no surface to which SurfNum of 119 next to 118 is assigned, the imaging surface 133a does not have a surface interval T.

### First Example of Aspherical Data of Surfaces of Lenses

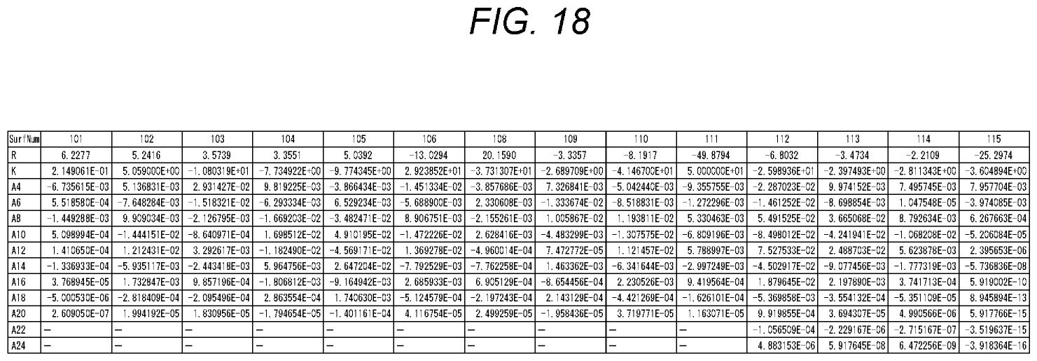

FIG. 18 is a table illustrating an example of aspherical data of the surfaces 431a to 437a and the surfaces 431b to 437b.

In the first column from the left of the table of FIG. 18, items corresponding to rows are described. The second and subsequent columns from the left correspond to the surfaces 431a, 431b, 432a, 432b, 433a, 433b, 434a, 434b, 435a, 435b, 436a, 436b, 437a, and 437b in order from the left. The rows correspond to, from top to bottom, items of SurfNum, curvature radiuses R, conic coefficients K, and n-th-order aspheric coefficients An (n=2, 4, 6, 8, 10, 12, 14, 16, 18, 20, 22, and 24). Note that the conic coefficient K and the n-th-order aspheric coefficient An are coefficients used when a sag amount of an aspherical surface expressed by Expression (a) is obtained.

$$\begin{matrix}( Math . 1 ) & \\ z = \frac{c {r}^{2}}{1 + \sqrt{1 - ( 1 + K ) {c}^{2} {r}^{2}}} + \sum A n {r}^{n} & ( a )\end{matrix}$$

In Expression (a), z denotes a sag amount in a direction parallel to the optical axis, r denotes a distance in a radial direction, and c denotes curvature, that is, a reciprocal of a curvature radius R. K denotes a conic coefficient (conic constant), and An denotes a coefficient of rⁿ, that is, an n-th-order aspheric coefficient. N denotes an integer of 1 or more and 30 or less.

As illustrated in FIG. 18, the curvature radius R of the surface 431a assigned with SurfNum of 101 is 6.2277, and the conic coefficient K thereof is 2.149061×10⁻¹. The fourth-order aspheric coefficient A4, the sixth-order aspheric coefficient A6, and the eighth-order aspheric coefficient A8 are −6.735615×10⁻³, 5.518580×10⁻⁴, and −1.449288×10⁻³, respectively. The tenth-order aspheric coefficient A10 and the twelfth-order aspheric coefficient A12 are 5.098994×10⁻⁴ and 1.410650×10⁻⁴, respectively. The fourteen-th-order aspheric coefficient A14, the sixteen-th-order aspheric coefficient A16, the eighteen-th-order aspheric coefficient A18, and the twentieth-order aspheric coefficient A20 are −1.336933×10⁻⁴, 3.768945×10⁻⁵, −5.000530×10⁻⁶, and 2.609050×10⁻⁷, respectively.

Note that, although not described, the curvature radiuses R, the conic coefficients K, and the n-th-order aspheric coefficients An (n=2, 4, 6, 8, 10, 12, 14, 16, 18, and 20) of the surfaces 432a to 435a and the surfaces 432b to 435b are provided as respective values illustrated in the table in FIG. 18. The curvature radiuses R, the conic coefficients K, and the n-th-order aspheric coefficients An (n=2, 4, 6, 8, 10, 12, 14, 16, 18, 20, 22, and 24) of the surfaces 436a, 436b, 437a, and 437b are provided as respective values illustrated in the table of FIG. 18.

### First Example of Spherical Aberration, Field Curvature, and Distortion

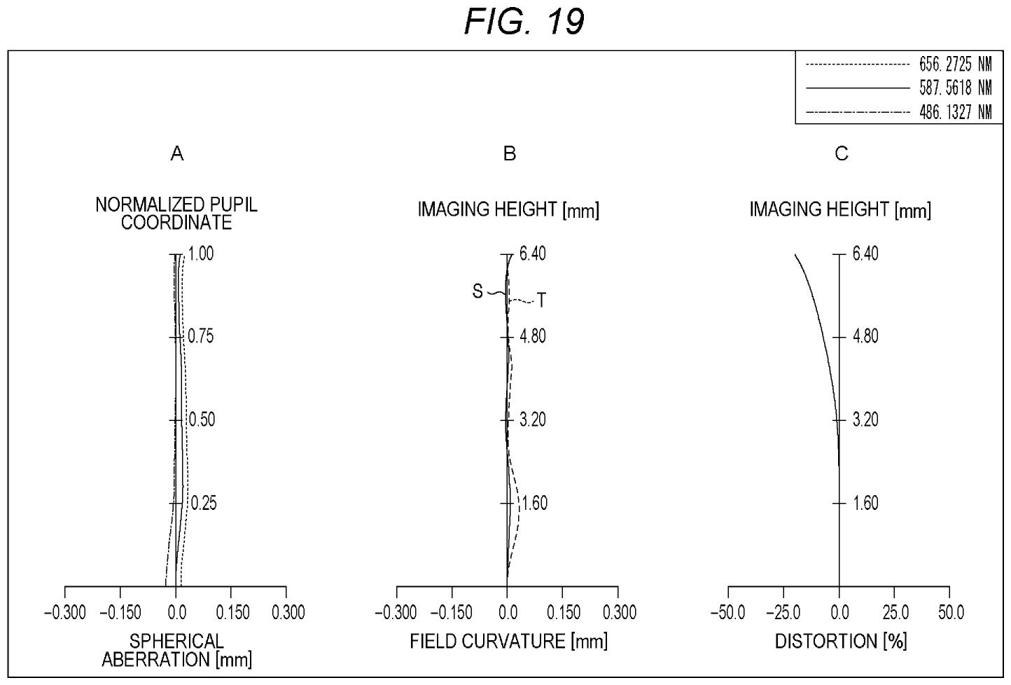

FIG. 19 illustrates graphs of examples of spherical aberration, field curvature, and distortion occurring in the imaging lens 116 in FIG. 15.

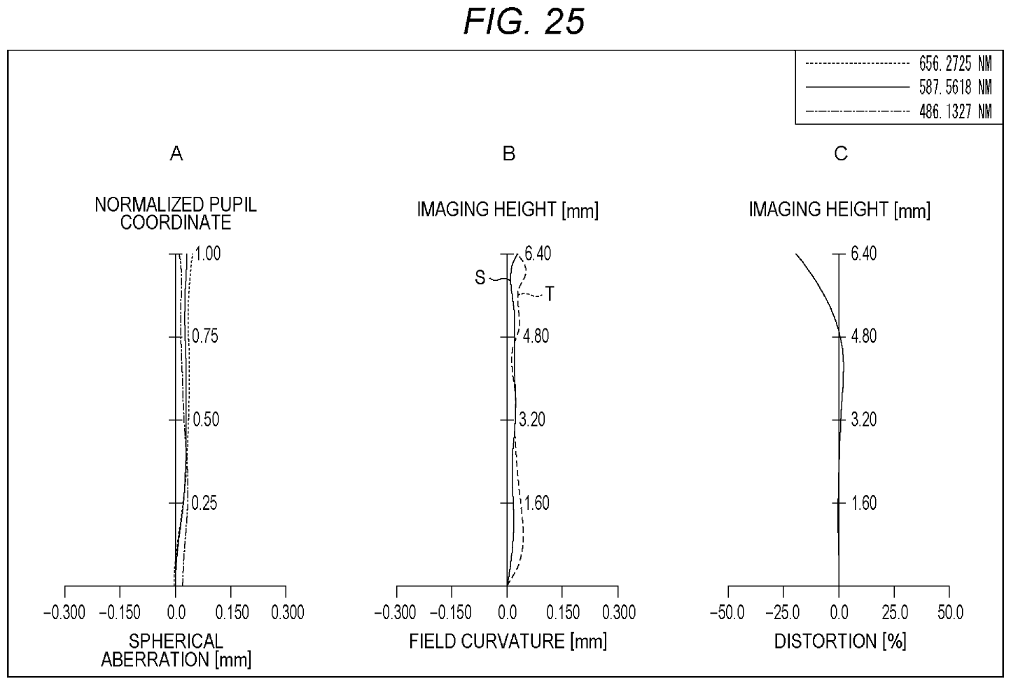

A of FIG. 19 is a graph illustrating spherical aberration for each wavelength of light having wavelengths of 486.1327 nm, 587.5618 nm, and 656.2725 nm, the spherical aberration occurring in the imaging lens 116 in FIG. 15. In the graph in A of FIG. 19, the horizontal axis represents spherical aberration (mm), and the vertical axis represents a normalized pupil coordinate that is a ratio of a distance of an incident position of a light beam from the optical axis to a pupil diameter. The same applies to A of FIGS. 25, 31, 37, 43, 49, 55, 61, 67, 73, 79, and 85 to be described later.

B of FIG. 19 is a graph illustrating field curvature of light having a wavelength of 587.5618 nm, the field curvature occurring in the imaging lens 116. In the graph in B of FIG. 19, the horizontal axis represents field curvature (mm) in a sagittal direction or a tangential direction, and the vertical axis represents an imaging height (mm). In B of FIG. 19, a solid line represents a relationship between the field curvature in the tangential direction and the imaging height, and a dotted line represents a relationship between the field curvature in the sagittal direction and the imaging height. The same applies to B of FIGS. 25, 31, 37, 43, 49, 55, 61, 67, 73, 79, and 85 to be described later.

C of FIG. 19 is a graph illustrating distortion of light having a wavelength of 587.5618 nm, the distortion occurring in the imaging lens 116. In the graph in C of FIG. 19, the horizontal axis represents the distortion (%), and the vertical axis represents the imaging height (mm). The same applies to C of FIGS. 25, 31, 37, 43, 49, 55, 61, 67, 73, 79, and 85 to be described later.

### First Example of Lateral Aberration

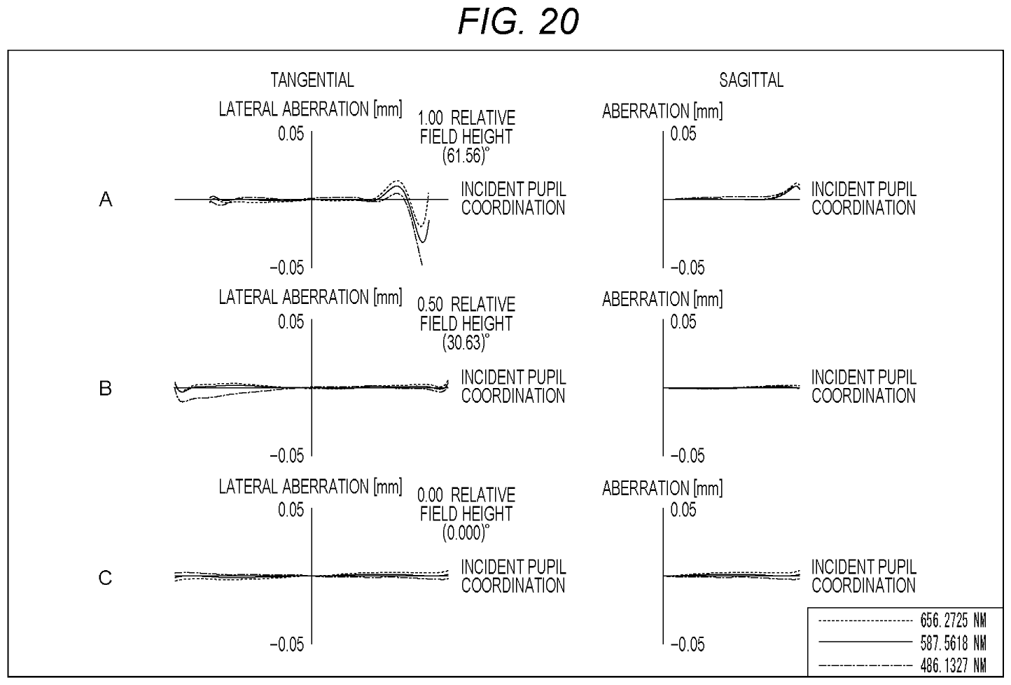

FIG. 20 illustrates graphs of examples of lateral aberration occurring in the imaging lens 116 in FIG. 15. FIG. 20 illustrates graphs of lateral aberration for each wavelength of light having wavelengths of 486.1327 nm, 587.5618 nm, and 656.2725 nm, the lateral aberration occurring in imaging lens 116.

Specifically, the graphs on the left side in A to C of FIG. 20 represent the lateral aberration in the tangential direction at positions (positions of imaging heights in a case where half angles of view are 61.56°, 30.63°, and 0°) where the imaging heights are 1.00 mm, 0.50 mm, and 0.00 mm, respectively. The graphs on the right side in A to C of FIG. 20 represent lateral aberration in the sagittal direction at positions where the imaging heights are 1.00 mm, 0.50 mm, and 0.00 mm, respectively.

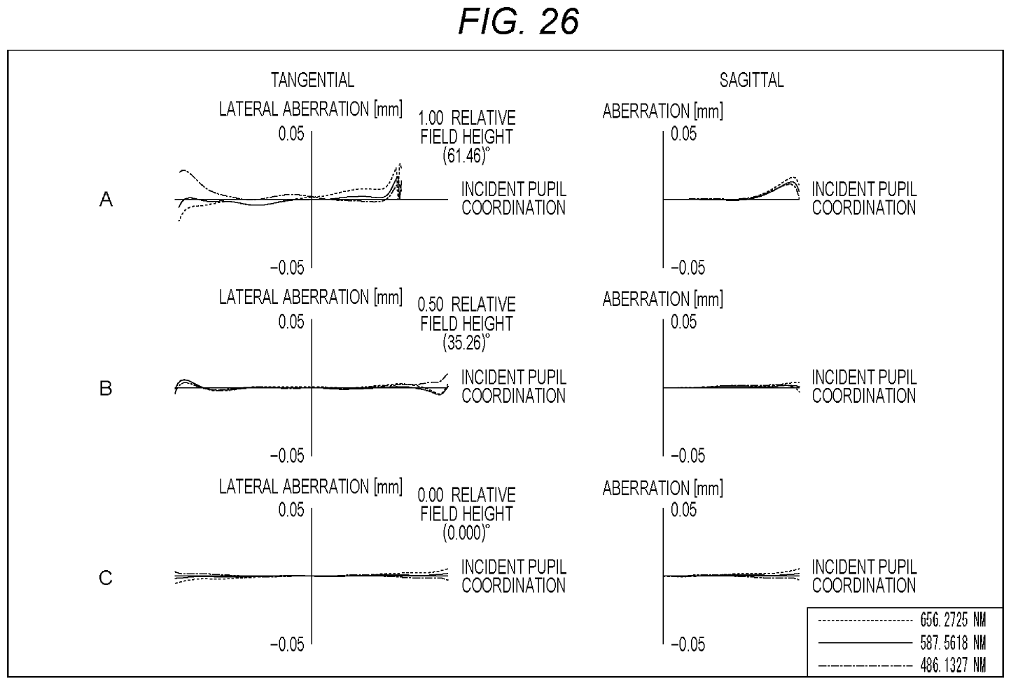

In the graphs in A to C of FIG. 20, the vertical axis represents lateral aberration (mm), and the horizontal axis represents an entrance pupil coordinate which is a coordinate indicating a ratio of a position of incident light beam in a direction perpendicular to the optical axis when the optical axis is set to 0 to the pupil diameter. The same applies to A to C of FIGS. 26, 32, 38, 44, 50, 56, 62, 68, 74, 80, and 86 to be described later.

As illustrated in FIGS. 19 and 20, good aberration correction is performed in the imaging lens 116 in FIG. 15, and the imaging lens 116 in FIG. 15 has good imaging quality.

### Second Configuration Example of Imaging Lens

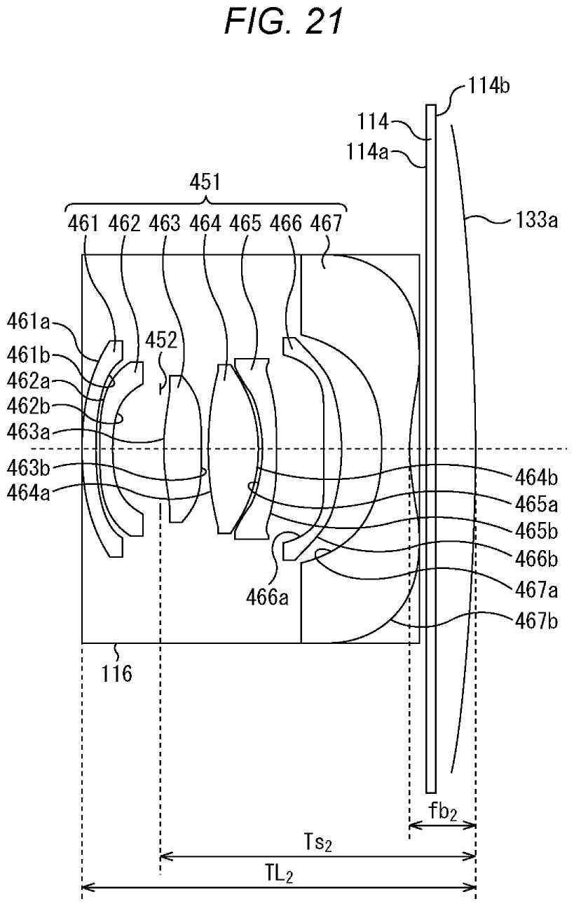

FIG. 21 is a cross-sectional view illustrating a second configuration example of the imaging lens 116.

The imaging lens 116 in FIG. 21 includes a lens group 451 and an aperture stop 452.

The lens group 451 includes seven lenses 461 to 467 which are aspherical lenses. The seven lenses 461 to 467 are arranged in order from the object side toward the imaging surface 133a side. The lens 461 has a surface 461a on the object side and a surface 461b on the imaging surface 133a side. Similarly to the lens 461, the lenses 462 to 467 also have surfaces 462a and 462b, surfaces 463a and 463b, surfaces 464a and 464b, surfaces 465a and 465b, surfaces 466a and 466b, and surfaces 467a and 467b, respectively.

The surfaces 461a to 467a and 461b to 467b are aspherical surfaces. The aperture stop 452 is disposed between the lenses 462 and 463 and limits light incident on the lens 463 from the lens 462. In the example of FIG. 21, the imaging surface 133a is a spherical surface.

The light incident on the imaging lens 116 from the object is emitted via the lenses 461 to 467 and the infrared cut filter 114 and is collected on the imaging surface 133a.

Note that, hereinafter, the total optical length of the imaging lens 116, which is a distance on the optical axis from the object-side surface 461a (foremost surface) of the lens 461 closest to the object side of the lenses 461 to 467 to the imaging surface 133a is referred to as TL₂. A distance on the optical axis from the surface 467b to the imaging surface 133a is referred to as fb₂, and a distance on the optical axis from the aperture stop 452 to the imaging surface 133a is referred to as Ts₂.

### Second Example of Various Setting Values of Entire Imaging Lens

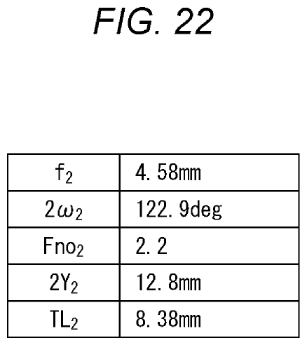

FIG. 22 is a table illustrating examples of various setting values of the entire imaging lens 116 in FIG. 21. As illustrated in FIG. 22, a focal length f₂ of the entire imaging lens 116 in FIG. 21 is 4.58 mm. A maximum angle of view 2ω₂ of the imaging lens 116 is 122.9 deg.

An F value Fno₂ of the imaging lens 116 is 2.2 and is 2.5 or less. In addition, 2Y₂ which is twice the maximum imaging height Y₂, is 12.8 mm, and the total optical length TL₂ is 8.38 mm.

### Second Example of Various Setting Values of Lenses, Aperture Stop, Imaging Surface, and Infrared Cut Filter

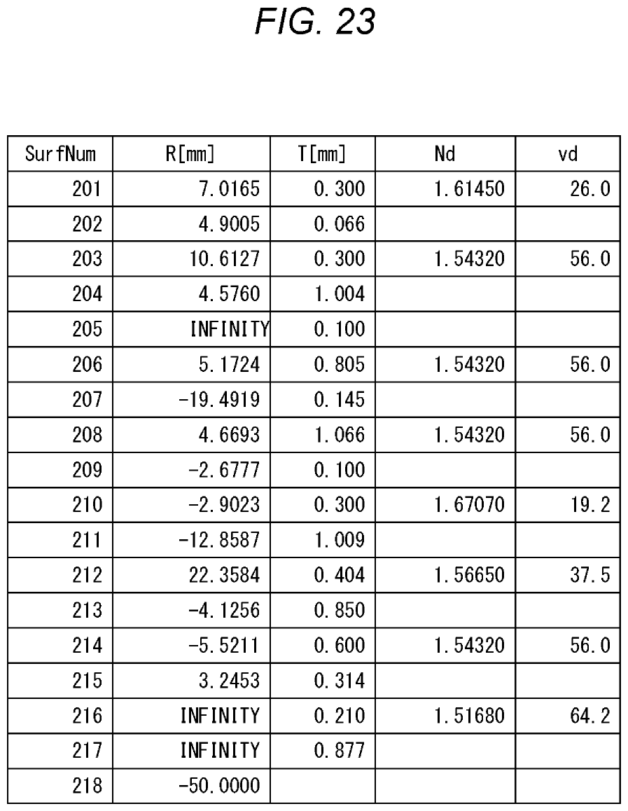

FIG. 23 is a table illustrating examples of various setting values of the lenses 461 to 467, the aperture stop 452, the infrared cut filter 114, and the imaging surface 133a in FIG. 21.

The first row from the top of the table in FIG. 23 shows items corresponding to respective columns. The second and subsequent rows from the top correspond to the surfaces 461a to 467a and the surfaces 461b to 467b, a surface of the aperture stop 452, the surfaces 114a and 114b, and the imaging surface 133a, respectively. Each column in FIG. 23 is similar to each column in FIG. 17. In the present specification, surface numbers from 201 to 205 are sequentially assigned to the surfaces 461a, 461b, 462a, and 462b and the surface of the aperture stop 452. Surface numbers from 206 to 218 are sequentially assigned to the surfaces 463a, 463b, 464a, 464b, 465a, 465b, 466a, 466b, 467a, 467b, 114a, and 114b, and the imaging surface 133a.

Note that, although not described, the curvature radiuses R, the surface intervals T, the refractive indexes Nd, and the Abbe numbers vd of the surfaces 461a to 467a are provided as respective values illustrated in the table of FIG. 23, respectively. The curvature radiuses R and the surface intervals T of the surfaces 461b to 467b are provided as respective values illustrated in the table of FIG. 23.

Since the surface of the aperture stop 452 and the surfaces 114a and 114b are flat surfaces, the curvature radiuses R corresponding to SurfNum of 205, 216, and 217 are infinity. Note that, although not described, the surface intervals T of the surface of the aperture stop 452 and the surface 114b, and the surface interval T, the refractive index Nd, and the Abbe number vd of the surface 114a are provided as values illustrated in the table of FIG. 23, respectively.

The curvature radius R of the imaging surface 133a assigned with SurfNum of 218 is −50.000. Since there is no surface to which SurfNum of 219 next to 218 is assigned, the imaging surface 133a does not have a surface interval T.

### Second Example of Aspherical Data of Surfaces of Lenses

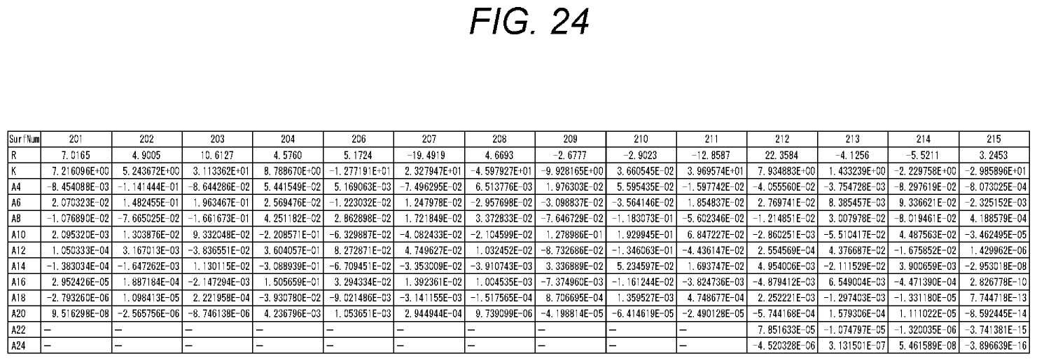

FIG. 24 is a table illustrating an example of aspherical data of the surfaces 461a to 467a and the surfaces 461b to 467b.

In the first column from the left of the table of FIG. 24, items corresponding to rows are described. The second and subsequent columns from the left correspond to the surfaces 461a, 461b, 462a, 462b, 463a, 463b, 464a, 464b, 465a, 465b, 466a, 466b, 467a, and 467b in order from the left. Each row in FIG. 24 is similar to each row in FIG. 18.

Note that, although not described, the curvature radiuses R, the conic coefficients K, and the n-th-order aspheric coefficients An (n=2, 4, 6, 8, 10, 12, 14, 16, 18, and 20) of the surfaces 461a to 465a and the surfaces 461b to 465b are provided as respective values illustrated in the table in FIG. 24. The curvature radiuses R, the conic coefficients K, and the n-th-order aspheric coefficients An (n=2, 4, 6, 8, 10, 12, 14, 16, 18, 20, 22, and 24) of the surfaces 466a, 466b, 467a, and 467b are provided as respective values illustrated in the table of FIG. 24.

### Second Example of Spherical Aberration, Field Curvature, and Distortion

FIG. 25 illustrates graphs of examples of spherical aberration, field curvature, and distortion occurring in the imaging lens 116 in FIG. 21.

A of FIG. 25 is a graph illustrating spherical aberration for each wavelength of light having wavelengths of 486.1327 nm, 587.5618 nm, and 656.2725 nm, the spherical aberration occurring in the imaging lens 116 in FIG. 21.

B of FIG. 25 is a graph illustrating field curvature of light having a wavelength of 587.5618 nm, the field curvature occurring in the imaging lens 116. C of FIG. 25 is a graph illustrating distortion of light having a wavelength of 587.5618 nm, the distortion occurring in the imaging lens 116.

### Second Example of Lateral Aberration

FIG. 26 illustrates graphs of examples of lateral aberration occurring in the imaging lens 116 in FIG. 21. FIG. 26 illustrates graphs of lateral aberration for each wavelength of light having wavelengths of 486.1327 nm, 587.5618 nm, and 656.2725 nm, the lateral aberration occurring in imaging lens 116.

Specifically, the graphs on the left side in A to C of FIG. 26 represent the lateral aberration in the tangential direction at positions (positions of imaging heights in a case where half angles of view are 61.46°, 35.26°, and 0°) where the imaging heights are 1.00 mm, 0.50 mm, and 0.00 mm, respectively. The graphs on the right side in A to C of FIG. 26 represent lateral aberration in the sagittal direction at positions where the imaging heights are 1.00 mm, 0.50 mm, and 0.00 mm, respectively.

As illustrated in FIGS. 25 and 26, good aberration correction is performed in the imaging lens 116 in FIG. 21, and the imaging lens 116 in FIG. 21 has good imaging quality.

### Third Configuration Example of Imaging Lens

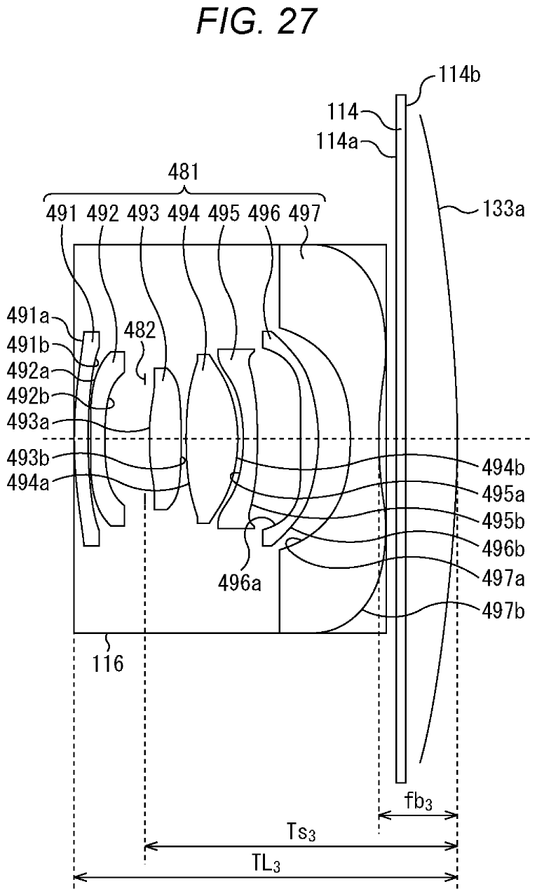

FIG. 27 is a cross-sectional view illustrating a third configuration example of the imaging lens 116.

The imaging lens 116 in FIG. 27 includes a lens group 481 and an aperture stop 482.

The lens group 481 includes seven lenses 491 to 497 which are aspherical lenses. The seven lenses 491 to 497 are arranged in order from the object side toward the imaging surface 133a side. The lens 491 has a surface 491a on the object side and a surface 491b on the imaging surface 133a side. Similarly to the lens 491, the lenses 492 to 497 also have surfaces 492a and 492b, surfaces 493a and 493b, surfaces 494a and 494b, surfaces 495a and 495b, surfaces 496a and 496b, and surfaces 497a and 497b, respectively.

The surfaces 491a to 497a and 491b to 497b are aspherical surfaces. The aperture stop 482 is disposed between the lenses 492 and 493 and limits light incident on the lens 493 from the lens 492. In the example of FIG. 27, the imaging surface 133a is a spherical surface.

The light incident on the imaging lens 116 from the object is emitted via the lenses 491 to 497 and the infrared cut filter 114 and is collected on the imaging surface 133a.

Note that, hereinafter, the total optical length of the imaging lens 116, which is a distance on the optical axis from the object-side surface 491a (foremost surface) of the lens 491 closest to the object side of the lenses 491 to 497 to the imaging surface 133a is referred to as TL₃. A distance on the optical axis from the surface 497b to the imaging surface 133a is referred to as fb₃, and a distance on the optical axis from the aperture stop 482 to the imaging surface 133a is referred to as Ts₃.

### Third Example of Various Setting Values of Entire Imaging Lens

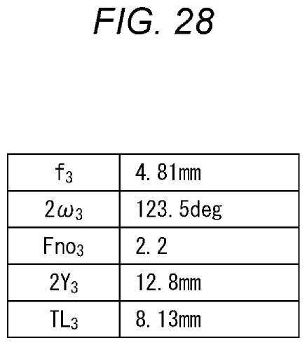

FIG. 28 is a table illustrating examples of various setting values of the entire imaging lens 116 in FIG. 27. As illustrated in FIG. 28, a focal length f₃ of the entire imaging lens 116 in FIG. 27 is 4.81 mm. A maximum angle of view 2ω₃ of the imaging lens 116 is 123.5 deg.

An F value Fno₃ of the imaging lens 116 is 2.2 and is 2.5 or less. In addition, 2Y₃ which is twice the maximum imaging height Y₃ is 12.8 mm, and the total optical length TL₃ is 8.13 mm.

### Third Example of Various Setting Values of Lenses, Aperture Stop, Imaging Surface, and Infrared Cut Filter

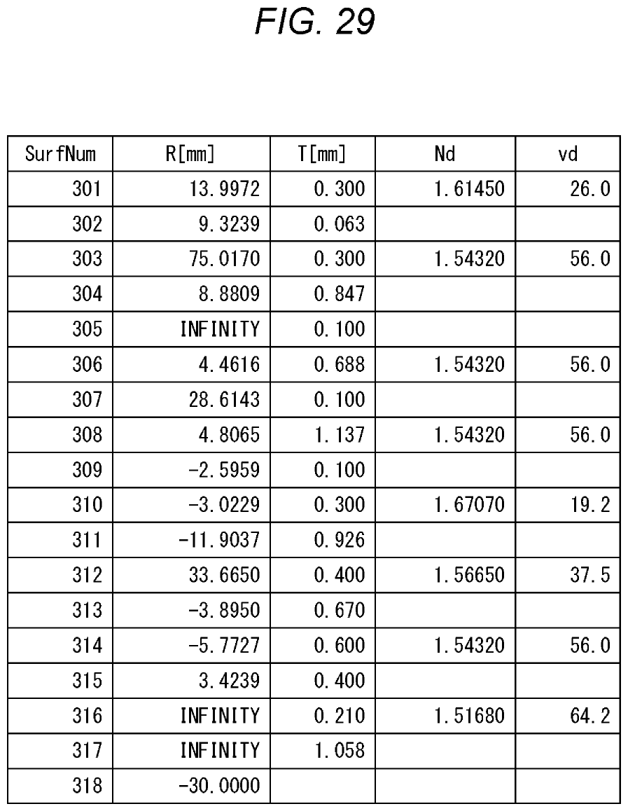

FIG. 29 is a table illustrating examples of various setting values of the lenses 491 to 497, the aperture stop 482, the infrared cut filter 114, and the imaging surface 133a in FIG. 27.

The first row from the top of the table in FIG. 29 shows items corresponding to respective columns. The second and subsequent rows from the top correspond to the surfaces 491a to 497a and the surfaces 491b to 497b, a surface of the aperture stop 482, the surfaces 114a and 114b, and the imaging surface 133a, respectively. Each column in FIG. 29 is similar to each column in FIG. 17. In the present specification, surface numbers from 301 to 304 are sequentially assigned to the surfaces 491a, 491b, 492a, and 492b. Surface numbers from 305 to 318 are sequentially assigned to the surface of the aperture stop 482, the surfaces 493a, 493b, 494a, 494b, 495a, 495b, 496a, 496b, 497a, 497b, 114a, and 114b, and the imaging surface 133a.

Note that, although not described, the curvature radiuses R, the surface intervals T, the refractive indexes Nd, and the Abbe numbers vd of the surfaces 491a to 497a are provided as respective values illustrated in the table of FIG. 29. The curvature radiuses R and the surface intervals T of the surfaces 491b to 497b are provided as respective values illustrated in the table of FIG. 29. Since the surface of the aperture stop 482 and the surfaces 114a and 114b are flat surfaces, the curvature radiuses R corresponding to SurfNum of 305, 316, and 317 are infinity. Note that, although not described, the surface intervals T of the surface of the aperture stop 482 and the surface 114b, and the surface interval T, the refractive index Nd, and the Abbe number vd of the surface 114a are provided as values illustrated in the table of FIG. 29, respectively.

The curvature radius R of the imaging surface 133a assigned with SurfNum of 318 is −30.000. Since there is no surface to which SurfNum of 319 next to 318 is assigned, the imaging surface 133a does not have a surface interval T.

### Third Example of Aspherical Data of Surfaces of Lenses

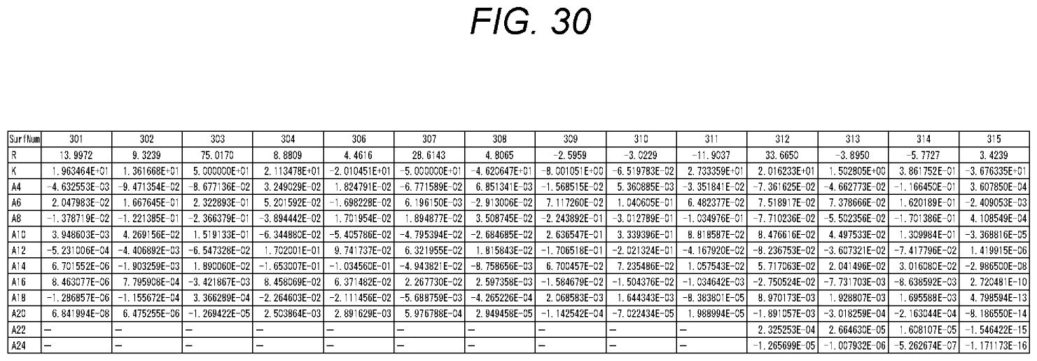

FIG. 30 is a table illustrating an example of aspherical data of the surfaces 491a to 497a and the surfaces 491b to 497b.

In the first column from the left of the table of FIG. 30, items corresponding to rows are described. The second and subsequent columns from the left correspond to the surfaces 491a, 491b, 492a, 492b, 493a, 493b, 494a, 494b, 495a, 495b, 496a, 496b, 497a, and 497b in order from the left. Each row in FIG. 30 is similar to each row in FIG. 18.

Note that, although not described, the curvature radiuses R, the conic coefficients K, and the n-th-order aspheric coefficients An (n=2, 4, 6, 8, 10, 12, 14, 16, 18, and 20) of the surfaces 491a to 495a and the surfaces 491b to 495b are provided as respective values illustrated in the table in FIG. 30. The curvature radiuses R, the conic coefficients K, and the n-th-order aspheric coefficients An (n=2, 4, 6, 8, 10, 12, 14, 16, 18, 20, 22, and 24) of the surfaces 496a, 496b, 497a, and 497b are provided as respective values illustrated in the table of FIG. 30.

### Third Example of Spherical Aberration, Field Curvature, and Distortion

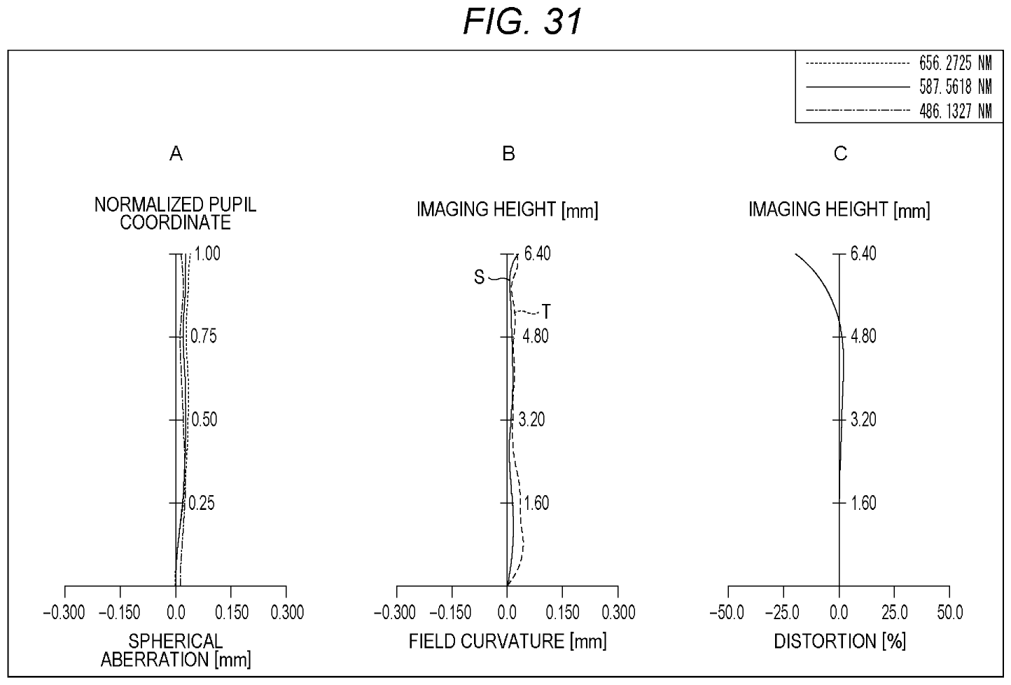

FIG. 31 illustrates graphs of examples of spherical aberration, field curvature, and distortion occurring in the imaging lens 116 in FIG. 27.

A of FIG. 31 is a graph illustrating spherical aberration for each wavelength of light having wavelengths of 486.1327 nm, 587.5618 nm, and 656.2725 nm, the spherical aberration occurring in the imaging lens 116 in FIG. 27.

B of FIG. 31 is a graph illustrating field curvature of light having a wavelength of 587.5618 nm, the field curvature occurring in the imaging lens 116. C of FIG. 31 is a graph illustrating distortion of light having a wavelength of 587.5618 nm, the distortion occurring in the imaging lens 116.

### Third Example of Lateral Aberration

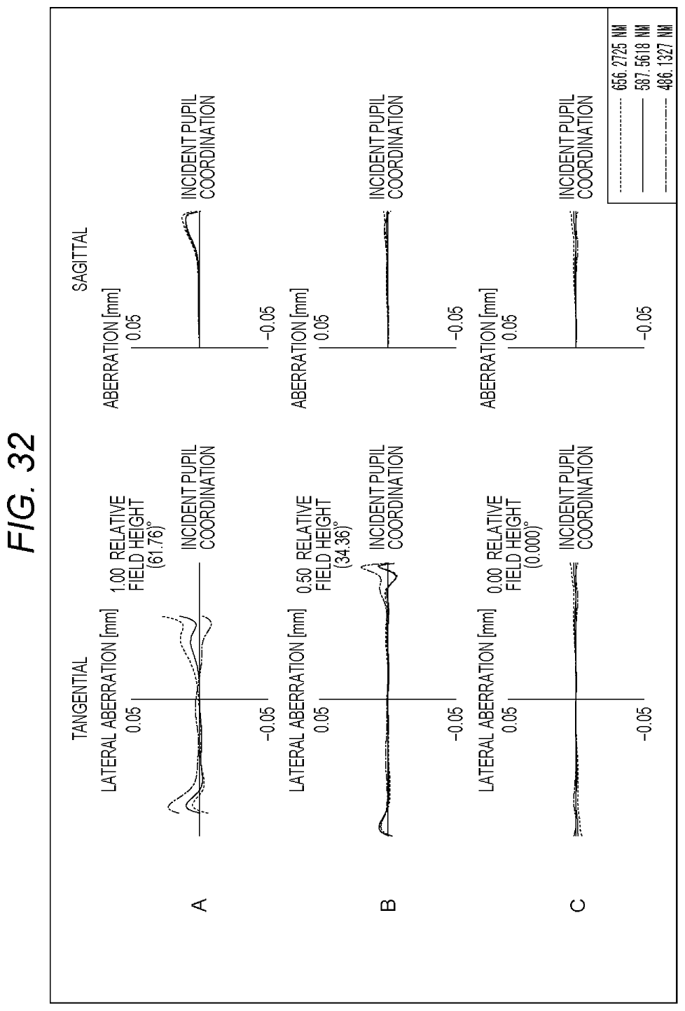

FIG. 32 illustrates graphs of examples of lateral aberration occurring in the imaging lens 116 in FIG. 27.

FIG. 32 illustrates graphs of lateral aberration for each wavelength of light having wavelengths of 486.1327 nm, 587.5618 nm, and 656.2725 nm, the lateral aberration occurring in imaging lens 116.

Specifically, the graphs on the left side in A to C of FIG. 32 represent the lateral aberration in the tangential direction at positions (positions of imaging heights in a case where half angles of view are 61.76°, 34.366°, and 0°) where the imaging heights are 1.00 mm, 0.50 mm, and 0.00 mm, respectively. The graphs on the right side in A to C of FIG. 32 represent lateral aberration in the sagittal direction at positions where the imaging heights are 1.00 mm, 0.50 mm, and 0.00 mm, respectively.

As illustrated in FIGS. 31 and 32, good aberration correction is performed in the imaging lens 116 in FIG. 27, and the imaging lens 116 in FIG. 27 has good imaging quality.

### Fourth Configuration Example of Imaging Lens

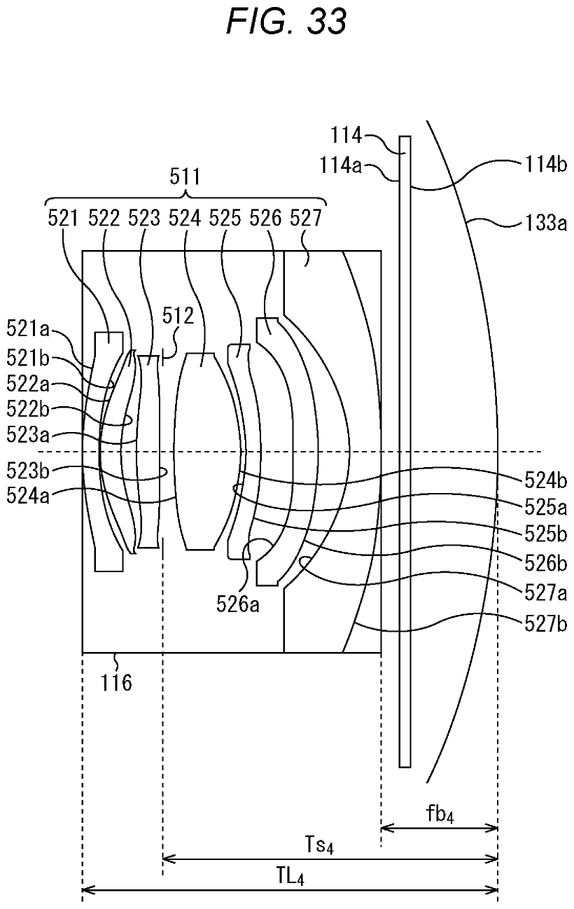

FIG. 33 is a cross-sectional view illustrating a fourth configuration example of the imaging lens 116.

The imaging lens 116 in FIG. 33 includes a lens group 511 and an aperture stop 512.

The lens group 511 includes seven lenses 521 to 527 which are aspherical lenses. The seven lenses 521 to 527 are arranged in order from the object side toward the imaging surface 133a side. The lens 521 has a surface 521a on the object side and a surface 521b on the imaging surface 133a side. Similarly to the lens 521, the lenses 522 to 527 also have surfaces 522a and 522b, surfaces 523a and 523b, surfaces 524a and 524b, surfaces 525a and 525b, surfaces 526a and 526b, and surfaces 527a and 527b, respectively.

The surfaces 521a to 527a and 521b to 526b are aspherical surfaces. Of the lenses 521 to 527, the imaging surface 133a-side surface 527b (last surface) of the lens 527 closest to the imaging surface 133a is an aspherical surface that is concave toward the object side as a whole, in which inclination of the surface is not reversed as a distance between the surface and the optical axis increases. The aperture stop 512 is disposed between the lenses 523 and 524 and limits light incident on the lens 524 from the lens 523. In the example of FIG. 33, the imaging surface 133a is a spherical surface.

The light incident on the imaging lens 116 from the object is emitted via the lenses 521 to 527 and the infrared cut filter 114 and is collected on the imaging surface 133a.

Note that, hereinafter, the total optical length of the imaging lens 116, which is a distance on the optical axis from the object-side surface 521a (foremost surface) of the lens 521 closest to the object side of the lenses 521 to 527 to the imaging surface 133a is referred to as TL₄. A distance on the optical axis from the surface 527b to the imaging surface 133a is referred to as fb₄, and a distance on the optical axis from the aperture stop 512 to the imaging surface 133a is referred to as Ts₄.

### Fourth Example of Various Setting Values of Entire Imaging Lens

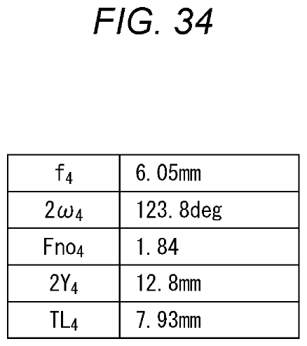

FIG. 34 is a table illustrating examples of various setting values of the entire imaging lens 116 in FIG. 33. As illustrated in FIG. 34, a focal length f₄ of the entire imaging lens 116 in FIG. 33 is 6.05 mm. A maximum angle of view 2ω₄ of the imaging lens 116 is 123.8 deg.

An F value Fno₄ of the imaging lens 116 is 1.84 and is 2.5 or less. In addition, 2Y₄ which is twice the maximum imaging height Y₄ is 12.8 mm, and the total optical length TL₄ is 7.93 mm.

### Fourth Example of Various Setting Values of Lenses, Aperture Stop, Imaging Surface, and Infrared Cut Filter

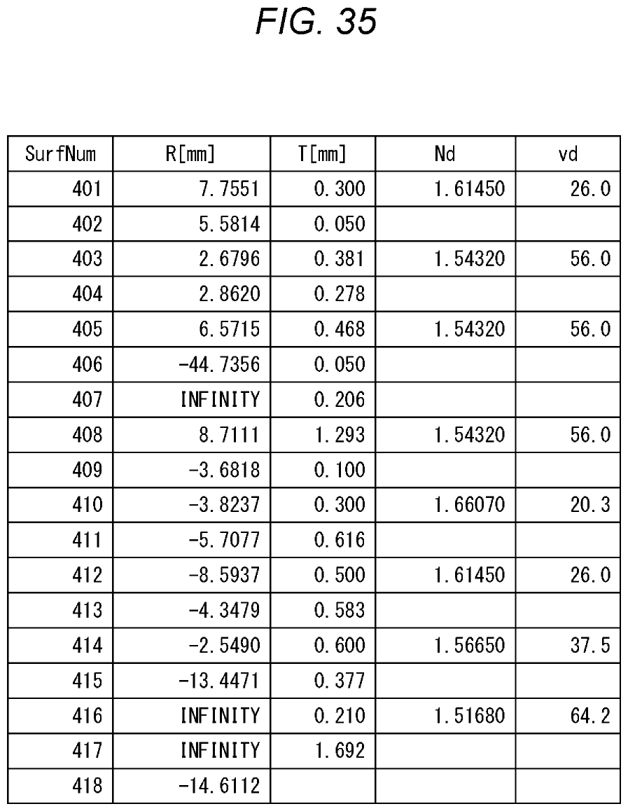

FIG. 35 is a table illustrating examples of various setting values of the lenses 521 to 527, the aperture stop 512, the infrared cut filter 114, and the imaging surface 133a in FIG. 33.

The first row from the top of the table in FIG. 35 shows items corresponding to respective columns. The second and subsequent rows from the top correspond to the surfaces 521a to 527a and the surfaces 521b to 527b, a surface of the aperture stop 512, the surfaces 114a and 114b, and the imaging surface 133a, respectively. Each column in FIG. 35 is similar to each column in FIG. 17.

In the present specification, surface numbers from 401 to 406 are sequentially assigned to the surfaces 521a, 521b, 522a, 522b, 523a, and 523b. Surface numbers from 407 to 418 are sequentially assigned to the surface of the aperture stop 512, the surfaces 524a, 524b, 525a, 525b, 526a, 526b, 527a, 527b, 114a, and 114b, and the imaging surface 133a.

Note that, although not described, the curvature radiuses R, the surface intervals T, the refractive indexes Nd, and the Abbe numbers vd of the surfaces 521a to 527a are provided as respective values illustrated in the table of FIG. 35. The curvature radiuses R and the surface intervals T of the surfaces 521b to 527b are provided as respective values illustrated in the table of FIG. 35. Since the surface of the aperture stop 512 and the surfaces 114a and 114b are flat surfaces, the curvature radiuses R corresponding to SurfNum of 407, 416, and 417 are infinity. Note that, although not described, the surface intervals T of the surface of the aperture stop 512 and the surface 114b, and the surface interval T, the refractive index Nd, and the Abbe number vd of the surface 114a are provided as values illustrated in the table of FIG. 35, respectively.

The curvature radius R of the imaging surface 133a assigned with SurfNum of 418 is −14.6122. Since there is no surface to which SurfNum of 419 next to 418 is assigned, the imaging surface 133a does not have a surface interval T.

### Fourth Example of Aspherical Data of Surfaces of Lenses

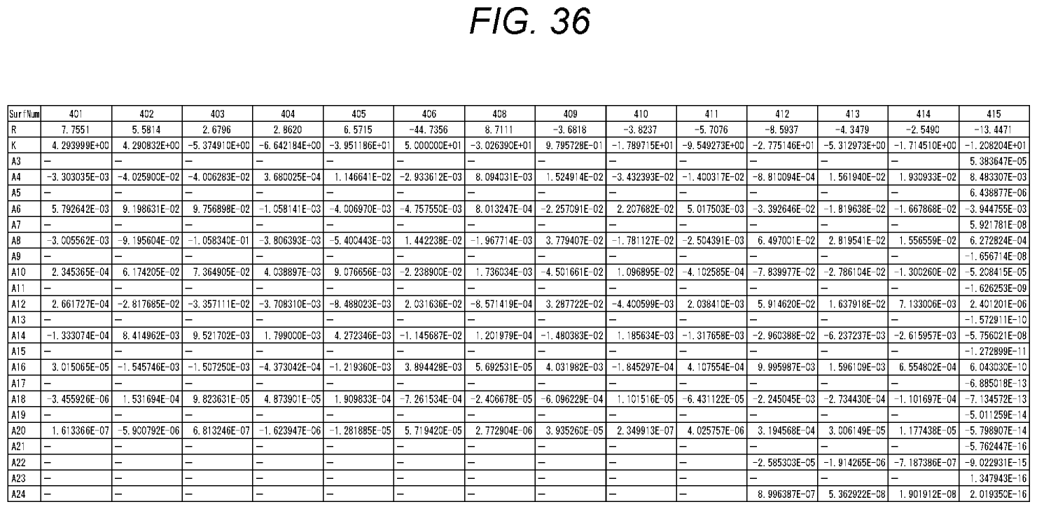

FIG. 36 is a table illustrating an example of aspherical data of the surfaces 521a to 527a and the surfaces 521b to 527b.

In the first column from the left of the table of FIG. 36, items corresponding to rows are described. The second and subsequent columns from the left correspond to the surfaces 521a, 521b, 522a, 522b, 523a, 523b, 524a, 524b, 525a, 525b, 526a, 526b, 527a, and 527b in order from the left. The rows in FIG. 36 correspond to, from top to bottom, items of SurfNum, curvature radiuses R, conic coefficients K, and a third-order aspheric coefficients A3 to a twenty-fourth-order aspheric coefficients A24.

Note that, although not described, the curvature radiuses R, the conic coefficients K, and the n-th-order aspheric coefficients An (n=4, 6, 8, 10, 12, 14, 16, 18, and 20) of the surfaces 521a to 525a and the surfaces 521b to 525b are provided as respective values illustrated in the table in FIG. 36. The curvature radiuses R, the conic coefficients K, and the n-th-order aspheric coefficients An (n=4, 6, 8, 10, 12, 14, 16, 18, 20, 22, and 24) of the surfaces 526a, 526b, and 527a are provided as respective values illustrated in the table of FIG. 36. The curvature radius R, the conic coefficient K, and the third-order aspheric coefficient A3 to the twenty-fourth-order aspheric coefficient A24 of the surface 527b are provided as respective values illustrated in the table of FIG. 36.

### Fourth Example of Spherical Aberration, Field Curvature, and Distortion

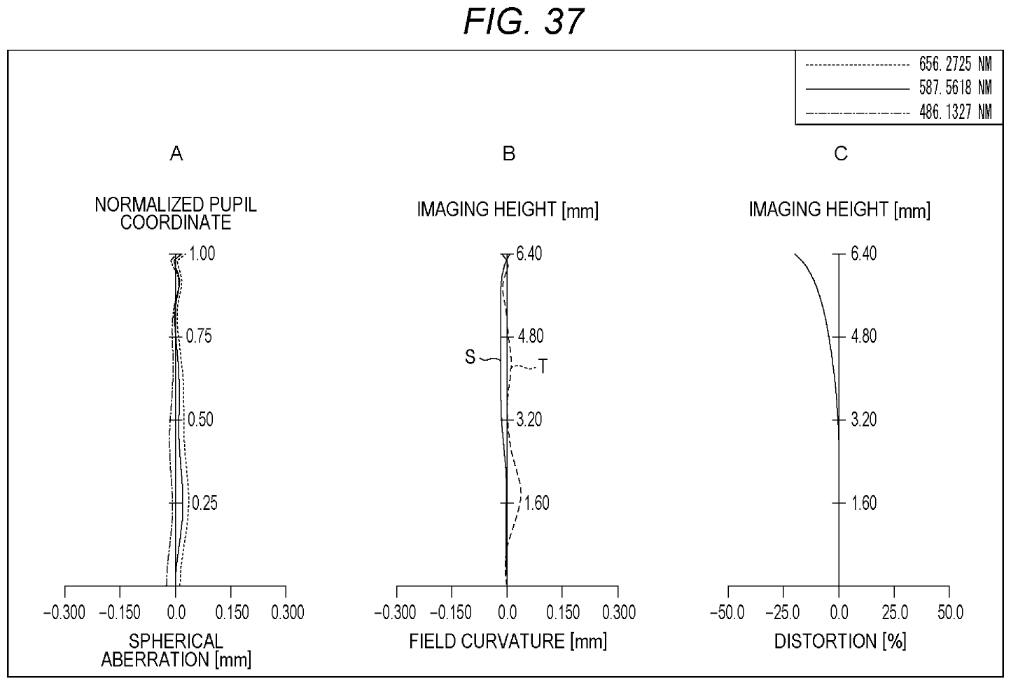

FIG. 37 illustrates graphs of examples of spherical aberration, field curvature, and distortion occurring in the imaging lens 116 in FIG. 33.

A of FIG. 37 is a graph illustrating spherical aberration for each wavelength of light having wavelengths of 486.1327 nm, 587.5618 nm, and 656.2725 nm, the spherical aberration occurring in the imaging lens 116 in FIG. 33.

B of FIG. 37 is a graph illustrating field curvature of light having a wavelength of 587.5618 nm, the field curvature occurring in the imaging lens 116. C of FIG. 37 is a graph illustrating distortion of light having a wavelength of 587.5618 nm, the distortion occurring in the imaging lens 116.

### Fourth Example of Lateral Aberration

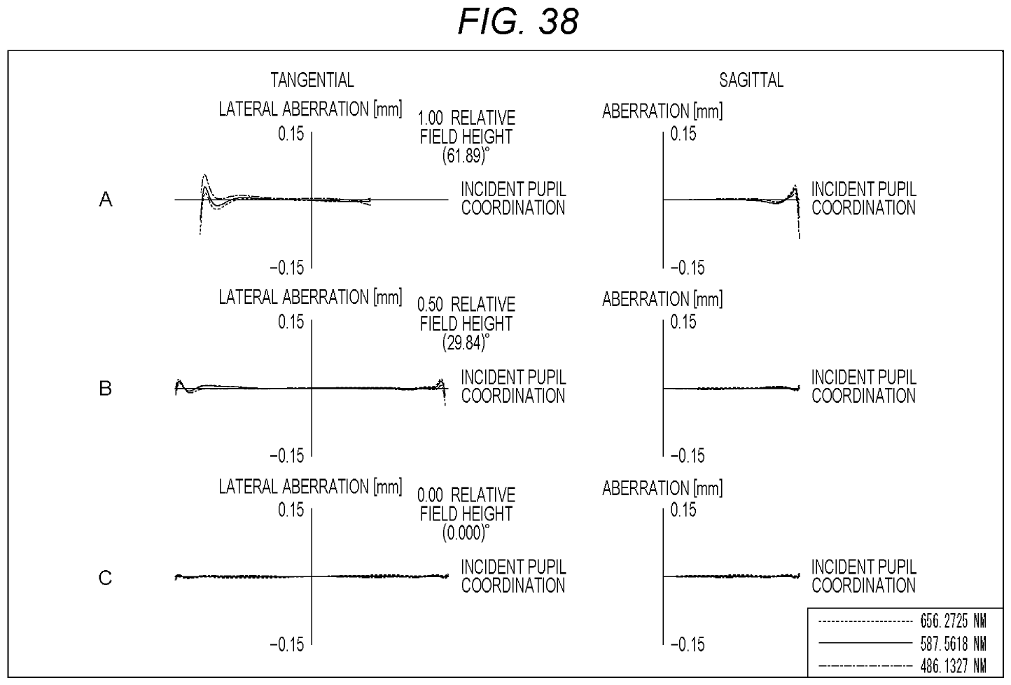

FIG. 38 illustrates graphs of examples of lateral aberration occurring in the imaging lens 116 in FIG. 33.

FIG. 38 illustrates graphs of lateral aberration for each wavelength of light having wavelengths of 486.1327 nm, 587.5618 nm, and 656.2725 nm, the lateral aberration occurring in imaging lens 116.

Specifically, the graphs on the left side in A to C of FIG. 38 represent the lateral aberration in the tangential direction at positions (positions of imaging heights in a case where half angles of view are 61.89°, 29.84°, and 0°) where the imaging heights are 1.00 mm, 0.50 mm, and 0.00 mm, respectively. The graphs on the right side in A to C of FIG. 38 represent lateral aberration in the sagittal direction at positions where the imaging heights are 1.00 mm, 0.50 mm, and 0.00 mm, respectively.

As illustrated in FIGS. 37 and 38, good aberration correction is performed in the imaging lens 116 in FIG. 33, and the imaging lens 116 in FIG. 33 has good imaging quality.

### Fifth Configuration Example of Imaging Lens

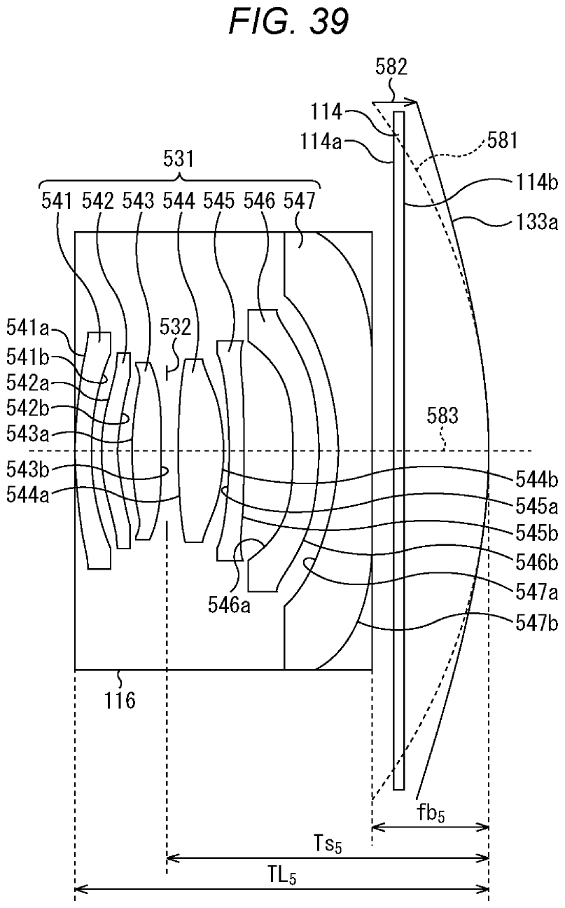

FIG. 39 is a cross-sectional view illustrating a fifth configuration example of the imaging lens 116.

The imaging lens 116 in FIG. 39 includes a lens group 531 and an aperture stop 532.

The lens group 531 includes seven lenses 541 to 547 which are aspherical lenses. The seven lenses 541 to 547 are arranged in order from the object side toward the imaging surface 133a side. The lens 541 has a surface 541a on the object side and a surface 541b on the imaging surface 133a side. Similarly to the lens 541, the lenses 542 to 547 also have surfaces 542a and 542b, surfaces 543a and 543b, surfaces 544a and 544b, surfaces 545a and 545b, surfaces 546a and 546b, and surfaces 547a and 547b, respectively.

The surfaces 541a to 547a and 541b to 546b are aspherical surfaces. Of the lenses 541 to 547, the imaging surface 133a-side surface 547b (last surface) of the lens 547 closest to the imaging surface 133a is an aspherical surface that is concave toward the object side as a whole, in which inclination of the surface is not reversed as a distance between the surface and the optical axis increases. The aperture stop 532 is disposed between the lenses 543 and 544 and limits light incident on the lens 544 from the lens 543.

In the example of FIG. 39, the imaging surface 133a is an aspherical surface in which a displacement amount 552 with respect to the spherical surface 551 increases in a direction in which the imaging surface is away from the imaging lens 116, that is, in a right direction in FIG. 39, as a distance from an optical axis 553 increases. Therefore, it is easy to perform both field curvature corrections of a low imaging height and a high imaging height. Furthermore, it is possible to secure a space between the imaging lens 116 or the infrared cut filter 114 and the imaging surface 133a while shortening a total optical length TL₅. As a result, it is easy to dispose a mechanical member such as the filter holder 113. Curvature decreases as the distance from the optical axis 553 increases, and thus wire bonding or the like using the wire 134 can be easily performed.

Note that, the total optical length TL₅ is a distance on the optical axis 553 from the object-side surface 541a (foremost surface) of the lens 541 closest to the object side of the lenses 541 to 547 to the imaging surface 133a.

The light incident on the imaging lens 116 from the object is emitted via the lenses 541 to 547 and the infrared cut filter 114 and is collected on the imaging surface 133a.

Note that, hereinafter, a distance on the optical axis 553 from the surface 547b to the imaging surface 133a is referred to as fb₅, and a distance on the optical axis 553 from the aperture stop 532 to the imaging surface 133a is referred to as Ts₅.

### Fifth Example of Various Setting Values of Entire Imaging Lens

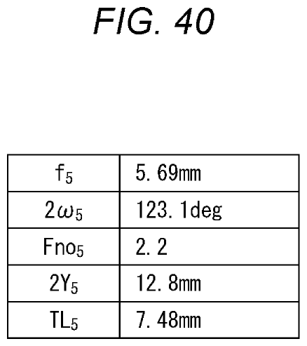

FIG. 40 is a table illustrating examples of various setting values of the entire imaging lens 116 in FIG. 39. As illustrated in FIG. 40, a focal length f₅ of the entire imaging lens 116 in FIG. 39 is 5.69 mm. A maximum angle of view 2ω₅ of the imaging lens 116 is 123.1 deg.

An F value Fno₅ of the imaging lens 116 is 2.2 and is 2.5 or less. In addition, 2Y₅ which is twice the maximum imaging height Y₅ is 12.8 mm, and the total optical length TL₅ is 7.48 mm.

### Fifth Example of Various Setting Values of Lenses, Aperture Stop, Imaging Surface, and Infrared Cut Filter

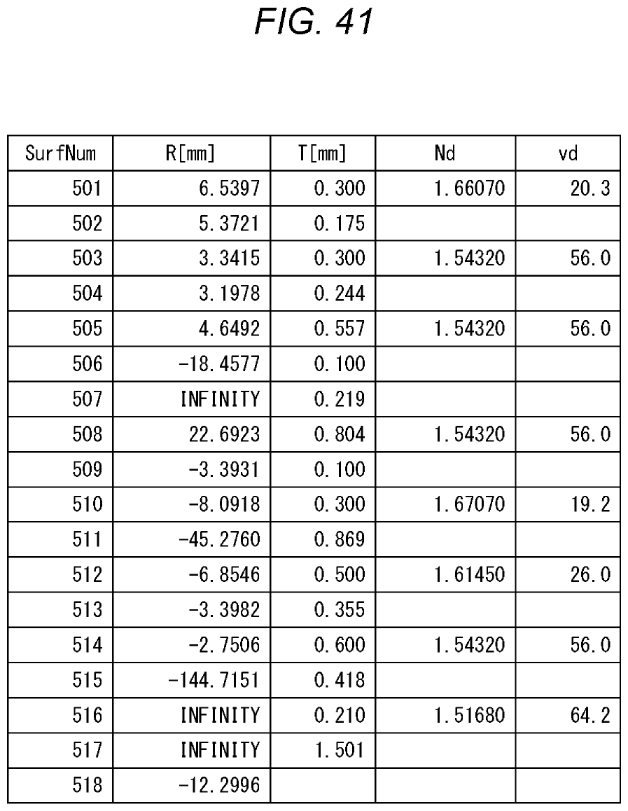

FIG. 41 is a table illustrating examples of various setting values of the lenses 541 to 547, the aperture stop 532, the infrared cut filter 114, and the imaging surface 133a in FIG. 39.

The first row from the top of the table in FIG. 41 shows items corresponding to respective columns. The second and subsequent rows from the top correspond to the surfaces 541a to 547a and the surfaces 541b to 547b, a surface of the aperture stop 532, the surfaces 114a and 114b, and the imaging surface 133a, respectively. Each column in FIG. 41 is similar to each column in FIG. 17.

In the present specification, surface numbers from 501 to 506 are sequentially assigned to the surfaces 541a, 541b, 542a, 542b, 543a, and 543b. Surface numbers from 507 to 518 are sequentially assigned to the surface of the aperture stop 532, the surfaces 544a, 544b, 545a, 545b, 546a, 546b, 547a, 547b, 114a, and 114b, and the imaging surface 133a.

Note that, although not described, the curvature radiuses R, the surface intervals T, the refractive indexes Nd, and the Abbe numbers vd of the surfaces 541a to 547a are provided as respective values illustrated in the table of FIG. 41. The curvature radiuses R and the surface intervals T of the surfaces 541b to 547b are provided as respective values illustrated in the table of FIG. 41.

Since the surface of the aperture stop 532 and the surfaces 114a and 114b are flat surfaces, the curvature radiuses R corresponding to SurfNum of 507, 516, and 517 are infinity. Note that, although not described, the surface intervals T of the surface of the aperture stop 532 and the surface 114b, and the surface interval T, the refractive index Nd, and the Abbe number vd of the surface 114a are provided as values illustrated in the table of FIG. 41, respectively.

The curvature radius R of the imaging surface 133a assigned with SurfNum of 518 is −12.2996. Since there is no surface to which SurfNum of 519 next to 518 is assigned, the imaging surface 133a does not have a surface interval T.

### Fifth Example of Aspherical Data of Surfaces of Lenses and Imaging Surface

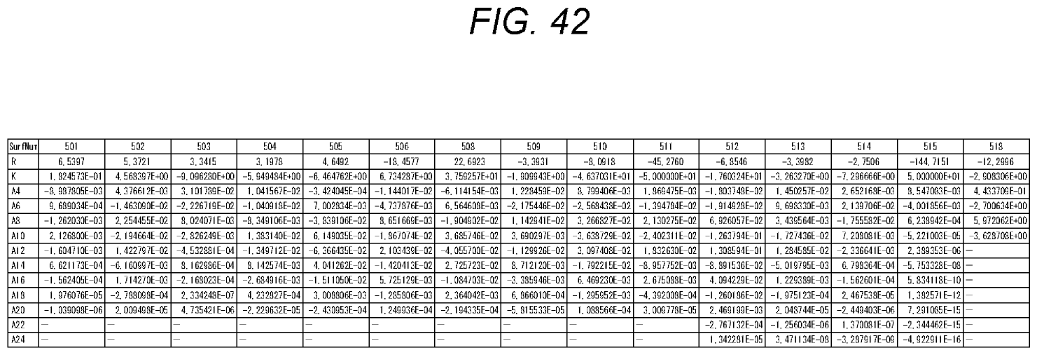

FIG. 42 is a table illustrating an example of aspherical data of the surfaces 541a to 547a, the surfaces 541b to 547b, and the imaging surface 133a in FIG. 39.

In the first column from the left of the table of FIG. 42, items corresponding to rows are described. The second and subsequent columns from the left correspond to the surfaces 541a, 541b, 542a, 542b, 543a, 543b, 544a, 544b, 545a, 545b, 546a, 546b, 547a, 547b, and the imaging surface 133a of FIG. 39 in order from the left. Each row in FIG. 42 is similar to each row in FIG. 18.

Note that, although not described, the curvature radiuses R, the conic coefficients K, and the n-th-order aspheric coefficients An (n=2, 4, 6, 8, 10, 12, 14, 16, 18, and 20) of the surfaces 541a to 545a and the surfaces 541b to 545b are provided as respective values illustrated in the table in FIG. 42. The curvature radiuses R, the conic coefficients K, and the n-th-order aspheric coefficients An (n=2, 4, 6, 8, 10, 12, 14, 16, 18, 20, 22, and 24) of the surfaces 546a, 546b, 547a, and 547b are provided as respective values illustrated in the table of FIG. 42. The curvature radius R, the conic coefficient K, and the n-th-order aspheric coefficients An (n=4, 6, 8, and 10) of the imaging surface 133a are provided as respective values illustrated in the table of FIG. 42.

### Fifth Example of Spherical Aberration, Field Curvature, and Distortion

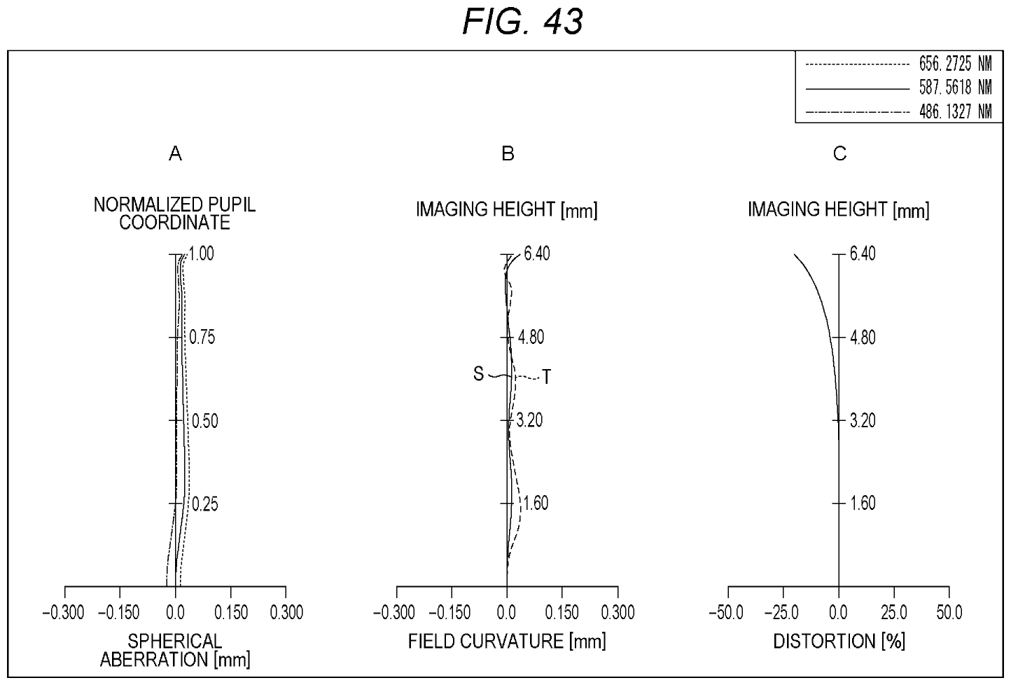

FIG. 43 illustrates graphs of examples of spherical aberration, field curvature, and distortion occurring in the imaging lens 116 in FIG. 39.

A of FIG. 43 is a graph illustrating spherical aberration for each wavelength of light having wavelengths of 486.1327 nm, 587.5618 nm, and 656.2725 nm, the spherical aberration occurring in the imaging lens 116 in FIG. 39.

B of FIG. 43 is a graph illustrating field curvature of light having a wavelength of 587.5618 nm, the field curvature occurring in the imaging lens 116. C of FIG. 43 is a graph illustrating distortion of light having a wavelength of 587.5618 nm, the distortion occurring in the imaging lens 116.

### Fifth Example of Lateral Aberration

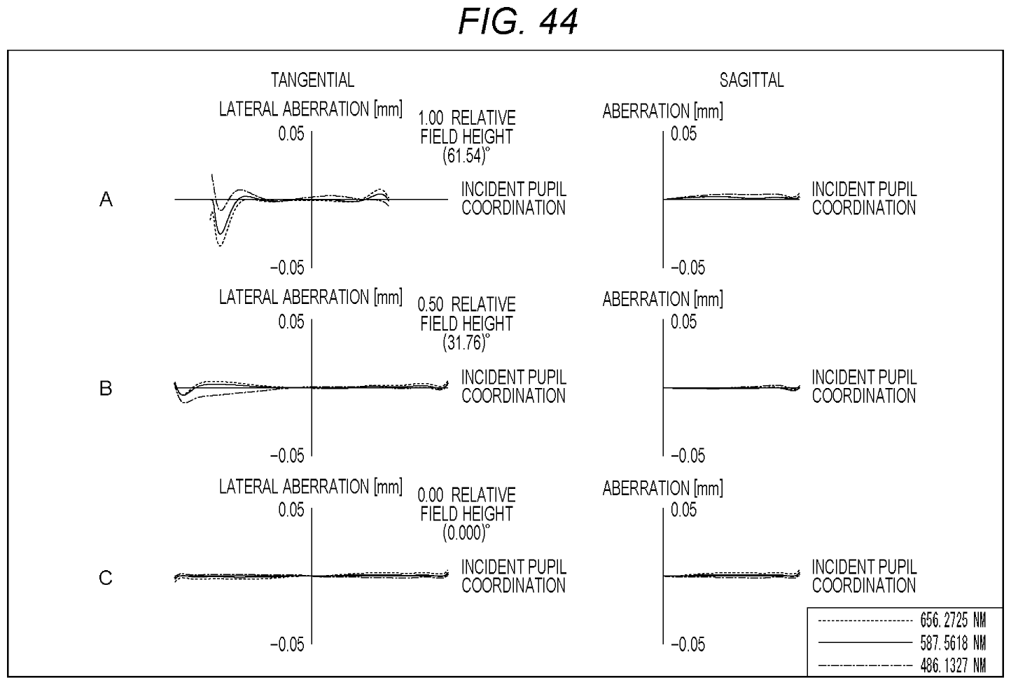

FIG. 44 illustrates graphs of examples of lateral aberration occurring in the imaging lens 116 in FIG. 39. FIG. 44 illustrates graphs of lateral aberration for each wavelength of light having wavelengths of 486.1327 nm, 587.5618 nm, and 656.2725 nm, the lateral aberration occurring in imaging lens 116.

Specifically, the graphs on the left side in A to C of FIG. 44 represent the lateral aberration in the tangential direction at positions (positions of imaging heights in a case where half angles of view are 61.54°, 31.76°, and 0°) where the imaging heights are 1.00 mm, 0.50 mm, and 0.00 mm, respectively. The graphs on the right side in A to C of FIG. 44 represent lateral aberration in the sagittal direction at positions where the imaging heights are 1.00 mm, 0.50 mm, and 0.00 mm, respectively.

As illustrated in FIGS. 43 and 44, good aberration correction is performed in the imaging lens 116 in FIG. 39, and the imaging lens 116 in FIG. 39 has good imaging quality.

### Sixth Configuration Example of Imaging Lens

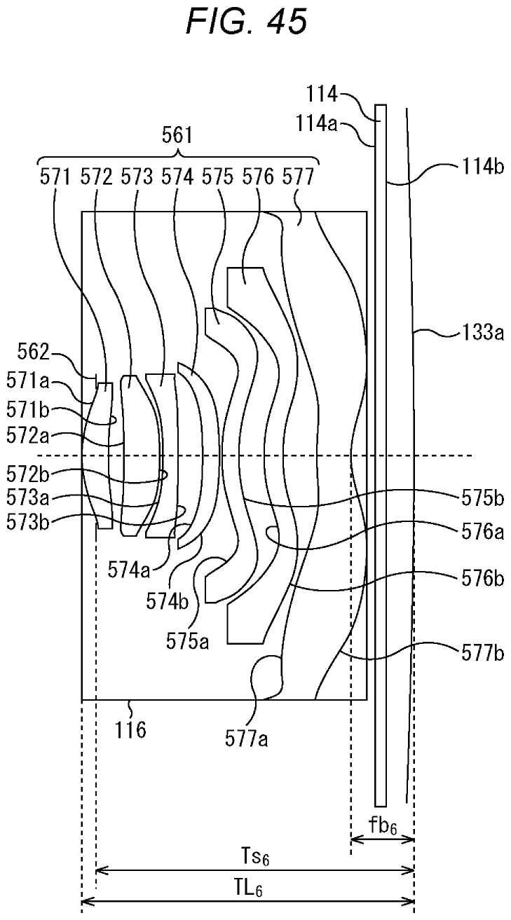

FIG. 45 is a cross-sectional view illustrating a sixth configuration example of the imaging lens 116.

The imaging lens 116 in FIG. 45 includes a lens group 561 and an aperture stop 562.

The lens group 561 includes seven lenses 571 to 577 which are aspherical lenses. The seven lenses 571 to 577 are arranged in order from the object side toward the imaging surface 133a side. The lens 571 has a surface 571a on the object side and a surface 571b on the imaging surface 133a side. Similarly to the lens 571, the lenses 572 to 577 also have surfaces 572a and 572b, surfaces 573a and 573b, surfaces 574a and 574b, surfaces 575a and 575b, surfaces 576a and 576b, and surfaces 577a and 577b, respectively.

The surfaces 571a to 577a and 571b to 577b are aspherical surfaces. The aperture stop 562 is disposed on the object side from the lens 571 and limits light incident on the lens 571. In the example of FIG. 45, the imaging surface 133a is a spherical surface.

The light incident on the imaging lens 116 from the object is emitted via the lenses 571 to 577 and the infrared cut filter 114 and is collected on the imaging surface 133a.

Note that, hereinafter, the total optical length of the imaging lens 116, which is a distance on the optical axis from the object-side surface 571a (foremost surface) of the lens 571 closest to the object side of the lenses 571 to 577 to the imaging surface 133a is referred to as TL₆. A distance on the optical axis from the surface 577b to the imaging surface 133a is referred to as fb₆, and a distance on the optical axis from the aperture stop 562 to the imaging surface 133a is referred to as Ts₆.

### Sixth Example of Various Setting Values of Entire Imaging Lens

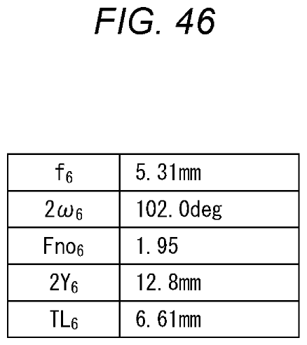

FIG. 46 is a table illustrating examples of various setting values of the entire imaging lens 116 in FIG. 45. As illustrated in FIG. 46, a focal length f₆ of the entire imaging lens 116 in FIG. 45 is 5.31 mm. A maximum angle of view 2 ω₆ of the imaging lens 116 is 102.0 deg. An F value Fno₆ of the imaging lens 116 is 1.95 and is 2.5 or less. In addition, 2Y₆ which is twice the maximum imaging height Y₆ is 12.8 mm, and the total optical length TL₆ is 6.61 mm.

### Sixth Example of Various Setting Values of Lenses, Aperture Stop, Imaging Surface, and Infrared Cut Filter

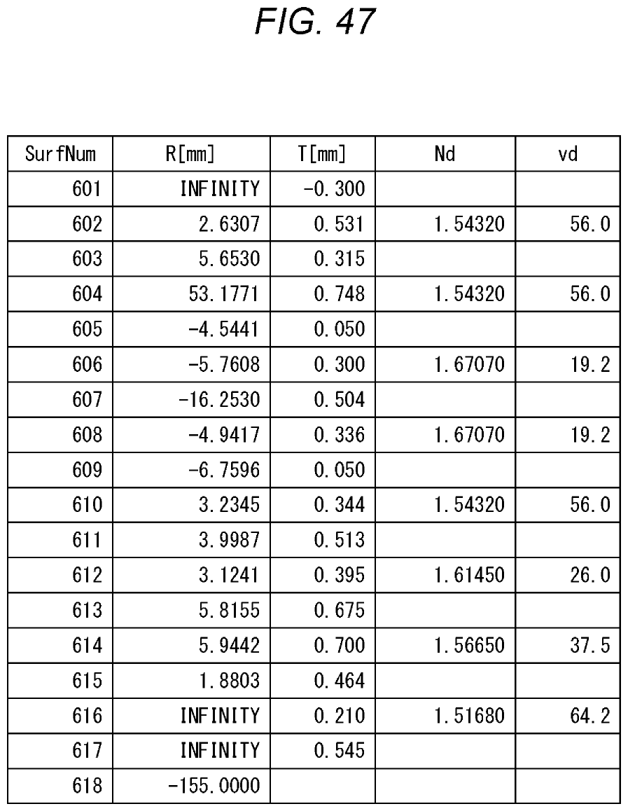

FIG. 47 is a table illustrating examples of various setting values of the lenses 571 to 577, the aperture stop 562, the infrared cut filter 114, and the imaging surface 133a in FIG. 45.

The first row from the top of the table in FIG. 47 shows items corresponding to respective columns. The second and subsequent rows from the top correspond to a surface of the aperture stop 562, the surfaces 571a to 577a and the surfaces 571b to 577b, the surfaces 114a and 114b, and the imaging surface 133a, respectively. Each column in FIG. 47 is similar to each column in FIG. 17.

In the present specification, surface numbers from 601 to 605 are sequentially assigned to the surface of the aperture stop 562, the surfaces 571a, 571b, 572a, and 572b. Surface numbers from 606 to 618 are sequentially assigned to the surfaces 573a, 573b, 574a, 574b, 575a, 575b, 576a, 576b, 577a, 577b, 114a, and 114b, and the imaging surface 133a.

Note that, although not described, the curvature radiuses R, the surface intervals T, the refractive indexes Nd, and the Abbe numbers vd of the surfaces 571a to 577a are provided as respective values illustrated in the table of FIG. 47. The curvature radiuses R and the surface intervals T of the surfaces 571b to 577b are provided as respective values illustrated in the table of FIG. 47. Since the surface of the aperture stop 562 and the surfaces 114a and 114b are flat surfaces, the curvature radiuses R corresponding to SurfNum of 601, 616, and 617 are infinity. Note that, although not described, the surface intervals T of the surface of the aperture stop 562 and the surface 114b, and the surface interval T, the refractive index Nd, and the Abbe number vd of the surface 114a are provided as values illustrated in the table of FIG. 47, respectively.

The curvature radius R of the imaging surface 133a assigned with SurfNum of 618 is −155.000. Since there is no surface to which SurfNum of 619 next to 618 is assigned, the imaging surface 133a does not have a surface interval T.

### Sixth Example of Aspherical Data of Surfaces of Lenses

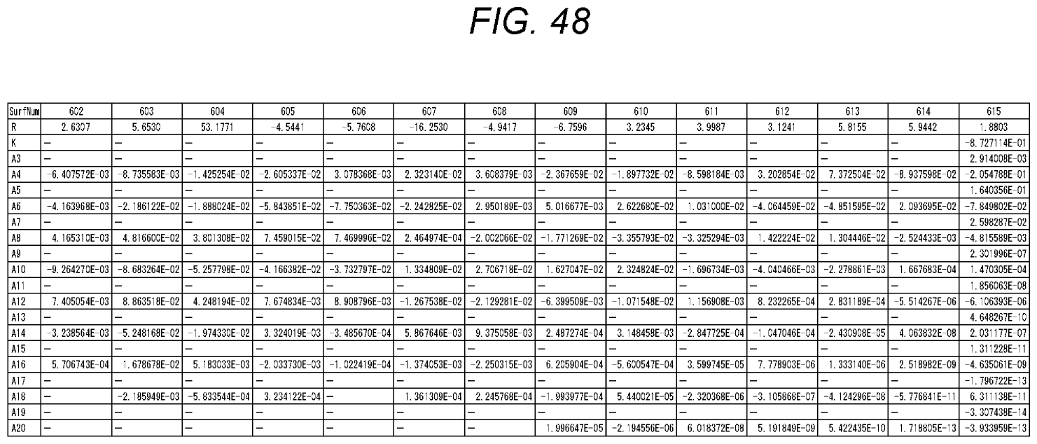

FIG. 48 is a table illustrating an example of aspherical data of the surfaces 571a to 577a and the surfaces 571b to 577b.

In the first column from the left of the table of FIG. 48, items corresponding to rows are described. The second and subsequent columns from the left correspond to the surfaces 571a, 571b, 572a, 572b, 573a, 573b, 574a, 574b, 575a, 575b, 576a, 576b, 577a, and 577b in order from the left. The rows in FIG. 48 correspond to, from top to bottom, items of SurfNum, curvature radiuses R, conic coefficients K, and a third-order aspheric coefficients A3 to a twentieth-order aspheric coefficients A20.

Note that, although not described, the curvature radiuses R and the n-th-order aspheric coefficients An (n=4, 6, 8, 10, 12, 14, and 16) of the surfaces 571a and 573a are provided as respective values illustrated in the table in FIG. 48. The curvature radiuses R and the n-th-order aspheric coefficients An (n=4, 6, 8, 10, 12, 14, 16, and 18) of the surfaces 571b to 573b, 572a, and 574a are provided as respective values illustrated in the table of FIG. 48. The curvature radiuses R and the n-th-order aspheric coefficients An (n=4, 6, 8, 10, 12, 14, 16, 18, and 20) of the surfaces 575a to 577a and 574b to 576b are provided as respective values illustrated in the table of FIG. 48. The curvature radius R, the conic coefficient K, and the third-order aspheric coefficient A3 to the twentieth-order aspheric coefficient A20 of the surface 577b are provided as respective values illustrated in the table of FIG. 48.

### Sixth Example of Spherical Aberration, Field Curvature, and Distortion

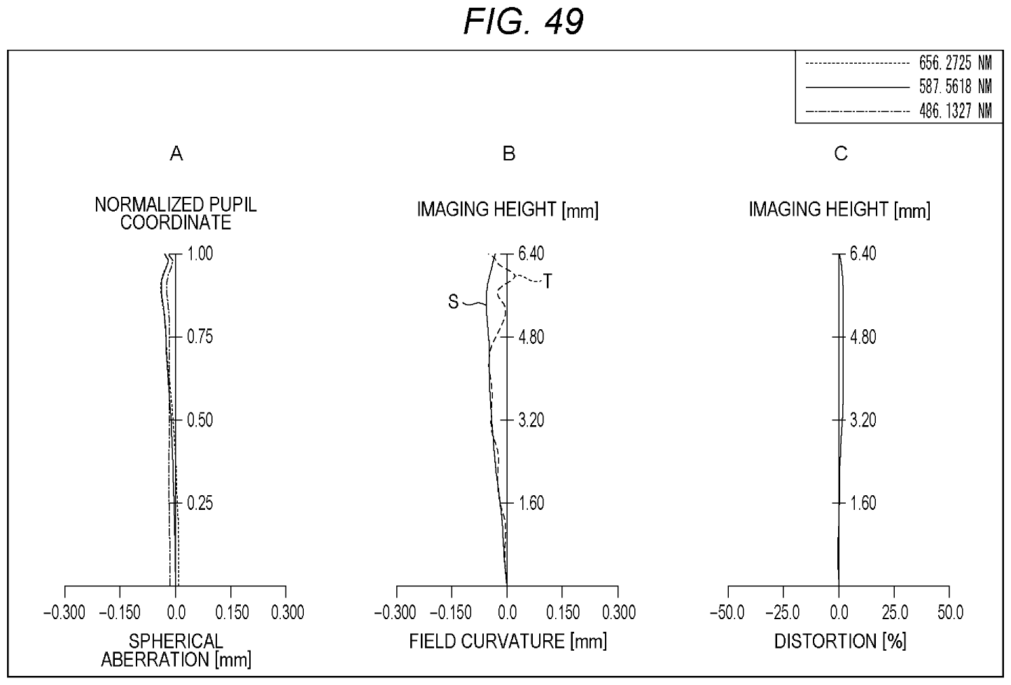

FIG. 49 illustrates graphs of examples of spherical aberration, field curvature, and distortion occurring in the imaging lens 116 in FIG. 45.

A of FIG. 49 is a graph illustrating spherical aberration for each wavelength of light having wavelengths of 486.1327 nm, 587.5618 nm, and 656.2725 nm, the spherical aberration occurring in the imaging lens 116 in FIG. 45.

B of FIG. 49 is a graph illustrating field curvature of light having a wavelength of 587.5618 nm, the field curvature occurring in the imaging lens 116. C of FIG. 49 is a graph illustrating distortion of light having a wavelength of 587.5618 nm, the distortion occurring in the imaging lens 116.

### Sixth Example of Lateral Aberration

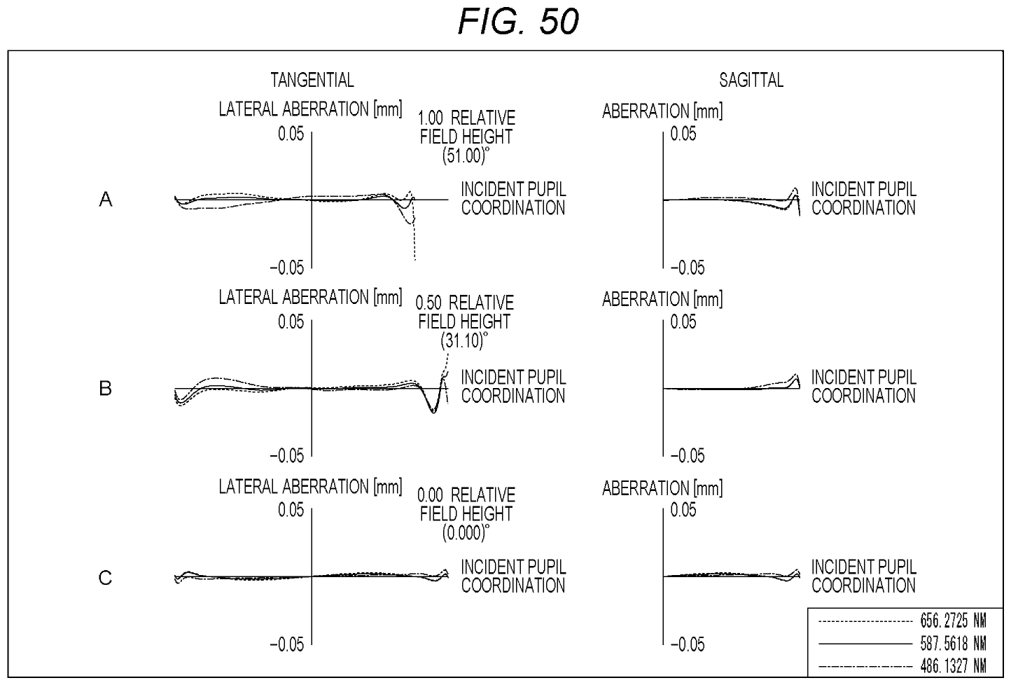

FIG. 50 illustrates graphs of examples of lateral aberration occurring in the imaging lens 116 in FIG. 45.

FIG. 50 illustrates graphs of lateral aberration for each wavelength of light having wavelengths of 486.1327 nm, 587.5618 nm, and 656.2725 nm, the lateral aberration occurring in imaging lens 116.

Specifically, the graphs on the left side in A to C of FIG. 50 represent the lateral aberration in the tangential direction at positions (positions of imaging heights in a case where half angles of view are 51.00°, 31.10°, and 0°) where the imaging heights are 1.00 mm, 0.65 mm, and 0.00 mm, respectively. The graphs on the right side in A to C of FIG. 50 represent lateral aberration in the sagittal direction at positions where the imaging heights are 1.00 mm, 0.65 mm, and 0.00 mm, respectively.

As illustrated in FIGS. 49 and 50, good aberration correction is performed in the imaging lens 116 in FIG. 45, and the imaging lens 116 in FIG. 45 has good imaging quality.

### Seventh Configuration Example of Imaging Lens

FIG. 51 is a cross-sectional view illustrating a seventh configuration example of the imaging lens 116.

The imaging lens 116 in FIG. 51 includes a lens group 591 and an aperture stop 592.

The lens group 591 includes seven lenses 601 to 607 which are aspherical lenses. The seven lenses 601 to 607 are arranged in order from the object side toward the imaging surface 133a side. The lens 601 has a surface 601a on the object side and a surface 601b on the imaging surface 133a side. Similarly to the lens 601, the lenses 602 to 607 also have surfaces 602a and 602b, surfaces 603a and 603b, surfaces 604a and 604b, surfaces 605a and 605b, surfaces 606a and 606b, and surfaces 607a and 607b, respectively.

The surfaces 601a to 607a and 601b to 607b are aspherical surfaces. The aperture stop 592 is disposed between the lenses 603 and 604 and limits light incident on the lens 604 from the lens 603. In the example of FIG. 51, the imaging surface 133a is a spherical surface.

The light incident on the imaging lens 116 from the object is emitted via the lenses 601 to 607 and the infrared cut filter 114 and is collected on the imaging surface 133a.

Note that, hereinafter, the total optical length of the imaging lens 116, which is a distance on the optical axis from the object-side surface 601a (foremost surface) of the lens 601 closest to the object side of the lenses 601 to 607 to the imaging surface 133a is referred to as TL₇. A distance on the optical axis from the surface 607b to the imaging surface 133a is referred to as fb₇, and a distance on the optical axis from the aperture stop 592 to the imaging surface 133a is referred to as Ts₇.

### Seventh Example of Various Setting Values of Entire Imaging Lens

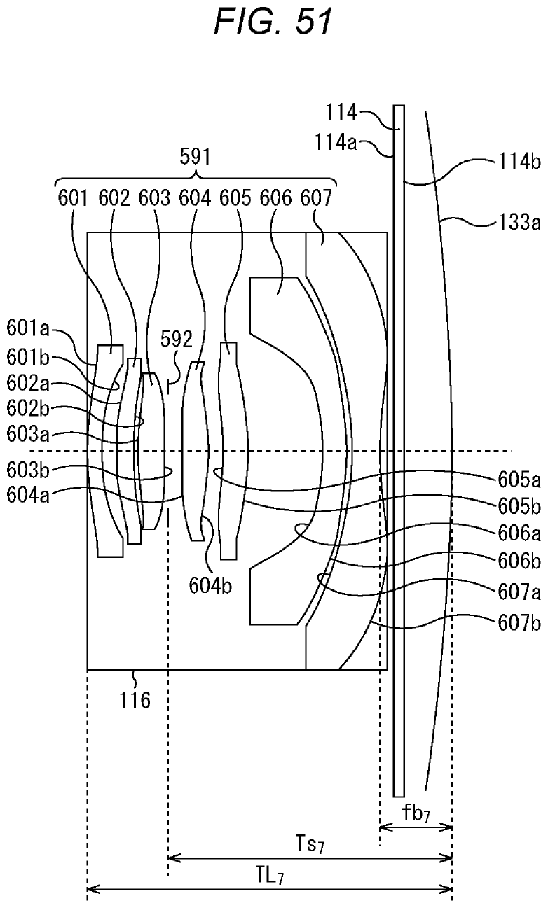

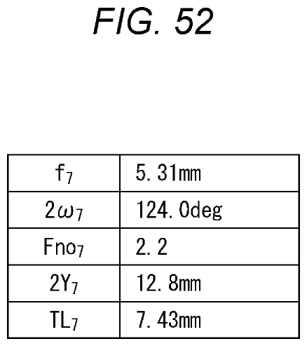

FIG. 52 is a table illustrating examples of various setting values of the entire imaging lens 116 in FIG. 51.

As illustrated in FIG. 52, a focal length f₇ of the entire imaging lens 116 in FIG. 51 is 5.31 mm. A maximum angle of view 2ω₇ of the imaging lens 116 is 124.0 deg.

An F value Fno₇ of the imaging lens 116 is 2.2 and is 2.5 or less. In addition, 2Y₇ which is twice the maximum imaging height Y₇ is 12.8 mm, and the total optical length TL₇ is 7.43 mm.

### Seventh Example of Various Setting Values of Lenses, Aperture Stop, Imaging Surface, and Infrared Cut Filter

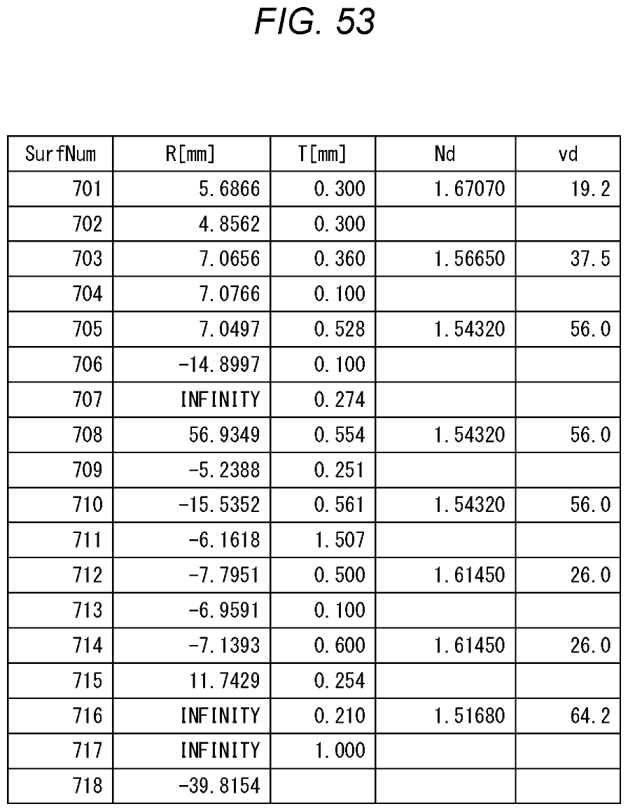

FIG. 53 is a table illustrating examples of various setting values of the lenses 601 to 607, the aperture stop 592, the infrared cut filter 114, and the imaging surface 133a in FIG. 51.

The first row from the top of the table in FIG. 53 shows items corresponding to respective columns. The second and subsequent rows from the top correspond to the surfaces 601a to 607a and the surfaces 601b to 607b, a surface of the aperture stop 592, the surfaces 114a and 114b, and the imaging surface 133a, respectively. Each column in FIG. 53 is similar to each column in FIG. 17.

In the present specification, surface numbers from 701 to 706 are sequentially assigned to the surfaces 601a, 601b, 602a, 602b, 603a, and 603b. Surface numbers from 707 to 718 are sequentially assigned to the surface of the aperture stop 592, the surfaces 604a, 604b, 605a, 605b, 606a, 606b, 607a, 607b, 114a, and 114b, and the imaging surface 133a.

Note that, although not described, the curvature radiuses R, the surface intervals T, the refractive indexes Nd, and the Abbe numbers vd of the surfaces 601a to 607a are provided as respective values illustrated in the table of FIG. 53. The curvature radiuses R and the surface intervals T of the surfaces 601b to 607b are provided as respective values illustrated in the table of FIG. 53. Since the surface of the aperture stop 592 and the surfaces 114a and 114b are flat surfaces, the curvature radiuses R corresponding to SurfNum of 707, 716, and 717 are infinity. Note that, although not described, the surface intervals T of the surface of the aperture stop 592 and the surface 114b, and the surface interval T, the refractive index Nd, and the Abbe number vd of the surface 114a are provided as values illustrated in the table of FIG. 53, respectively.

The curvature radius R of the imaging surface 133a assigned with SurfNum of 718 is −39.8154. Since there is no surface to which SurfNum of 719 next to 718 is assigned, the imaging surface 133a does not have a surface interval T.

### Seventh Example of Aspherical Data of Surfaces of Lenses

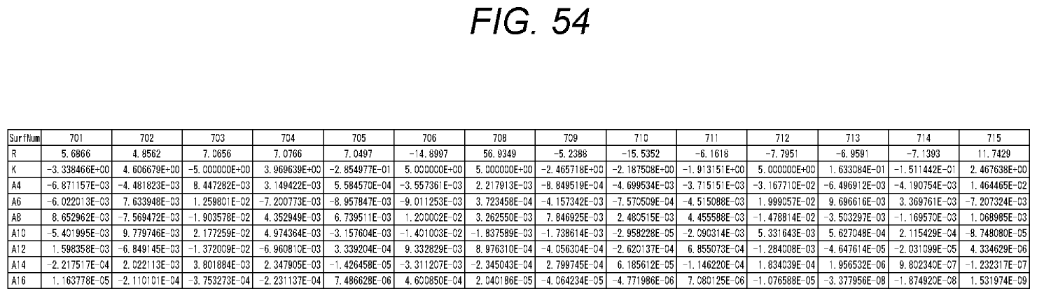

FIG. 54 is a table illustrating an example of aspherical data of the surfaces 601a to 607a and the surfaces 601b to 607b.

In the first column from the left of the table of FIG. 54, items corresponding to rows are described. The second and subsequent columns from the left correspond to the surfaces 601a, 601b, 602a, 602b, 603a, 603b, 604a, 604b, 605a, 605b, 606a, 606b, 607a, and 607b in order from the left. The rows in FIG. 54 correspond to, from top to bottom, items of SurfNum, curvature radiuses R, conic coefficients K, and n-th-order aspheric coefficients An (n=4, 6, 8, 10, 12, 14, and 16).

Note that, although not described, the curvature radiuses R, the conic coefficients K, and the n-th-order aspheric coefficients An (n=4, 6, 8, 10, 12, 14, and 16) of the surfaces 601a to 607a and the surfaces 601b to 607b are provided as respective values illustrated in the table in FIG. 54.

### Seventh Example of Spherical Aberration, Field Curvature, and Distortion

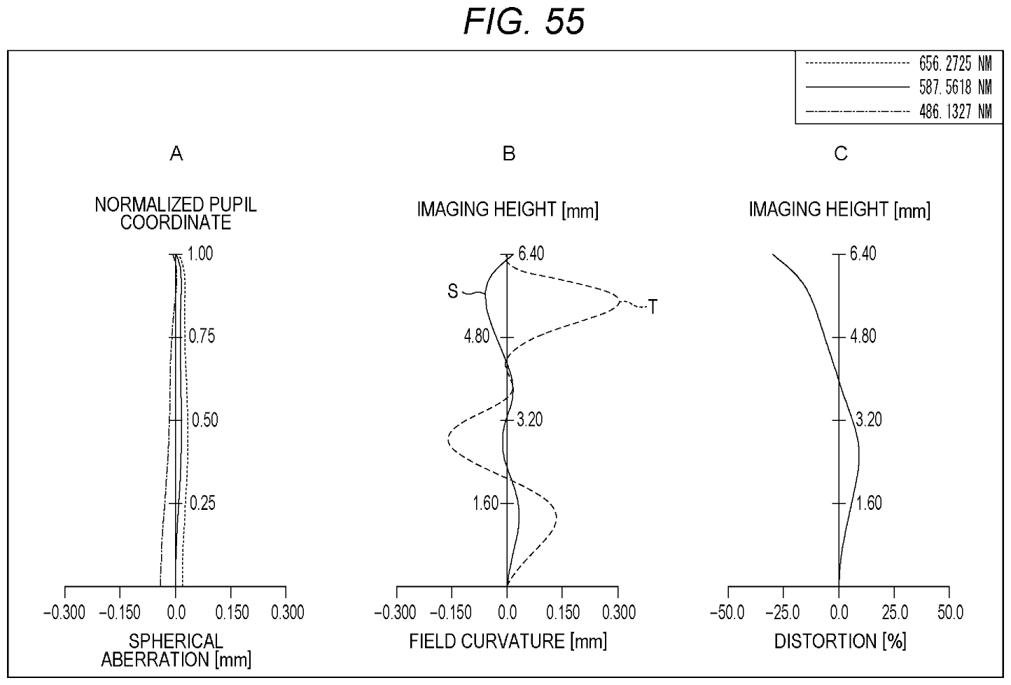

FIG. 55 illustrates graphs of examples of spherical aberration, field curvature, and distortion occurring in the imaging lens 116 in FIG. 51.

A of FIG. 55 is a graph illustrating spherical aberration for each wavelength of light having wavelengths of 486.1327 nm, 587.5618 nm, and 656.2725 nm, the spherical aberration occurring in the imaging lens 116 in FIG. 51.

B of FIG. 55 is a graph illustrating field curvature of light having a wavelength of 587.5618 nm, the field curvature occurring in the imaging lens 116. C of FIG. 55 is a graph illustrating distortion of light having a wavelength of 587.5618 nm, the distortion occurring in the imaging lens 116.

### Seventh Example of Lateral Aberration

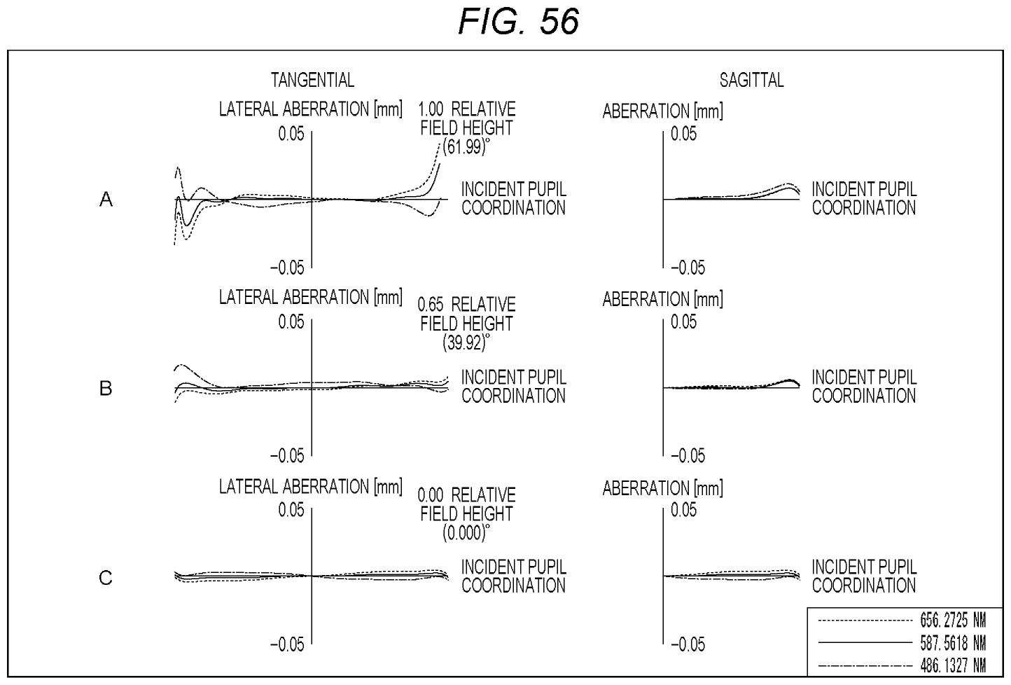

FIG. 56 illustrates graphs of examples of lateral aberration occurring in the imaging lens 116 in FIG. 51.

FIG. 56 illustrates graphs of lateral aberration for each wavelength of light having wavelengths of 486.1327 nm, 587.5618 nm, and 656.2725 nm, the lateral aberration occurring in imaging lens 116.

Specifically, the graphs on the left side in A to C of FIG. 56 represent the lateral aberration in the tangential direction at positions (positions of imaging heights in a case where half angles of view are 61.99°, 39.92°, and 0°) where the imaging heights are 1.00 mm, 0.65 mm, and 0.00 mm, respectively. The graphs on the right side in A to C of FIG. 56 represent lateral aberration in the sagittal direction at positions where the imaging heights are 1.00 mm, 0.65 mm, and 0.00 mm, respectively.

As illustrated in FIGS. 55 and 56, good aberration correction is performed in the imaging lens 116 in FIG. 51, and the imaging lens 116 in FIG. 51 has good imaging quality.

### Eighth Configuration Example of Imaging Lens

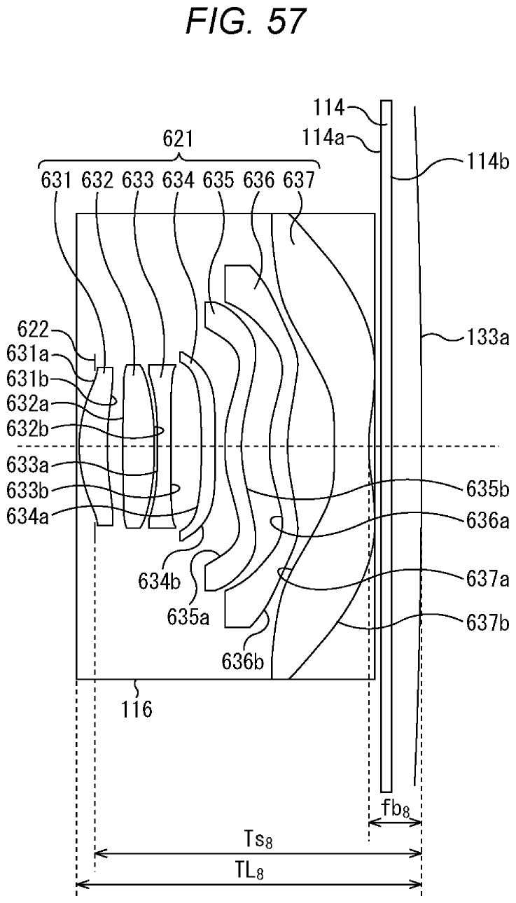

FIG. 57 is a cross-sectional view illustrating an eighth configuration example of the imaging lens 116.

The imaging lens 116 in FIG. 57 includes a lens group 621 and an aperture stop 622.

The lens group 621 includes seven lenses 631 to 637 which are aspherical lenses. The seven lenses 631 to 637 are arranged in order from the object side toward the imaging surface 133a side. The lens 631 has a surface 631a on the object side and a surface 631b on the imaging surface 133a side. Similarly to the lens 631, the lenses 632 to 637 also have surfaces 632a and 632b, surfaces 633a and 633b, surfaces 634a and 634b, surfaces 635a and 635b, surfaces 636a and 636b, and surfaces 637a and 637b, respectively.

The surfaces 631a to 637a and 631b to 637b are aspherical surfaces. The aperture stop 622 is disposed on the object side from the lens 631 and limits light incident on the lens 631. In the example of FIG. 57, the imaging surface 133a is a spherical surface.

The light incident on the imaging lens 116 from the object is emitted via the lenses 631 to 637 and the infrared cut filter 114 and is collected on the imaging surface 133a.

Note that, hereinafter, the total optical length of the imaging lens 116, which is a distance on the optical axis from the object-side surface 631a (foremost surface) of the lens 631 closest to the object side of the lenses 631 to 637 to the imaging surface 133a is referred to as TL₈. A distance on the optical axis from the surface 637b to the imaging surface 133a is referred to as fb₈, and a distance on the optical axis from the aperture stop 622 to the imaging surface 133a is referred to as Ts₈.

### Eighth Example of Various Setting Values of Entire Imaging Lens

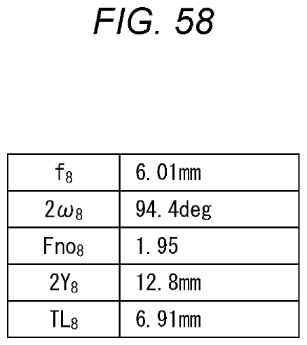

FIG. 58 is a table illustrating examples of various setting values of the entire imaging lens 116 in FIG. 57. As illustrated in FIG. 58, a focal length f₈ of the entire imaging lens 116 in FIG. 57 is 6.01 mm. A maximum angle of view 2w₈ of the imaging lens 116 is 94.4 deg.

An F value Fno₈ of the imaging lens 116 is 1.95 and is 2.5 or less. In addition, 2Y₈ which is twice the maximum imaging height Y₈ is 12.8 mm, and the total optical length TL₈ is 6.91 mm.

### Eighth Example of Various Setting Values of Lenses, Aperture Stop, Imaging Surface, and Infrared Cut Filter

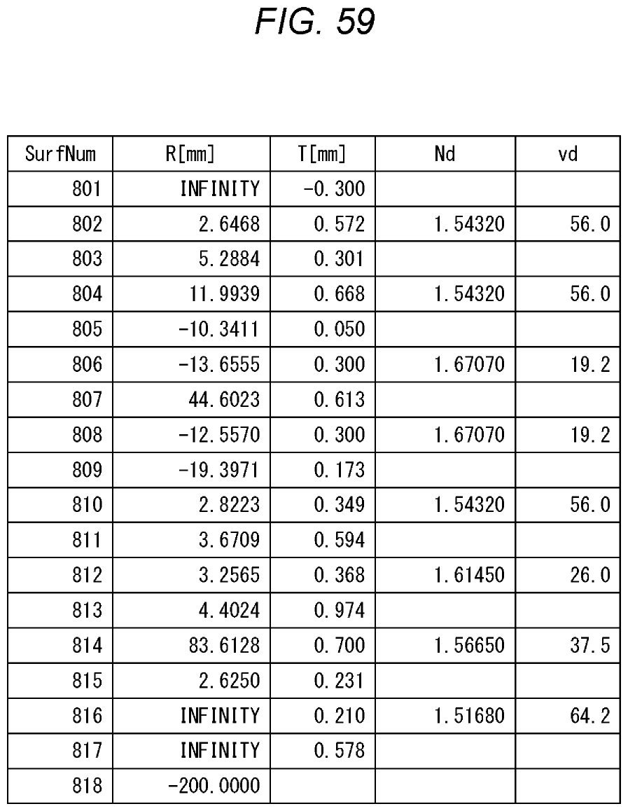

FIG. 59 is a table illustrating examples of various setting values of the lenses 631 to 637, the aperture stop 622, the infrared cut filter 114, and the imaging surface 133a in FIG. 57.

The first row from the top of the table in FIG. 59 shows items corresponding to respective columns. The second and subsequent rows from the top correspond to a surface of the aperture stop 622, the surfaces 631a to 637a and the surfaces 631b to 637b, the surfaces 114a and 114b, and the imaging surface 133a, respectively. Each column in FIG. 59 is similar to each column in FIG. 17.

In the present specification, surface numbers from 801 to 805 are sequentially assigned to the surface of the aperture stop 622, the surfaces 631a, 631b, 632a, and 632b. Surface numbers from 806 to 818 are sequentially assigned to the surfaces 633a, 633b, 634a, 634b, 635a, 635b, 636a, 636b, 637a, 637b, 114a, and 114b, and the imaging surface 133a.

Note that, although not described, the curvature radiuses R, the surface intervals T, the refractive indexes Nd, and the Abbe numbers vd of the surfaces 631a to 637a are provided as respective values illustrated in the table of FIG. 59. The curvature radiuses R and the surface intervals T of the surfaces 631b to 637b are provided as respective values illustrated in the table of FIG. 59. Since the surface of the aperture stop 622 and the surfaces 114a and 114b are flat surfaces, the curvature radiuses R corresponding to SurfNum of 801, 816, and 817 are infinity. Note that, although not described, the surface intervals T of the surface of the aperture stop 622 and the surface 114b, and the surface interval T, the refractive index Nd, and the Abbe number vd of the surface 114a are provided as values illustrated in the table of FIG. 59, respectively.

The curvature radius R of the imaging surface 133a assigned with SurfNum of 818 is −200.000. Since there is no surface to which SurfNum of 819 next to 818 is assigned, the imaging surface 133a does not have a surface interval T.

### Eighth Example of Aspherical Data of Surfaces of Lenses

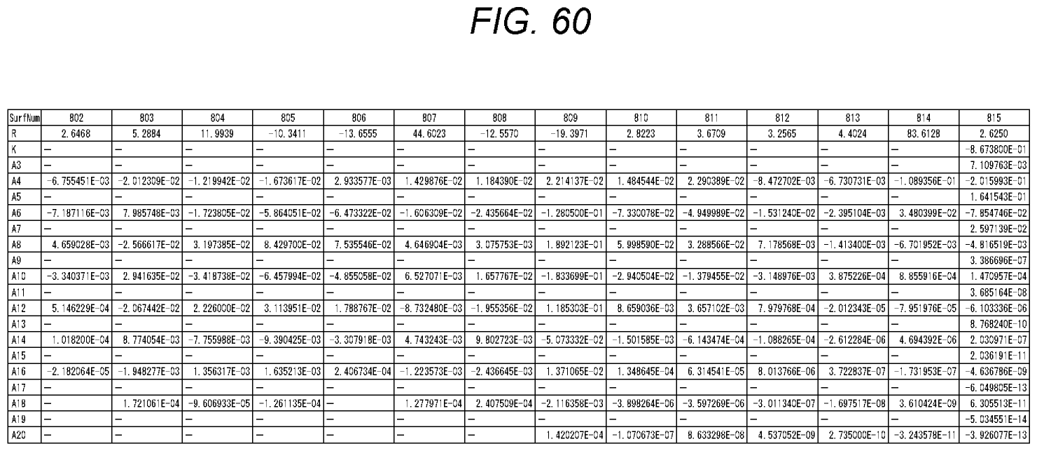

FIG. 60 is a table illustrating an example of aspherical data of the surfaces 631a to 637a and the surfaces 631b to 637b.

In the first column from the left of the table of FIG. 60, items corresponding to rows are described. The second and subsequent columns from the left correspond to the surfaces 631a, 631b, 632a, 632b, 633a, 633b, 634a, 634b, 635a, 635b, 636a, 636b, 637a, and 637b in order from the left. Each row in FIG. 60 is similar to each row in FIG. 48.

Note that, although not described, the curvature radiuses R and the n-th-order aspheric coefficients An (n=4, 6, 8, 10, 12, 14, and 16) of the surfaces 631a and 633a are provided as respective values illustrated in the table in FIG. 60. The curvature radiuses R and the n-th-order aspheric coefficients An (n=4, 6, 8, 10, 12, 14, 16, and 18) of the surfaces 631b to 633b, 632a, and 634a are provided as respective values illustrated in the table of FIG. 60. The curvature radiuses R and the n-th-order aspheric coefficients An (n=4, 6, 8, 10, 12, 14, 16, 18, and 20) of the surfaces 635a to 637a and 634b to 636b are provided as respective values illustrated in the table of FIG. 60. The curvature radius R, the conic coefficient K, and the third-order aspheric coefficient A3 to the twentieth-order aspheric coefficient A20 of the surface 637b are provided as values illustrated in the table of FIG. 60.

### Eighth Example of Spherical Aberration, Field Curvature, and Distortion

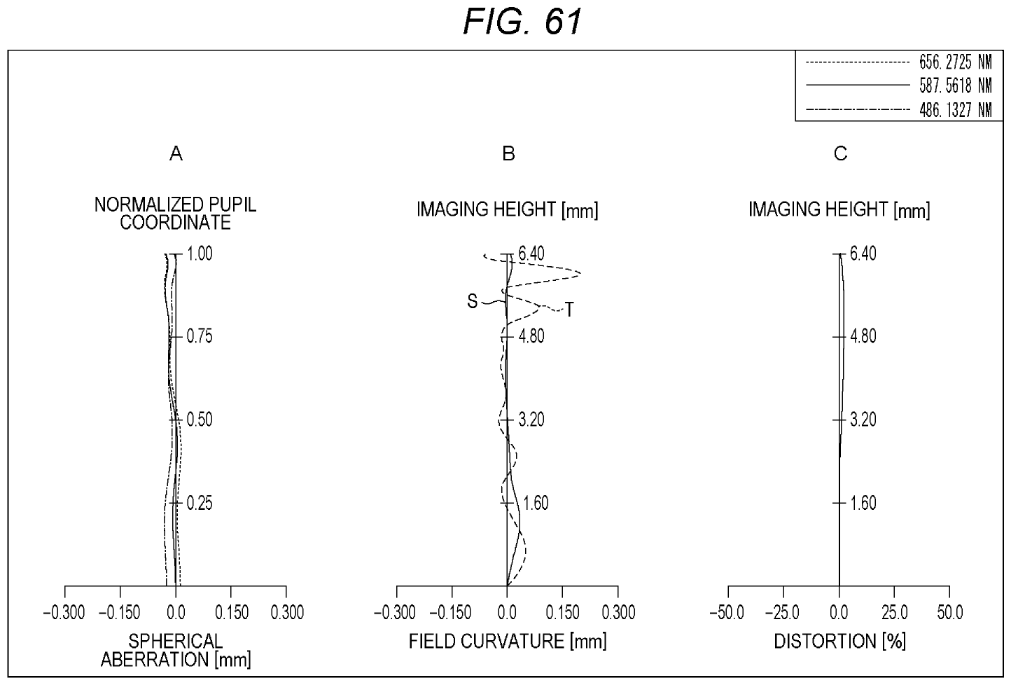

FIG. 61 illustrates graphs of examples of spherical aberration, field curvature, and distortion occurring in the imaging lens 116 in FIG. 57.

A of FIG. 61 is a graph illustrating spherical aberration for each wavelength of light having wavelengths of 486.1327 nm, 587.5618 nm, and 656.2725 nm, the spherical aberration occurring in the imaging lens 116 in FIG. 57.

B of FIG. 61 is a graph illustrating field curvature of light having a wavelength of 587.5618 nm, the field curvature occurring in the imaging lens 116. C of FIG. 61 is a graph illustrating distortion of light having a wavelength of 587.5618 nm, the distortion occurring in the imaging lens 116.

### Eighth Example of Lateral Aberration

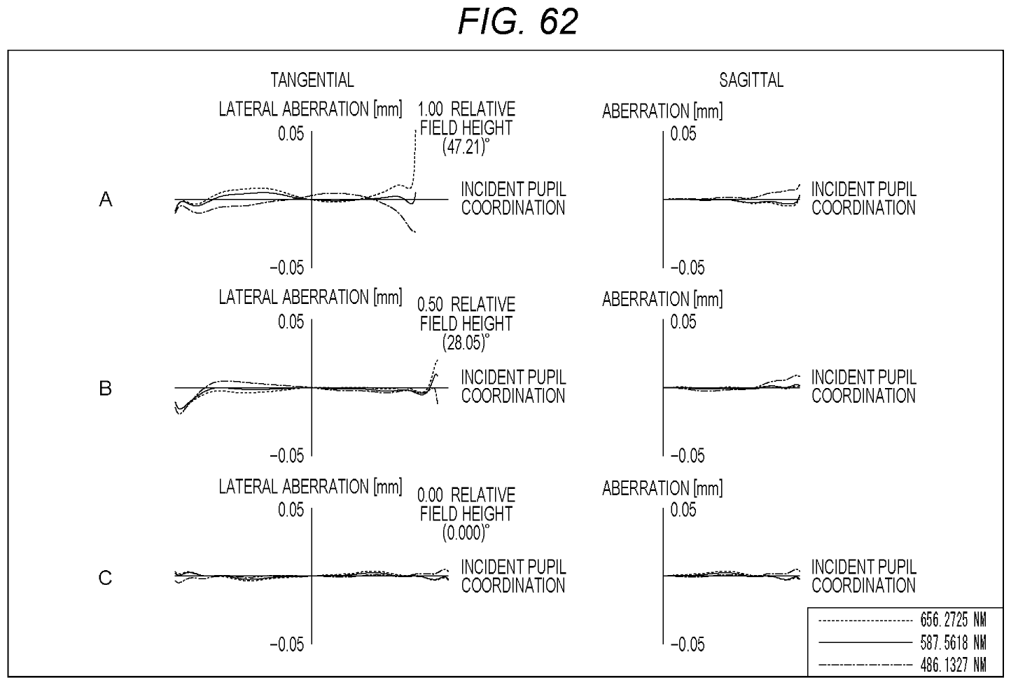

FIG. 62 illustrates graphs of examples of lateral aberration occurring in the imaging lens 116 in FIG. 57.

FIG. 62 illustrates graphs of lateral aberration for each wavelength of light having wavelengths of 486.1327 nm, 587.5618 nm, and 656.2725 nm, the lateral aberration occurring in imaging lens 116.

Specifically, the graphs on the left side in A to C of FIG. 62 represent the lateral aberration in the tangential direction at positions (positions of imaging heights in a case where half angles of view are 47.21°, 28.05°, and 0°) where the imaging heights are 1.00 mm, 0.50 mm, and 0.00 mm, respectively. The graphs on the right side in A to C of FIG. 62 represent lateral aberration in the sagittal direction at positions where the imaging heights are 1.00 mm, 0.50 mm, and 0.00 mm, respectively.

As illustrated in FIGS. 61 and 62, good aberration correction is performed in the imaging lens 116 in FIG. 57, and the imaging lens 116 in FIG. 57 has good imaging quality.

### Ninth Configuration Example of Imaging Lens

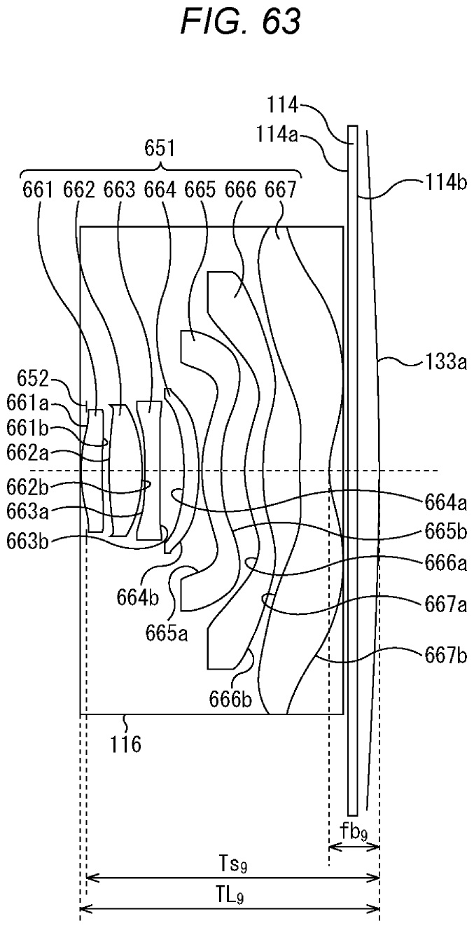

FIG. 63 is a cross-sectional view illustrating a ninth configuration example of the imaging lens 116.

The imaging lens 116 in FIG. 63 includes a lens group 651 and an aperture stop 652.

The lens group 651 includes seven lenses 661 to 667 which are aspherical lenses. The seven lenses 661 to 667 are arranged in order from the object side toward the imaging surface 133a side. The lens 661 has a surface 661a on the object side and a surface 661b on the imaging surface 133a side. Similarly to the lens 661, the lenses 662 to 667 also have surfaces 662a and 662b, surfaces 663a and 663b, surfaces 664a and 664b, surfaces 665a and 665b, surfaces 666a and 666b, and surfaces 667a and 667b, respectively.

The surfaces 661a to 667a and 661b to 667b are aspherical surfaces. The aperture stop 652 is disposed on the object side from the lens 661 and limits light incident on the lens 661. In the example of FIG. 63, the imaging surface 133a is a spherical surface.

The light incident on the imaging lens 116 from the object is emitted via the lenses 661 to 667 and the infrared cut filter 114 and is collected on the imaging surface 133a.

Note that, hereinafter, the total optical length of the imaging lens 116, which is a distance on the optical axis from the object-side surface 661a (foremost surface) of the lens 661 closest to the object side of the lenses 661 to 667 to the imaging surface 133a is referred to as TL₉. A distance on the optical axis from the surface 667b to the imaging surface 133a is referred to as fb₉, and a distance on the optical axis from the aperture stop 652 to the imaging surface 133a is referred to as Ts₉.

### Ninth Example of Various Setting Values of Entire Imaging Lens

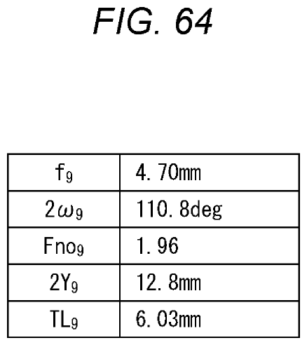

FIG. 64 is a table illustrating examples of various setting values of the entire imaging lens 116 in FIG. 63. As illustrated in FIG. 64, a focal length f₉ of the entire imaging lens 116 in FIG. 63 is 4.70 mm. A maximum angle of view 2ω₉ of the imaging lens 116 is 110.8 deg. An F value Fno₉ of the imaging lens 116 is 1.96 and is 2.5 or less. In addition, 2Y₉ which is twice the maximum imaging height Y₉ is 12.8 mm, and the total optical length TL₉ is 6.03 mm.

### Ninth Example of Various Setting Values of Lenses, Aperture Stop, Imaging Surface, and Infrared Cut Filter

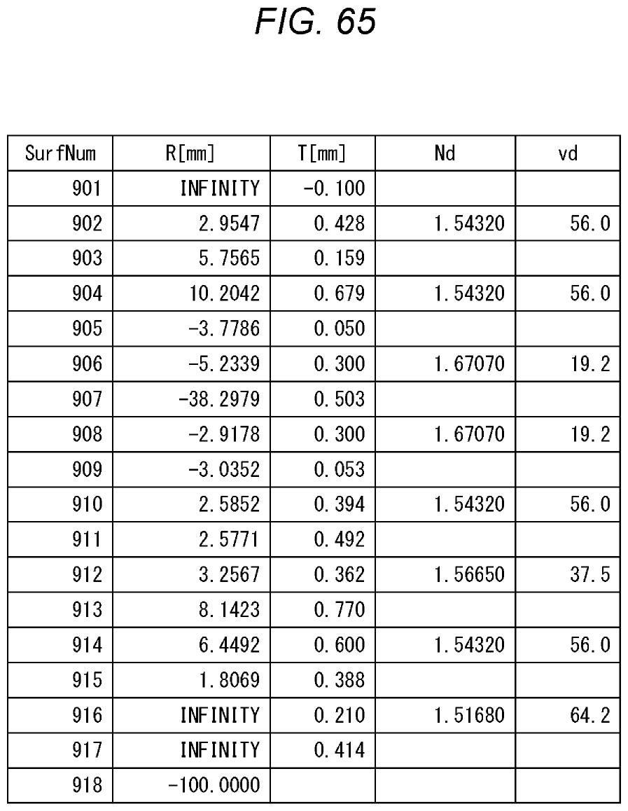

FIG. 65 is a table illustrating examples of various setting values of the lenses 661 to 667, the aperture stop 652, the infrared cut filter 114, and the imaging surface 133a in FIG. 63.

The first row from the top of the table in FIG. 65 shows items corresponding to respective columns. The second and subsequent rows from the top correspond to a surface of the aperture stop 652, the surfaces 661a to 667a and the surfaces 661b to 667b, the surfaces 114a and 114b, and the imaging surface 133a, respectively. Each column in FIG. 65 is similar to each column in FIG. 17.

In the present specification, surface numbers from 901 to 905 are sequentially assigned to the surface of the aperture stop 652, the surfaces 661a, 661b, 662a, and 662b. Surface numbers from 906 to 918 are sequentially assigned to the surfaces 663a, 663b, 664a, 664b, 665a, 665b, 666a, 666b, 667a, 667b, 114a, and 114b, and the imaging surface 133a.

Note that, although not described, the curvature radiuses R, the surface intervals T, the refractive indexes Nd, and the Abbe numbers vd of the surfaces 661a to 667a are provided as respective values illustrated in the table of FIG. 65. The curvature radiuses R and the surface intervals T of the surfaces 661b to 667b are provided as respective values illustrated in the table of FIG. 65. Since the surface of the aperture stop 652 and the surfaces 114a and 114b are flat surfaces, the curvature radiuses R corresponding to SurfNum of 901, 916, and 917 are infinity. Note that, although not described, the surface intervals T of the surface of the aperture stop 652 and the surface 114b, and the surface interval T, the refractive index Nd, and the Abbe number vd of the surface 114a are provided as values illustrated in the table of FIG. 65, respectively.

The curvature radius R of the imaging surface 133a assigned with SurfNum of 918 is −100.000. Since there is no surface to which SurfNum of 919 next to 918 is assigned, the imaging surface 133a does not have a surface interval T.

### Ninth Example of Aspherical Data of Surfaces of Lenses

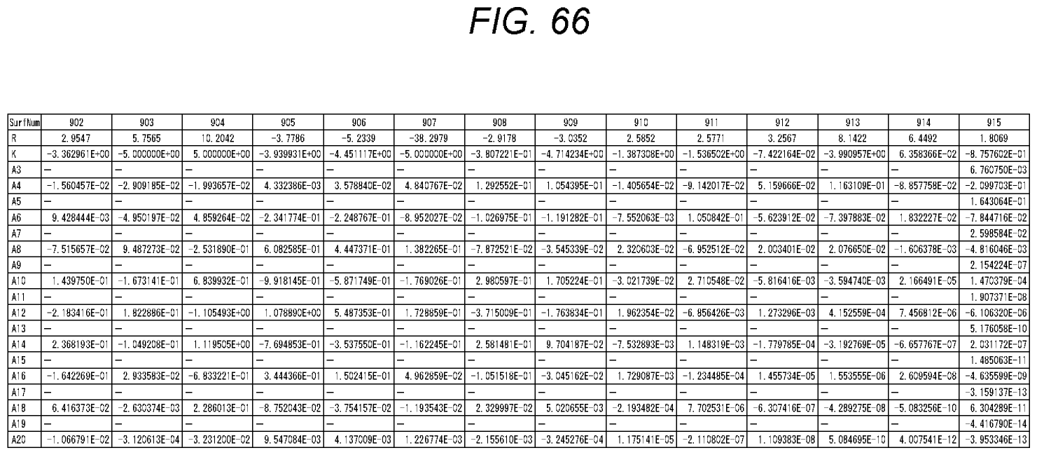

FIG. 66 is a table illustrating an example of aspherical data of the surfaces 661a to 667a and the surfaces 661b to 667b.

In the first column from the left of the table of FIG. 66, items corresponding to rows are described. The second and subsequent columns from the left correspond to the surfaces 661a, 661b, 662a, 662b, 663a, 663b, 664a, 664b, 665a, 665b, 666a, 666b, 667a, and 667b in order from the left. Each row in FIG. 66 is similar to each row in FIG. 48.

Note that, although not described, the curvature radiuses R, the conic coefficients K, and the n-th-order aspheric coefficients An (n=4, 6, 8, 10, 12, 14, 16, 18, and 20) of the surfaces 661a to 667a and the surfaces 661b to 666b are provided as respective values illustrated in the table in FIG. 66. The curvature radius R, the conic coefficient K, and the third-order aspheric coefficient A3 to the twentieth-order aspheric coefficient A20 of the surface 667b are provided as respective values illustrated in the table of FIG. 66.

### Ninth Example of Spherical Aberration, Field Curvature, and Distortion

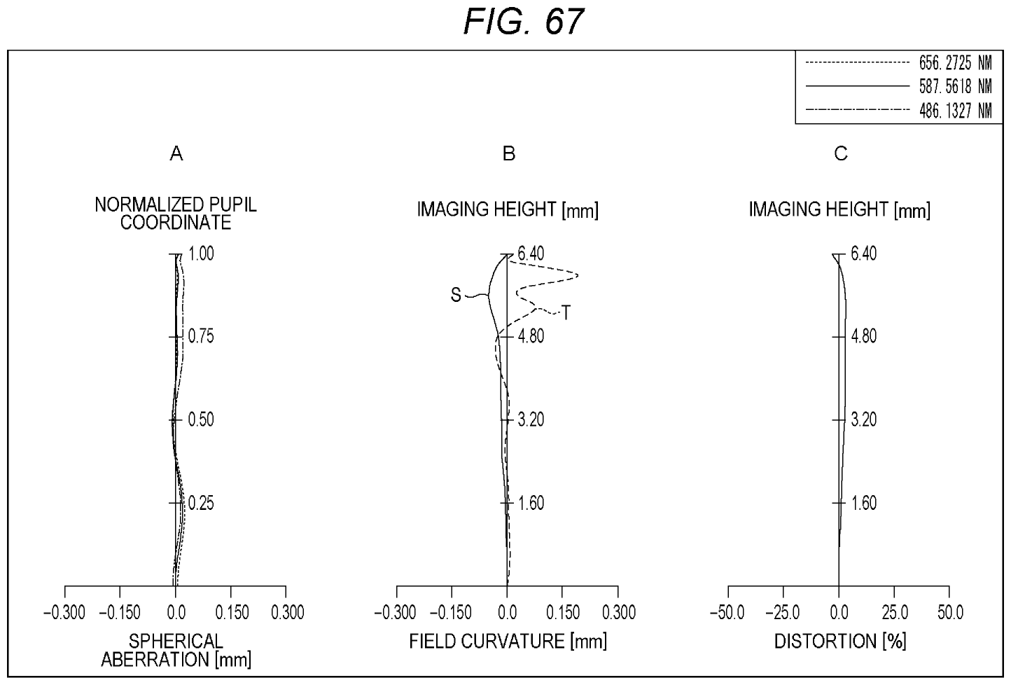

FIG. 67 illustrates graphs of examples of spherical aberration, field curvature, and distortion occurring in the imaging lens 116 in FIG. 63.

A of FIG. 67 is a graph illustrating spherical aberration for each wavelength of light having wavelengths of 486.1327 nm, 587.5618 nm, and 656.2725 nm, the spherical aberration occurring in the imaging lens 116 in FIG. 63.

B of FIG. 67 is a graph illustrating field curvature of light having a wavelength of 587.5618 nm, the field curvature occurring in the imaging lens 116. C of FIG. 67 is a graph illustrating distortion of light having a wavelength of 587.5618 nm, the distortion occurring in the imaging lens 116.

### Ninth Example of Lateral Aberration

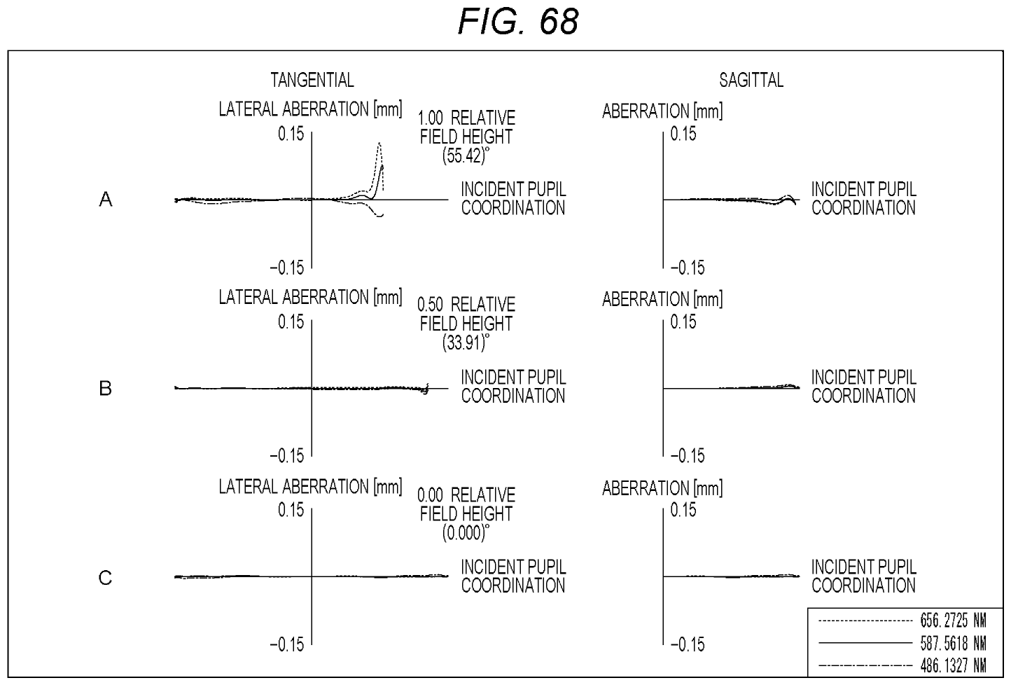

FIG. 68 illustrates graphs of examples of lateral aberration occurring in the imaging lens 116 in FIG. 63.

FIG. 68 illustrates graphs of lateral aberration for each wavelength of light having wavelengths of 486.1327 nm, 587.5618 nm, and 656.2725 nm, the lateral aberration occurring in imaging lens 116.

Specifically, the graphs on the left side in A to C of FIG. 68 represent the lateral aberration in the tangential direction at positions (positions of imaging heights in a case where half angles of view are 55.42°, 33.91°, and 0°) where the imaging heights are 1.00 mm, 0.50 mm, and 0.00 mm, respectively. The graphs on the right side in A to C of FIG. 68 represent lateral aberration in the sagittal direction at positions where the imaging heights are 1.00 mm, 0.50 mm, and 0.00 mm, respectively.

As illustrated in FIGS. 67 and 68, good aberration correction is performed in the imaging lens 116 in FIG. 63, and the imaging lens 116 in FIG. 63 has good imaging quality.

### Tenth Configuration Example of Imaging Lens

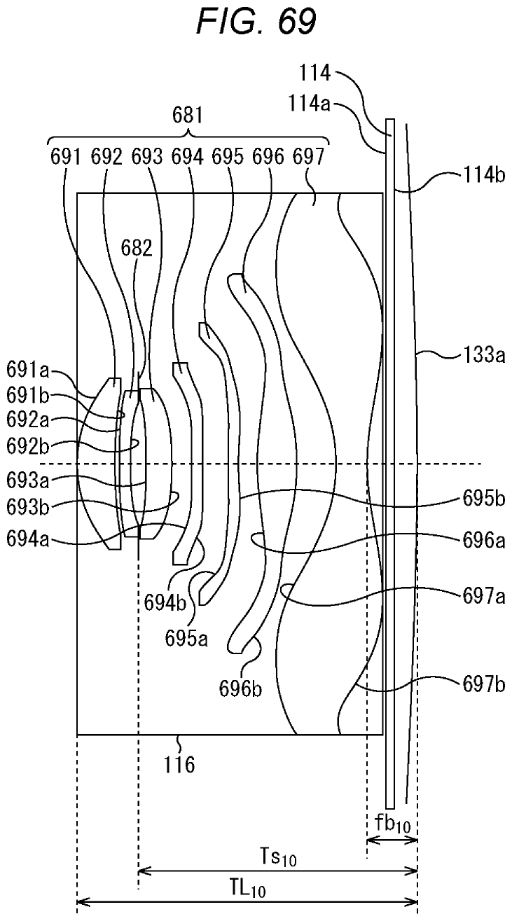

FIG. 69 is a cross-sectional view illustrating a tenth configuration example of the imaging lens 116.

The imaging lens 116 in FIG. 69 includes a lens group 681 and an aperture stop 682.

The lens group 681 includes seven lenses 691 to 697 which are aspherical lenses. The seven lenses 691 to 697 are arranged in order from the object side toward the imaging surface 133a side. The lens 691 has a surface 691a on the object side and a surface 691b on the imaging surface 133a side. Similarly to the lens 691, the lenses 692 to 697 also have surfaces 692a and 692b, surfaces 693a and 693b, surfaces 694a and 694b, surfaces 695a and 695b, surfaces 696a and 696b, and surfaces 697a and 697b, respectively. The aperture stop 682 is disposed at a position of the surface 692b and limits light incident on the lens 693 from the lens 692.

The surfaces 691a to 697a and 691b to 697b are aspherical surfaces. In the example of FIG. 69, the imaging surface 133a is a spherical surface.

The light incident on the imaging lens 116 from the object is emitted via the lenses 691 to 697 and the infrared cut filter 114 and is collected on the imaging surface 133a.

Note that, hereinafter, the total optical length of the imaging lens 116, which is a distance on the optical axis from the object-side surface 691a (foremost surface) of the lens 691 closest to the object side of the lenses 691 to 697 to the imaging surface 133a is referred to as TL₁₀. A distance on the optical axis from the surface 697b to the imaging surface 133a is referred to as fb₁₀, and a distance on the optical axis from the aperture stop 682 to the imaging surface 133a is referred to as Ts₁₀.

### Tenth Example of Various Setting Values of Entire Imaging Lens

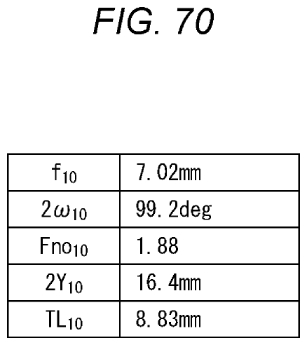

FIG. 70 is a table illustrating examples of various setting values of the entire imaging lens 116 in FIG. 69. As illustrated in FIG. 70, a focal length f₁₀ of the entire imaging lens 116 in FIG. 69 is 7.02 mm. A maximum angle of view 2ω₁₀ of the imaging lens 116 is 99.2 deg.

An F value Fno₁₀ of the imaging lens 116 is 1.88 and is 2.5 or less. In addition, 2Y₁₀ which is twice the maximum imaging height Y₁₀ is 16.4 mm, and the total optical length TL₁₀ is 8.83 mm.

### Tenth Example of Various Setting Values of Lenses, Imaging Surface, and Infrared Cut Filter

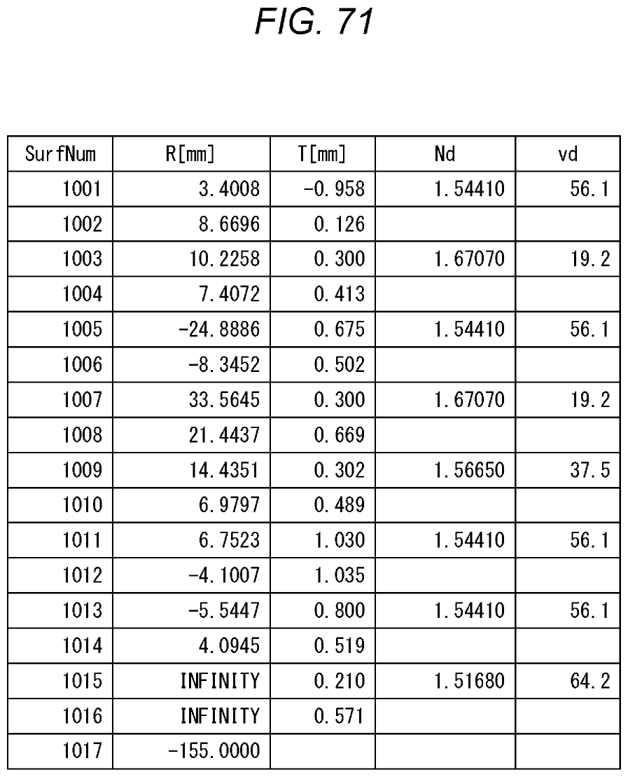

FIG. 71 is a table illustrating examples of various setting values of the lenses 691 to 697, the infrared cut filter 114, and the imaging surface 133a in FIG. 69.

The first row from the top of the table in FIG. 71 shows items corresponding to respective columns. The second and subsequent rows from the top correspond to the surfaces 691a to 697a and the surfaces 691b to 697b, the surfaces 114a and 114b, and the imaging surface 133a, respectively. Each column in FIG. 71 is similar to each column in FIG. 17.

In the present specification, surface numbers from 1001 to 1004 are sequentially assigned to the surfaces 691a, 691b, 692a, and 692b. Surface numbers from 1005 to 1017 are sequentially assigned to the surfaces 693a, 693b, 694a, 694b, 695a, 695b, 696a, 696b, 697a, 697b, 114a, and 114b, and the imaging surface 133a.

Note that, although not described, the curvature radiuses R, the surface intervals T, the refractive indexes Nd, and the Abbe numbers vd of the surfaces 691a to 697a are provided as respective values illustrated in the table of FIG. 71. The curvature radiuses R and the surface intervals T of the surfaces 691b to 697b are provided as respective values illustrated in the table of FIG. 71. Since the surfaces 114a and 114b are flat surfaces, the curvature radiuses R corresponding to SurfNum of 1015 and 1016 are infinity. Note that, although not described, the surface interval T of the surface 114b, and the surface interval T, the refractive index Nd, and the Abbe number vd of the surface 114a are provided as values illustrated in the table of FIG. 71, respectively.

The curvature radius R of the imaging surface 133a assigned with SurfNum of 1017 is −155.000. Since there is no surface to which SurfNum of 1018 next to 1017 is assigned, the imaging surface 133a does not have a surface interval T.

### Tenth Example of Aspherical Data of Surfaces of Lenses

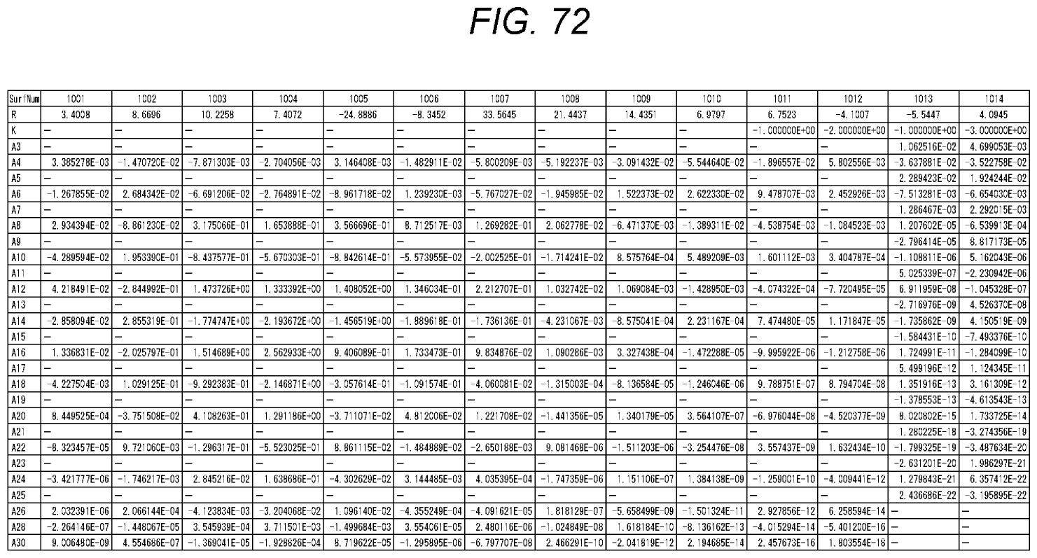

FIG. 72 is a table illustrating an example of aspherical data of the surfaces 691a to 697a and the surfaces 691b to 697b.

In the first column from the left of the table of FIG. 72, items corresponding to rows are described. The second and subsequent columns from the left correspond to the surfaces 691a, 691b, 692a, 692b, 693a, 693b, 694a, 694b, 695a, 695b, 696a, 696b, 697a, and 697b in order from the left. The rows in FIG. 72 correspond to, from top to bottom, items of SurfNum, curvature radiuses R, conic coefficients K, and a third-order aspheric coefficients A3 to a twenty-sixth-order aspheric coefficient A26, a twenty-eighth-order aspheric coefficient A28, and a thirtieth-order aspheric coefficient A30.

Note that, although not described, the curvature radiuses R and the n-th-order aspheric coefficients An (n=4, 6, 8, 10, 12, 14, 16, 18, 20, 22, 24, 26, 28, and 30) of the surfaces 691a to 695a and the surfaces 691b to 695b are provided as respective values illustrated in the table in FIG. 72. The curvature radiuses R, the conic coefficients K, and the n-th-order aspheric coefficients An (n=4, 6, 8, 10, 12, 14, 16, 18, 20, 22, 24, 26, 28, and 30) of the surfaces 696a and 696b are provided as respective values illustrated in the table of FIG. 72. The curvature radiuses R, the conic coefficients K, and the third-order aspheric coefficients A3 to the twenty fifth-order aspheric coefficients A25 of the surfaces 697a and 697b are provided as respective values illustrated in the table of FIG. 72.

### Tenth Example of Spherical Aberration, Field Curvature, and Distortion

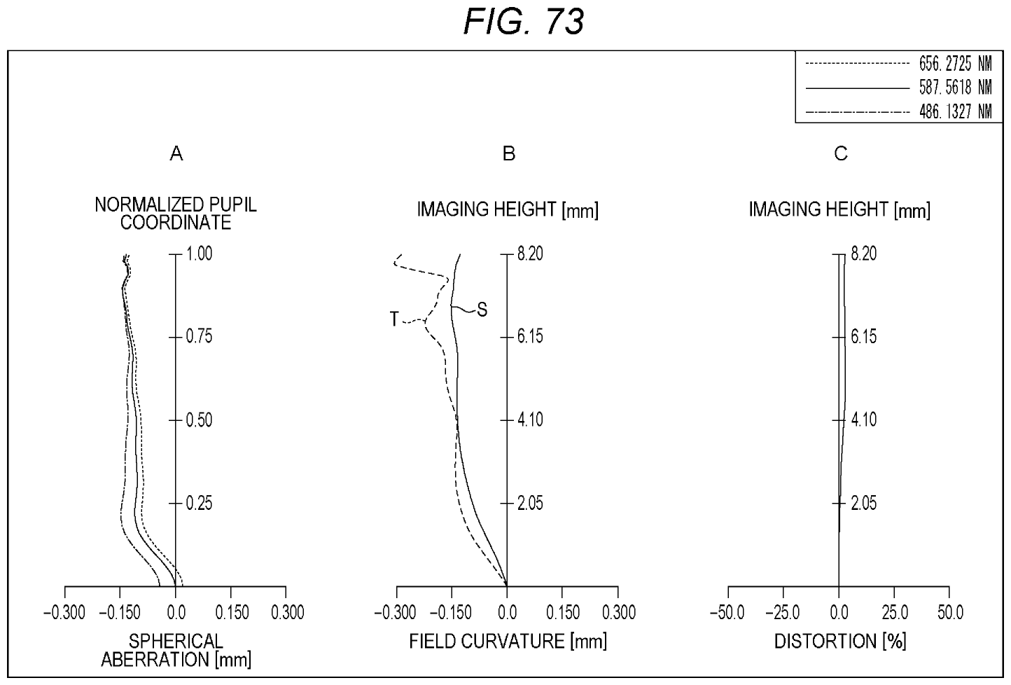

FIG. 73 illustrates graphs of examples of spherical aberration, field curvature, and distortion occurring in the imaging lens 116 in FIG. 69.

A of FIG. 73 is a graph illustrating spherical aberration for each wavelength of light having wavelengths of 486.1327 nm, 587.5618 nm, and 656.2725 nm, the spherical aberration occurring in the imaging lens 116 in FIG. 69.

B of FIG. 73 is a graph illustrating field curvature of light having a wavelength of 587.5618 nm, the field curvature occurring in the imaging lens 116. C of FIG. 73 is a graph illustrating distortion of light having a wavelength of 587.5618 nm, the distortion occurring in the imaging lens 116.

### Tenth Example of Lateral Aberration

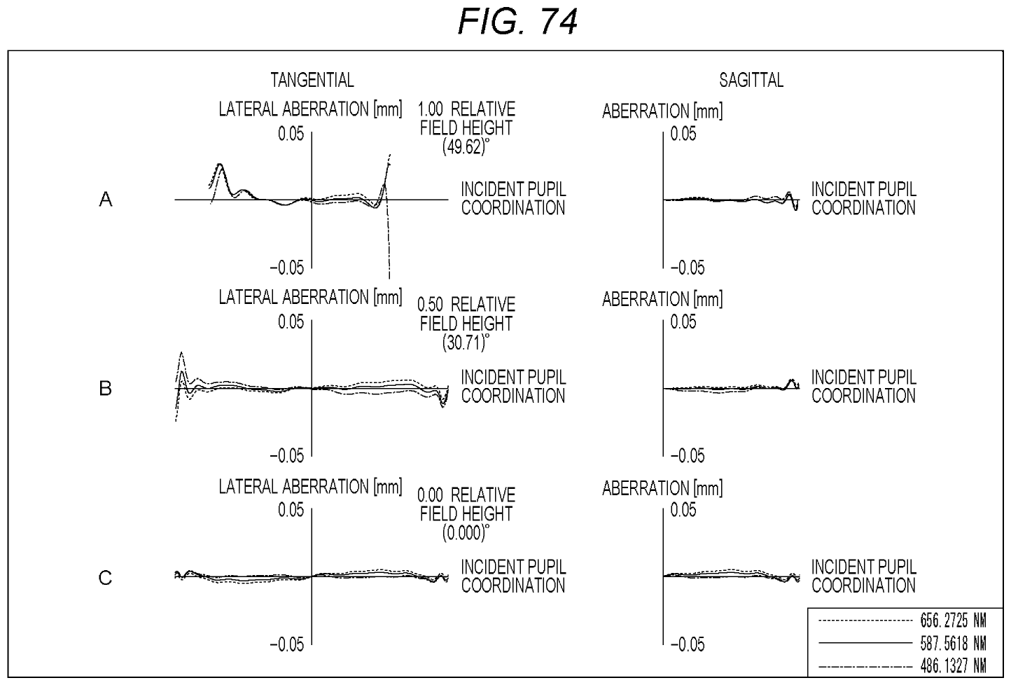

FIG. 74 illustrates graphs of examples of lateral aberration occurring in the imaging lens 116 in FIG. 69.

FIG. 74 illustrates graphs of lateral aberration for each wavelength of light having wavelengths of 486.1327 nm, 587.5618 nm, and 656.2725 nm, the lateral aberration occurring in imaging lens 116.

Specifically, the graphs on the left side in A to C of FIG. 74 represent the lateral aberration in the tangential direction at positions (positions of imaging heights in a case where half angles of view are 49.62°, 30.71°, and 0°) where the imaging heights are 1.00 mm, 0.50 mm, and 0.00 mm, respectively. The graphs on the right side in A to C of FIG. 74 represent lateral aberration in the sagittal direction at positions where the imaging heights are 1.00 mm, 0.50 mm, and 0.00 mm, respectively.

As illustrated in FIGS. 73 and 74, good aberration correction is performed in the imaging lens 116 in FIG. 69, and the imaging lens 116 in FIG. 69 has good imaging quality.

### Eleventh Configuration Example of Imaging Lens

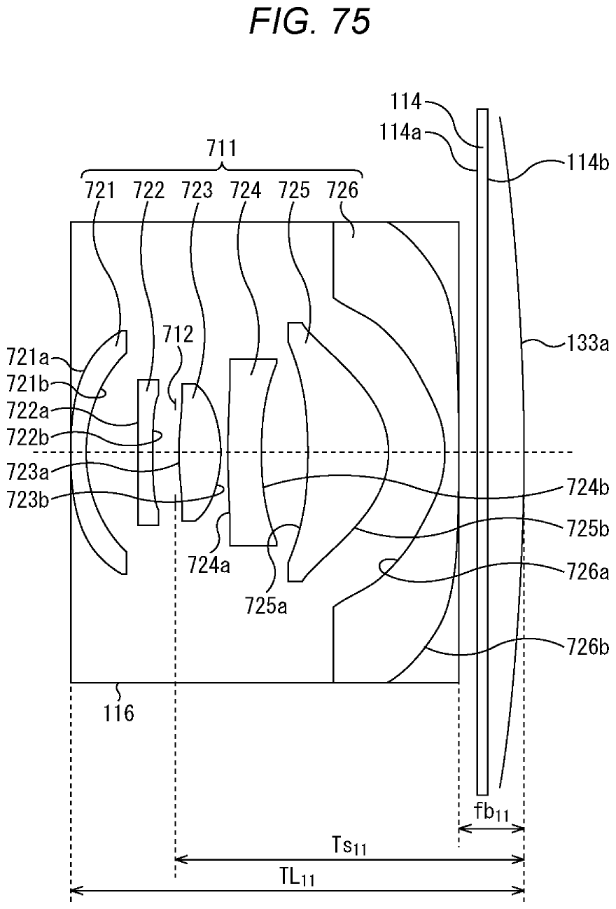

FIG. 75 is a cross-sectional view illustrating an eleventh configuration example of the imaging lens 116. The imaging lens 116 in FIG. 75 includes a lens group 711 and an aperture stop 712.

The lens group 711 includes six lenses 721 to 726 which are aspherical lenses. The seven lenses 721 to 726 are arranged in order from the object side toward the imaging surface 133a side. The lens 721 has a surface 721a on the object side and a surface 721b on the imaging surface 133a side. Similarly to the lens 721, the lenses 722 to 726 also have surfaces 722a and 722b, surfaces 723a and 723b, surfaces 724a and 724b, surfaces 725a and 725b, and surfaces 726a and 726b, respectively.

The surfaces 721a to 726a and 721b to 725b are aspherical surfaces. Of the lenses 721 to 726, the imaging surface 133a-side surface 726b (last surface) of the lens 726 closest to the imaging surface 133a is an aspherical surface that is concave toward the object side as a whole, in which inclination of the surface is not reversed as a distance between the surface and the optical axis increases. The aperture stop 712 is disposed between the lenses 722 and 723 and limits light incident on the lens 723 from the lens 722. In the example of FIG. 75, the imaging surface 133a is a spherical surface.

The light incident on the imaging lens 116 from the object is emitted via the lenses 721 to 726 and the infrared cut filter 114 and is collected on the imaging surface 133a.

Note that, hereinafter, the total optical length of the imaging lens 116, which is a distance on the optical axis from the object-side surface 721a (foremost surface) of the lens 721 closest to the object side of the lenses 721 to 726 to the imaging surface 133a is referred to as TL₁₁. A distance on the optical axis from the surface 726b to the imaging surface 133a is referred to as fb₁₁, and a distance on the optical axis from the aperture stop 712 to the imaging surface 133a is referred to as Ts₁₁.

### Eleventh Example of Various Setting Values of Entire Imaging Lens

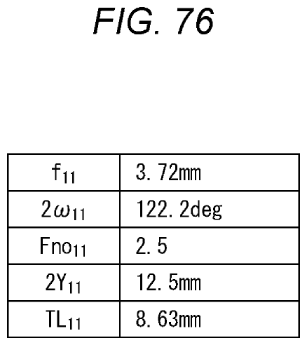

FIG. 76 is a table illustrating examples of various setting values of the entire imaging lens 116 in FIG. 75.

As illustrated in FIG. 76, a focal length f₁₁ of the entire imaging lens 116 in FIG. 75 is 3.72 mm. A maximum angle of view 2ω₁₁ of the imaging lens 116 is 122.2 deg.

An F value Fno₁₁ of the imaging lens 116 is 2.5 and is 2.5 or less. In addition, 2Y₁₁ which is twice the maximum imaging height Y₁₁ is 12.5 mm, and the total optical length TL₁₁ is 8.63 mm.

### Eleventh Example of Various Setting Values of Lenses, Aperture Stop, Imaging Surface, and Infrared Cut Filter

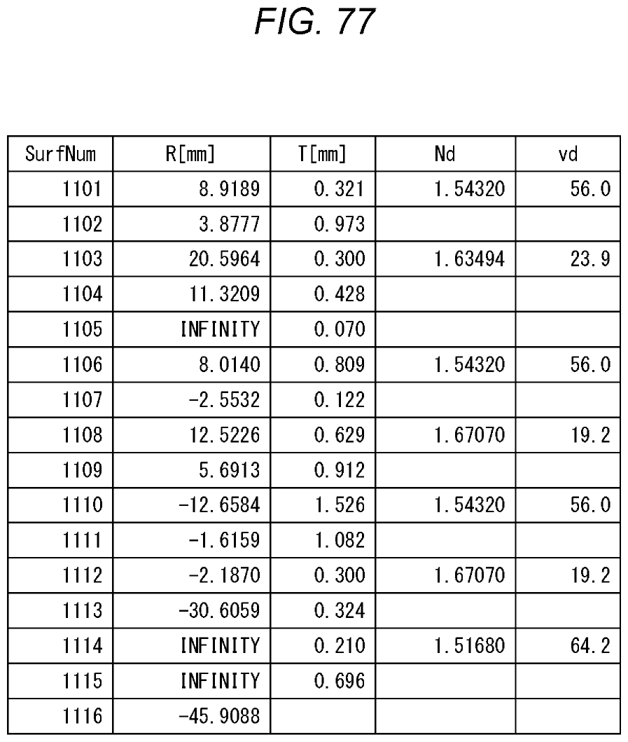

FIG. 77 is a table illustrating examples of various setting values of the lenses 721 to 726, the aperture stop 712, the infrared cut filter 114, and the imaging surface 133a in FIG. 75.

The first row from the top of the table in FIG. 77 shows items corresponding to respective columns. The second and subsequent rows from the top correspond to the surfaces 721a to 726a and the surfaces 721b to 726b, the surface of the aperture stop 712, the surfaces 114a and 114b, and the imaging surface 133a, respectively. Each column in FIG. 77 is similar to each column in FIG. 17.

In the present specification, surface numbers from 1101 to 1104 are sequentially assigned to the surfaces 721a, 721b, 722a, and 722b. Surface numbers from 1105 to 1116 are sequentially assigned to the surface of the aperture stop 712, the surfaces 723a, 723b, 724a, 724b, 725a, 725b, 726a, 726b, 114a, and 114b, and the imaging surface 133a.

Note that, although not described, the curvature radiuses R, the surface intervals T, the refractive indexes Nd, and the Abbe numbers vd of the surfaces 721a to 726a are provided as respective values illustrated in the table of FIG. 77. The curvature radiuses R and the surface intervals T of the surfaces 721b to 726b are provided as respective values illustrated in the table of FIG. 77. Since the surface of the aperture stop 712 and the surfaces 114a and 114b are flat surfaces, the curvature radiuses R corresponding to SurfNum of 1105, 1114, and 1115 are infinity. Note that, although not described, the surface intervals T of the surface of the aperture stop 712 and the surface 114b, and the surface interval T, the refractive index Nd, and the Abbe number vd of the surface 114a are provided as values illustrated in the table of FIG. 77, respectively.

The curvature radius R of the imaging surface 133a assigned with SurfNum of 1116 is −45.9088. Since there is no surface to which SurfNum of 1117 next to 1116 is assigned, the imaging surface 133a does not have a surface interval T.

### Eleventh Example of Aspherical Data of Surfaces of Lenses

FIG. 78 is a table illustrating an example of aspherical data of the surfaces 721a to 726a and the surfaces 721b to 726b.

In the first column from the left of the table of FIG. 78, items corresponding to rows are described. The second and subsequent columns from the left correspond to the surfaces 721a, 721b, 722a, 722b, 723a, 723b, 724a, 724b, 725a, 725b, 726a, and 726b in order from the left. Each row in FIG. 78 is similar to each row in FIG. 48. Note that, although not described, the curvature radiuses R, the conic coefficients K, and the n-th-order aspheric coefficients An (n=4, 6, 8, and 10) of the surfaces 721a to 723a and the surfaces 721b and 722b are provided as respective values illustrated in the table in FIG. 78. The curvature radius R, the conic coefficient K, and the n-th-order aspheric coefficients An (n=4, 6, 8, 10, and 12) of the surface 723b are provided as respective values illustrated in the table of FIG. 78. The curvature radiuses R, the conic coefficients K, and the third-order aspheric coefficients A3 to the twelfth-order aspheric coefficients A12 of the surfaces 724a and 725a are provided as respective values illustrated in the table of FIG. 78. The curvature radius R, the conic coefficient K, and the third-order aspheric coefficient A3 to the tenth-order aspheric coefficient A10 of the surface 724b are provided as respective values illustrated in the table of FIG. 78. The curvature radius R, the conic coefficient K, and the third-order aspheric coefficient A3 to the thirteenth-order aspheric coefficient A13 of the surface 725b are provided as respective values illustrated in the table of FIG. 78. The curvature radius R, the conic coefficient K, and the third-order aspheric coefficient A3 to the fourteenth-order aspheric coefficient A14 of the surface 726a are provided as respective values illustrated in the table of FIG. 78. The curvature radius R, the conic coefficient K, and the third-order aspheric coefficient A3 to the twentieth-order aspheric coefficient A20 of the surface 726b are provided as respective values illustrated in the table of FIG. 78.

### Eleventh Example of Spherical Aberration, Field Curvature, and Distortion

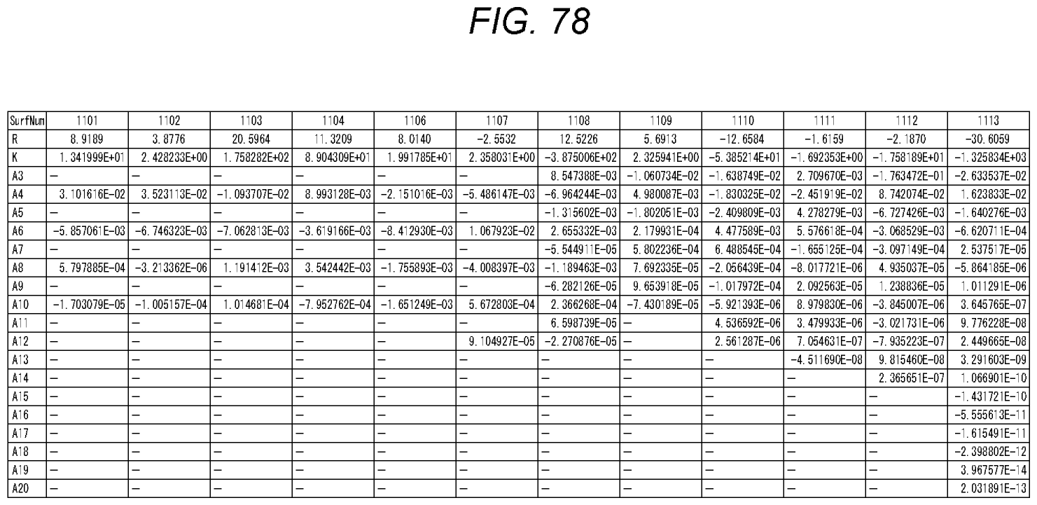

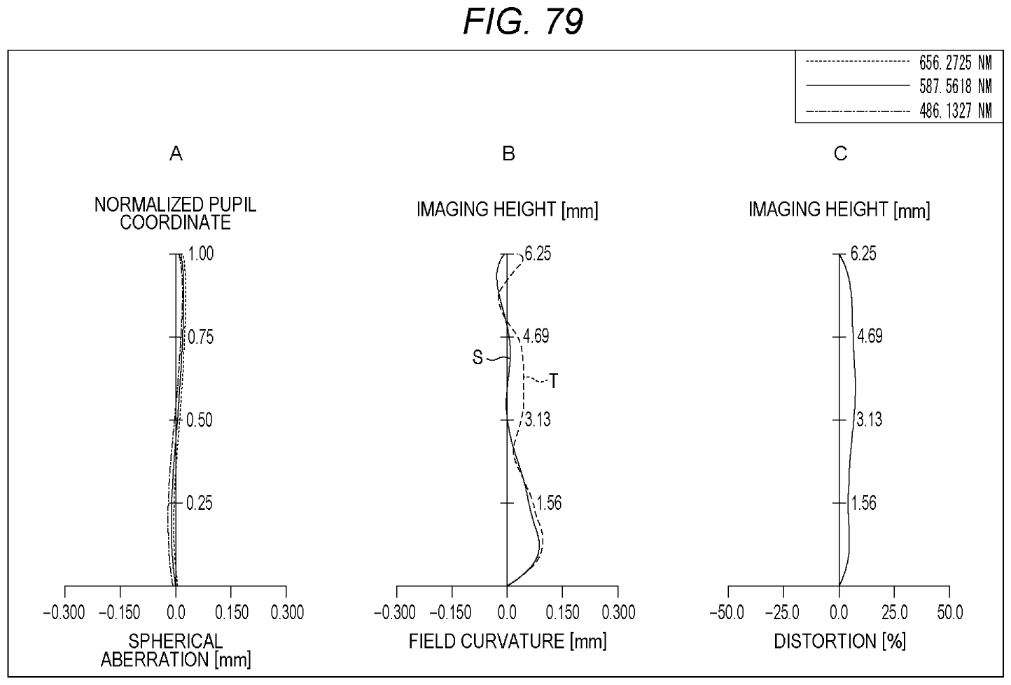

FIG. 79 illustrates graphs of examples of spherical aberration, field curvature, and distortion occurring in the imaging lens 116 in FIG. 75.

A of FIG. 79 is a graph illustrating spherical aberration for each wavelength of light having wavelengths of 486.1327 nm, 587.5618 nm, and 656.2725 nm, the spherical aberration occurring in the imaging lens 116 in FIG. 75.

B of FIG. 79 is a graph illustrating field curvature of light having a wavelength of 587.5618 nm, the field curvature occurring in the imaging lens 116. C of FIG. 79 is a graph illustrating distortion of light having a wavelength of 587.5618 nm, the distortion occurring in the imaging lens 116.

### Eleventh Example of Lateral Aberration

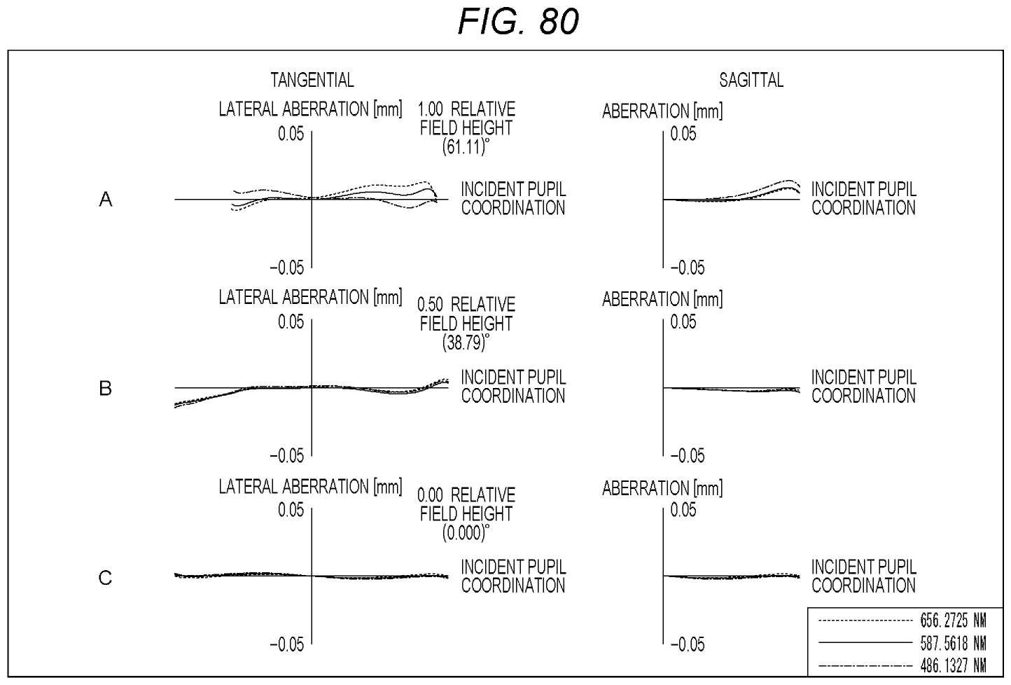

FIG. 80 illustrates graphs of examples of lateral aberration occurring in the imaging lens 116 in FIG. 75.

FIG. 80 illustrates graphs of lateral aberration for each wavelength of light having wavelengths of 486.1327 nm, 587.5618 nm, and 656.2725 nm, the lateral aberration occurring in imaging lens 116.

Specifically, the graphs on the left side in A to C of FIG. 80 represent the lateral aberration in the tangential direction at positions (positions of imaging heights in a case where half angles of view are 61.11°, 38.79°, and 0°) where the imaging heights are 1.00 mm, 0.50 mm, and 0.00 mm, respectively. The graphs on the right side in A to C of FIG. 80 represent lateral aberration in the sagittal direction at positions where the imaging heights are 1.00 mm, 0.50 mm, and 0.00 mm, respectively.

As illustrated in FIGS. 79 and 80, good aberration correction is performed in the imaging lens 116 in FIG. 75, and the imaging lens 116 in FIG. 75 has good imaging quality.

### Twelfth Configuration Example of Imaging Lens

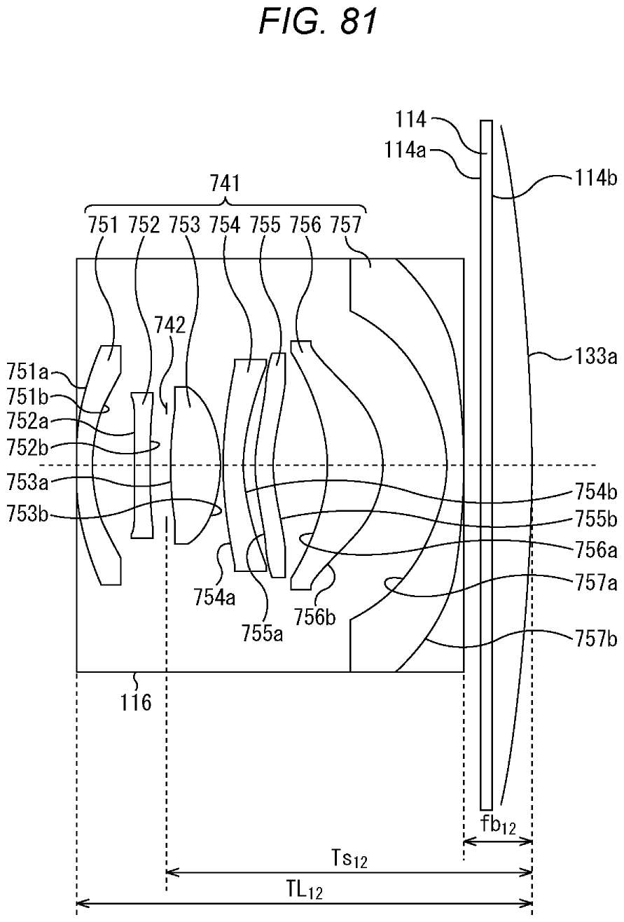

FIG. 81 is a cross-sectional view illustrating a twelfth configuration example of the imaging lens 116.

The imaging lens 116 in FIG. 81 includes a lens group 741 and an aperture stop 742.

The lens group 741 includes seventh lenses 751 to 757 which are aspherical lenses. The seven lenses 751 to 757 are arranged in order from the object side toward the imaging surface 133a side. The lens 751 has a surface 751a on the object side and a surface 751b on the imaging surface 133a side. Similarly to the lens 751, the lenses 752 to 757 also have surfaces 752a and 752b, surfaces 753a and 753b, surfaces 754a and 754b, surfaces 755a and 755b, surfaces 756a and 756b, and surfaces 757a and 757b, respectively.

The surfaces 751a to 757a and 751b to 756b are aspherical surfaces. Of the lenses 751 to 757, the imaging surface 133a-side surface 757b (last surface) of the lens 757 closest to the imaging surface 133a is an aspherical surface that is concave toward the object side as a whole, in which inclination of the surface is not reversed as a distance between the surface and the optical axis increases. The aperture stop 742 is disposed between the lenses 752 and 753 and limits light incident on the lens 753 from the lens 752. In the example of FIG. 81, the imaging surface 133a is a spherical surface.

The light incident on the imaging lens 116 from the object is emitted via the lenses 751 to 757 and the infrared cut filter 114 and is collected on the imaging surface 133a.

Note that, hereinafter, the total optical length of the imaging lens 116, which is a distance on the optical axis from the object-side surface 751a (foremost surface) of the lens 751 closest to the object side of the lenses 751 to 757 to the imaging surface 133a is referred to as TL₁₂. A distance on the optical axis from the surface 757b to the imaging surface 133a is referred to as fb₁₂, and a distance on the optical axis from the aperture stop 742 to the imaging surface 133a is referred to as Ts₁₂.

### Twelfth Example of Various Setting Values of Entire Imaging Lens

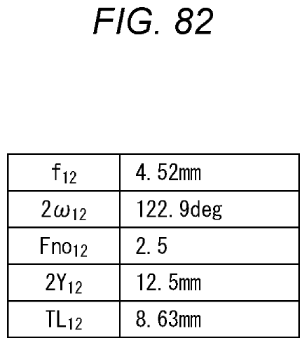

FIG. 82 is a table illustrating examples of various setting values of the entire imaging lens 116 in FIG. 81. As illustrated in FIG. 82, a focal length f₁₂ of the entire imaging lens 116 in FIG. 81 is 4.52 mm. A maximum angle of view 2ω₁₂ of the imaging lens 116 is 122.9 deg. An F value Fno₁₂ of the imaging lens 116 is 2.5 and is 2.5 or less. In addition, 2Y₁₂ which is twice the maximum imaging height Y₁₂ is 12.5 mm, and the total optical length TL₁₂ is 8.63 mm.

### Twelfth Example of Various Setting Values of Lenses, Aperture Stop, Imaging Surface, and Infrared Cut Filter

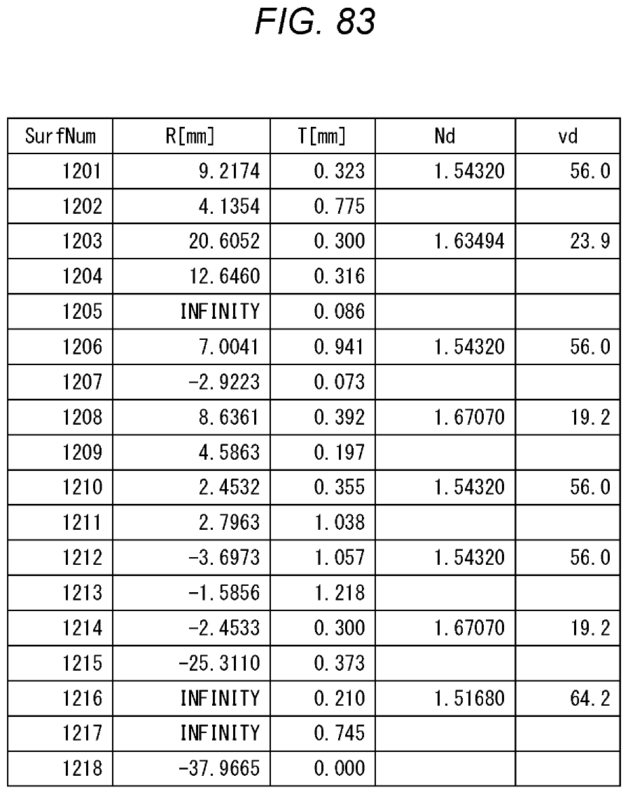

FIG. 83 is a table illustrating examples of various setting values of the lenses 751 to 757, the aperture stop 742, the infrared cut filter 114, and the imaging surface 133a in FIG. 81.

The first row from the top of the table in FIG. 83 shows items corresponding to respective columns. The second and subsequent rows from the top correspond to the surfaces 751a to 757a and the surfaces 751b to 757b, a surface of the aperture stop 742, the surfaces 114a and 114b, and the imaging surface 133a, respectively. Each column in FIG. 83 is similar to each column in FIG. 17. In the present specification, surface numbers from 1201 to 1204 are sequentially assigned to the surfaces 751a, 751b, 752a, and 752b. Surface numbers from 1205 to 1218 are sequentially assigned to the surface of the aperture stop 742, the surfaces 753a, 753b, 754a, 754b, 755a, 755b, 756a, 756b, 757a, 757b, 114a, and 114b, and the imaging surface 133a.

Note that, although not described, the curvature radiuses R, the surface intervals T, the refractive indexes Nd, and the Abbe numbers vd of the surfaces 751a to 757a are provided as respective values illustrated in the table of FIG. 83. The curvature radiuses R and the surface intervals T of the surfaces 751b to 757b are provided as respective values illustrated in the table of FIG. 83. Since the surface of the aperture stop 742 and the surfaces 114a and 114b are flat surfaces, the curvature radiuses R corresponding to SurfNum of 1205, 1216, and 1217 are infinity. Note that, although not described, the surface intervals T of the surface of the aperture stop 742 and the surface 114b, and the surface interval T, the refractive index Nd, and the Abbe number vd of the surface 114a are provided as values illustrated in the table of FIG. 83, respectively.

The curvature radius R of the imaging surface 133a assigned with SurfNum of 1218 is −37.9665. Since there is no surface to which SurfNum of 1219 next to 1218 is assigned, the imaging surface 133a does not have a surface interval T.

### Twelfth Example of Aspherical Data of Surfaces of Lenses

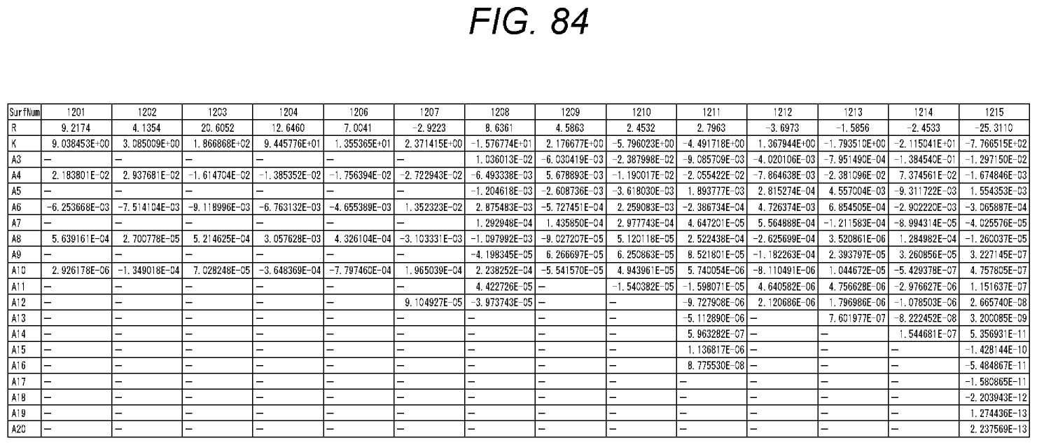

FIG. 84 is a table illustrating an example of aspherical data of the surfaces 751a to 757a and the surfaces 751b to 757b.

In the first column from the left of the table of FIG. 84, items corresponding to rows are described. The second and subsequent columns from the left correspond to the surfaces 751a, 751b, 752a, 752b, 753a, 753b, 754a, 754b, 755a, 755b, 756a, 756b, 757a, and 757b in order from the left. Each row in FIG. 84 is similar to each row in FIG. 48.

Note that, although not described, the curvature radiuses R, the conic coefficients K, and the n-th-order aspheric coefficients An (n=4, 6, 8, and 10) of the surfaces 751a to 753a and the surfaces 751b and 752b are provided as respective values illustrated in the table in FIG. 84. The curvature radius R, the conic coefficient K, and the n-th-order aspheric coefficients An (n=4, 6, 8, 10, and 12) of the surface 753b are provided as respective values illustrated in the table of FIG. 84. The curvature radiuses R, the conic coefficients K, and the third-order aspheric coefficients A3 to the twelfth-order aspheric coefficients A12 of the surfaces 754a and 756a are provided as respective values illustrated in the table of FIG. 84. The curvature radius R, the conic coefficient K, and the third-order aspheric coefficient A3 to the tenth-order aspheric coefficient A10 of the surface 754b are provided as respective values illustrated in the table of FIG. 84. The curvature radius R, the conic coefficient K, and the third-order aspheric coefficient A3 to the eleventh-order aspheric coefficient A11 of the surface 755a are provided as respective values illustrated in the table of FIG. 84.

The curvature radius R, the conic coefficient K, and the third-order aspheric coefficient A3 to the sixteenth-order aspheric coefficient A16 of the surface 755b are provided as respective values illustrated in the table of FIG. 84. The curvature radius R, the conic coefficient K, and the third-order aspheric coefficient A3 to the thirteenth-order aspheric coefficient A13 of the surface 756b are provided as respective values illustrated in the table of FIG. 84. The curvature radius R, the conic coefficient K, and the third-order aspheric coefficient A3 to the fourteenth-order aspheric coefficient A14 of the surface 757a are provided as respective values illustrated in the table of FIG. 84. The curvature radius R, the conic coefficient K, and the third-order aspheric coefficient A3 to the twentieth-order aspheric coefficient A20 of the surface 757b are provided as respective values illustrated in the table of FIG. 84.

### Twelfth Example of Spherical Aberration, Field Curvature, and Distortion

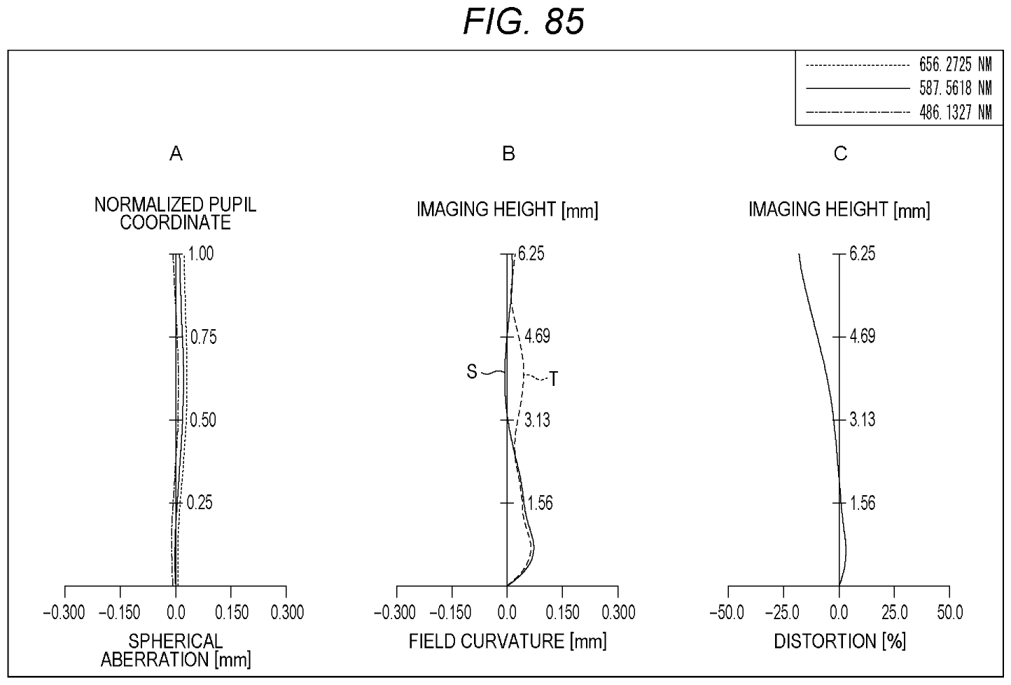

FIG. 85 illustrates graphs of examples of spherical aberration, field curvature, and distortion occurring in the imaging lens 116 in FIG. 81.

A of FIG. 85 is a graph illustrating spherical aberration for each wavelength of light having wavelengths of 486.1327 nm, 587.5618 nm, and 656.2725 nm, the spherical aberration occurring in the imaging lens 116 in FIG. 81.

B of FIG. 85 is a graph illustrating field curvature of light having a wavelength of 587.5618 nm, the field curvature occurring in the imaging lens 116. C of FIG. 85 is a graph illustrating distortion of light having a wavelength of 587.5618 nm, the distortion occurring in the imaging lens 116.

### Twelfth Example of Lateral Aberration

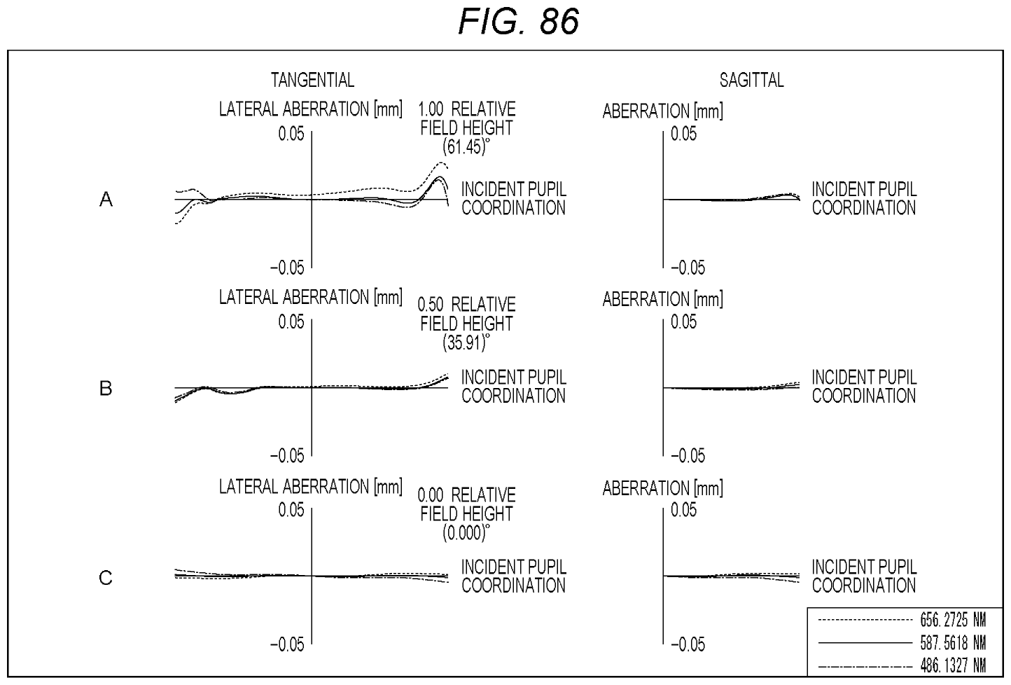

FIG. 86 illustrates graphs of examples of lateral aberration occurring in the imaging lens 116 in FIG. 81.

FIG. 86 illustrates graphs of lateral aberration for each wavelength of light having wavelengths of 486.1327 nm, 587.5618 nm, and 656.2725 nm, the lateral aberration occurring in imaging lens 116.

Specifically, the graphs on the left side in A to C of FIG. 86 represent the lateral aberration in the tangential direction at positions (positions of imaging heights in a case where half angles of view are 61.45°, 35.91°, and 0°) where the imaging heights are 1.00 mm, 0.50 mm, and 0.00 mm, respectively. The graphs on the right side in A to C of FIG. 86 represent lateral aberration in the sagittal direction at positions where the imaging heights are 1.00 mm, 0.50 mm, and 0.00 mm, respectively.

As illustrated in FIGS. 85 and 86, good aberration correction is performed in the imaging lens 116 in FIG. 81, and the imaging lens 116 in FIG. 81 has good imaging quality.

### Values of Parameters or Expressions

FIG. 87 is a table illustrating values of parameters or expressions in the imaging lenses 116 in FIGS. 15, 21, 27, 33, 39, 45, 51, 57, 63, 69, 75, and 81.

In the first column from the left of the table of FIG. 87, items corresponding to respective rows are described. The second and subsequent columns from the left correspond to, in order from the left, the imaging lenses 116 in FIGS. 15, 21, 27, 33, 39, 45, 51, 57, 63, 69, 75, and 81. The rows correspond to items of drawing Nos. of the imaging lenses 116, 2ω, the number of lenses, Fno, (Yw/Y)₂, TL/2Y, f/f1, |Dw/Yw|, RIYw/(cos(ω)⁴), EXPY/Ri, fb×2Y, Ri/Ts, (DY−Dw)/(Y−Yw), Ha/Hb, and Ts/TL. Here, ω collectively denotes maximum half view angles ω₁ to ω₁₂, and collectively denotes the maximum angles of view 2ω₁ to 2ω₁₂. Fno collectively denotes the F values Fno₁ to Fno₁₂. Yw is an imaging height (first imaging height) in a case where the half angle of view is 40 degrees, and Y collectively denotes the maximum imaging heights Y₁ to Y₁₂. TL collectively denotes the total optical lengths TL₁ to TL₁₂, and f collectively denotes the focal lengths f₁ to f₁₂. In addition, f1 denotes a focal length of the lens 431 (461, 491, 521, 541, 571, 601, 631, 661, 691, 721, or 751) closest to the object. Dw denotes optical distortion at the imaging height Yw, and RIYw denotes a peripheral illumination ratio with respect to the center of the imaging surface 133a in a case where the half angle of view is 40 degrees. EXPY denotes a distance (mm) of a light beam with the maximum imaging height Y on the optical axis from the imaging surface 133a to an exit pupil when a direction from the imaging surface 133a toward the object is a negative direction, and Ri denotes the curvature radius R of the center of the imaging surface 133a. In addition, fb collectively denotes the distances fb₁ to fb₁₂, and Ts collectively denotes the distances Ts₁ to Ts₁₂. DY denotes optical distortion (%) at the maximum imaging height Y. Ha denotes a maximum effective radius of the surface 431a (461a, 491a, 521a, 541a, 571a, 601a, 631a, 661a, 691a, 721a, or 751a). Hb denotes a maximum effective radius of the surface 437b (467b, 497b, 527b, 547b, 577b, 607b, 637b, 667b, 697b, 726b, or 757b). Since 2ω and Fno of each imaging lens 116 have been described above, the description thereof will be omitted. The number of lenses of each of the imaging lenses 116 in FIGS. 15, 21, 27, 33, 39, 45, 51, 57, 63, 69, and 81 is seven, and the number of lenses of the imaging lens 116 in FIG. 75 is six.

In the imaging lenses 116 in FIGS. 15, 21, 27, 33, 39, 45, 51, 57, 63, 69, and 81, (Yw/Y)² is 0.4258, 0.3506, 0.3651, 0.4481, 0.3988, 0.4842, 0.4220, 0.6273, 0.3877, 0.5072, 0.2726, and 0.3221, respectively. Hence, the imaging lenses 116 in FIGS. 15, 21, 27, 33, 39, 45, 51, 57, 63, 69, 75, and 81 satisfy the following Condition Expression (1). The imaging lenses 116 in FIGS. 15, 21, 27, 33, 39, 45, 51, 57, 63, 69, and 81 further satisfy the following Condition Expression (1)′.

$$0.27 \leq {( Yw / Y )}^{2} \leq 0.7 \qquad ( 1 )$$

$$0.32 \leq {( Yw / Y )}^{2} \leq 0.65 \qquad {( 1 )}^{′}$$

When (Yw/Y)² is larger than the upper limit of Condition Expression (1), distortion in the ultrawide-angle image increases extremely, and the peripheral resolution is remarkably degraded. When (Yw/Y)₂ is smaller than the lower limit of Condition Expression (1), the effective pixel region decreases and the number of effective pixels decreases in a case where a full angle of view with which imaging is most frequently performed is within 80 degrees. As a result, the resolution of the wide-angle image is significantly degraded. In a case where the imaging lens 116 satisfies Condition Expression (1)′, it is more effective as compared with the case where Condition Expression (1) is satisfied.

In the imaging lenses 116 in FIGS. 15, 21, 27, 33, 39, 45, 51, 57, 63, 69, and 81, TL/2Y is 0.5960, 0.6546, 0.6350, 0.6196, 0.5843, 0.5163, 0.5803, 0.5397, 0.4710. 0.5383, 0.6903, and 0.6903, respectively. Hence, the imaging lenses 116 in FIGS. 15, 21, 27, 33, 39, 45, 51, 57, 63, 69, 75, and 81 satisfy the following Condition Expression (2). The imaging lenses 116 in FIGS. 15, 21, 27, 33, 39, 45, 51, 57, 63, and 69 further satisfy the following Condition Expression (2)′.

$$0.3 \leq TL / 2 Y \leq 0 \text{.695} \qquad ( 2 )$$

$$0.35 \leq TL / 2 Y \leq 0.6 \; 75 \qquad {( 2 )}^{′}$$

When TL/2Y is larger than the upper limit of Condition Expression (2), it is difficult to accommodate the ultrawide-angle camera 11 in a housing of the smartphone 10. As a result, usability and design of the smartphone 10 are impaired, or the size of the smartphone 10 is increased. When TL/2Y is smaller than the lower limit of Condition Expression (2), an amount of curvature of the imaging element 133 increases, and thus it is difficult to manufacture the ultrawide-angle camera 11.

Furthermore, when TL/2Y is smaller than the lower limit of Condition Expression (2), it is difficult to correct aberration even if the imaging surface 133a is curved, and it is difficult to obtain desired resolution in a captured image. In a case where the imaging lens 116 satisfies Condition Expression (2)′, it is more effective as compared with the case where Condition Expression (2) is satisfied.

In the imaging lenses 116 in FIGS. 15, 21, 27, 33, 39, 45, 51, 57, 63, 69, and 81, f/f1 is −0.103, −0.164, −0.103, −0.177, −0.112, 0.622, −0.092, 0.663, 0.443, 0.727, −0.288, and −0.320, respectively. Hence, the imaging lenses 116 in FIGS. 15, 21, 27, 33, 39, 45, 51, 57, 63, 69, 75, and 81 satisfy the following Condition Expression (3). The imaging lenses 116 in FIGS. 15, 21, 27, 33, 39, 51, 75, and 81 further satisfy the following Condition Expression (3)′

$$- 0.35 \leq f / f 1 \leq 0.73 \qquad ( 3 )$$

$$- 0.3 \; 3 \leq f / f 1 \leq 0 \qquad {( 3 )}^{′}$$

When f/f1 is larger than the upper limit of Condition Expression (3), the imaging lens 116 becomes a so-called telephoto-type lens, the focal length of the entire imaging lens 116 becomes long, and it becomes difficult to achieve a wide angle. Furthermore, since the imaging surface 133a is curved, it is important to secure appropriate back focus in order to avoid physical interference between the imaging lens 116, the infrared cut filter 114, and the imaging surface 133a. However, it is difficult to extend the back focus in the telephoto-type lens.

When f/f1 is smaller than the lower limit of Condition Expression (3), distortion becomes high. As a result, image quality of a captured image becomes remarkably degraded, or resolution degradation of the captured image or an increase in power consumption occurs in a case where distortion is corrected by the signal processing section 105 in the subsequent stage. In a case where the imaging lens 116 satisfies Condition Expression (3)′, it is more effective as compared with the case where Condition Expression (3) is satisfied.

In the imaging lenses 116 in FIGS. 15, 21, 27, 33, 39, 45, 51, 57, 63, 69, and 81, |Dw/Yw| is 0.010, 0.005, 0.005, 0.006, 0.004, 0.004, 0.003, 0.004, 0.07, 0.005, 0.021, and 0.011, respectively. Hence, the imaging lenses 116 in FIGS. 15, 21, 27, 33, 39, 45, 51, 57, 63, 69, 75, and 81 satisfy the following Condition Expressions (4) and (4)′.

$$0.001 \leq \vert Dw / Yw \vert \leq 0 \text{.08} \qquad ( 4 )$$

$$0.003 \leq \vert Dw / Yw \vert \leq 0 \text{.03} \qquad {( 4 )}^{′}$$

When |Dw/Yw| is larger than the upper limit of Condition Expression (4), it is necessary to correct the distortion in the subsequent state even in the wide-angle image in which the full angle of view with which imaging is most frequently performed is within 80 degrees, and as a result, resolution degradation of the wide-angle image or an increase in power consumption occurs. When |Dw/Yw| is smaller than the lower limit of Condition Expression (4), a shape of each of the surfaces (the surfaces 431a to 437a, 431b to 437b, and the like) of the imaging lens 116 becomes difficult to manufacture, or the number of lenses increases in order to correct the distortion. In a case where the imaging lens 116 satisfies Condition Expression (4)′, it is more effective as compared with the case where Condition Expression (4) is satisfied.

In the imaging lenses 116 in FIGS. 15, 21, 27, 33, 39, 45, 51, 57, 63, 69, and 81, RIYw/(cos(ω)⁴) is 11.03, 7.23, 7.83, 11.56, 11.18, 1.98, 10.18, 1.33, 2.72, 1.88, 6.97, and 8.90, respectively. Hence, the imaging lenses 116 in FIGS. 15, 21, 27, 33, 39, 45, 51, 57, 63, 69, 75, and 81 satisfy the following Condition Expression (5).

$$1.2 \leq RIYw / ( {cos ( ω )}^{4} ) \leq 35 \qquad ( 5 )$$

When RIYw/(cos(ω)⁴) is larger than the upper limit of Condition Expression (5), the total optical length TL becomes extremely long, so that it becomes difficult to accommodate the ultrawide-angle camera 11 in the housing of the smartphone 10. When RIYw/(cos(ω)⁴) is smaller than the lower limit of Condition Expression (5), signal noise increases when light amount correction is performed at a peripheral portion of the captured image, and the image quality at the dark place is significantly degraded even in the wide-angle image or the like in which the full angle of view with which imaging is most frequently performed is within 80 degrees.

In the imaging lenses 116 in FIGS. 15, 21, 27, 33, 39, 45, 51, 57, 63, 69, and 81, EXPY/Ri is 0.230, 0.111, 0.166, 0.295, 0.382, 0.040, 0.109, 0.039, 0.062, 0.066, 0.122, and 0.136, respectively. Hence, the imaging lenses 116 in FIGS. 15, 21, 27, 33, 39, 45, 51, 57, 63, 69, 75, and 81 satisfy the following Condition Expression (6).

$$0.01 \leq EXPY / Ri \leq 0.39 \qquad ( 6 )$$

When EXPY/Ri is larger than the upper limit of Condition Expression (6), an amount of curvature of the imaging element 133 increases, and thus it is difficult to manufacture the ultrawide-angle camera 11, or the total optical length TL increases. When EXPY/Ri is smaller than the lower limit of Condition Expression (6), it is difficult to appropriately perform pupil correction by the on-chip lens 258, and as a result, the light amount substantially incident on the imaging element 133 decreases, and the S/N ratio of the electrical signal deteriorates.

In the imaging lenses 116 in FIGS. 15, 21, 27, 33, 39, 45, 51, 57, 63, 69, and 81, fb×2Y is 24.99, 17.01, 20.43, 28.26, 26.34, 14.69, 17.83, 12.13, 12.03, 20.15, 14.47, and 15.71, respectively. Hence, the imaging lenses 116 in FIGS. 15, 21, 27, 33, 39, 45, 51, 57, 63, 69, 75, and 81 satisfy the following Condition Expression (7).

$$9.7 \leq fb \times 2 Y \leq 28.4 \qquad ( 7 )$$

When fb×2Y is larger than the upper limit of Condition Expression (7), the negative optical power of the lens 431 (461, 491, 521, 541, 571, 601, 631, 661, 691, 721, or 751) closest to the object becomes strong, and it becomes difficult to correct the distortion. When fb×2Y is smaller than the lower limit of Condition Expression (7), shapes of components of the imaging lens 116 becomes complicated, and it becomes difficult to manufacture the imaging lens 116. Furthermore, there is a growing risk that the imaging lens 116, the infrared cut filter 114, and the imaging element 133 may be damaged at the time of focus adjustment or drop impact.

In the imaging lenses 116 in FIGS. 15, 21, 27, 33, 39, 45, 51, 57, 63, 69, and 81, Ri/Ts are −3.020, −7.453, −4.533, −2.281, −2.119, −24.570, −6.937, −30.264, −16.868, −20.823, −6.948, and −5.491, respectively. Hence, the imaging lenses 116 in FIGS. 15, 21, 27, 33, 39, 45, 51, 57, 63, 69, 75, and 81 satisfy the following Condition Expression (8).

$$- 50 \leq Ri / Ts \leq - 1.95 \qquad ( 8 )$$

If Ri/Ts is larger than the upper limit of Condition Expression (8), the amount of curvature of the imaging surface 133a increases, so that defects such as breaking or cracking of the imaging element 133 increase, and it is difficult to manufacture the ultrawide-angle camera 11. When Ri/Ts is smaller than the lower limit of Condition Expression (8), it is difficult to sufficiently obtain the effects with the curvature of the imaging surface 133a, and as a result, the total optical length TL increases.

In the imaging lenses 116 in FIGS. 15, 21, 27, 33, 39, 45, 51, 57, 63, 69, and 81, (DY-Dw)/(Y-Yw) is −0.07, −0.08, −0.08, −0.08, −0.08, −0.01, −0.13, −0.01, −0.02, 0.00, −0.02, and −0.05, respectively. Hence, the imaging lenses 116 in FIGS. 15, 21, 27, 33, 39, 45, 51, 57, 63, 69, 75, and 81 satisfy the following Condition Expression (9).

$$- 0.16 \leq ( DY - Dw ) / ( Y - Yw ) \leq 0.16 \qquad ( 9 )$$

When (DY-Dw)/(Y-Yw) is larger than the upper limit or is smaller than the lower limit of Condition Expression (9), the distortion in the ultrawide-angle image increases, and high-frequency information of a subject is lost. Therefore, even in a case where the distortion is corrected in the subsequent stage, the resolution of the peripheral portion is significantly degraded.

Furthermore, a difference in image quality between peripheral portions of the wide-angle image and the ultrawide-angle image increases.

In the imaging lenses 116 in FIGS. 15, 21, 27, 33, 39, 45, 51, 57, 63, 69, and 81, Ha/Hb is 0.5596, 0.5486, 0.5474, 0.5888, 0.5428, 0.2816, 0.4839, 0.3276, 0.2437, 0.3123, 0.5304, and 0.5709, respectively. Hence, the imaging lenses 116 in FIGS. 15, 21, 27, 33, 39, 51, 75, and 81 further satisfy the following Condition Expression

(10).

$$0.47 5 \leq Ha / Hb \leq 0.68 \qquad ( 10 )$$

When Ha/Hb is larger than the upper limit of Condition Expression (10), the total optical length TL increases, and an occupancy area of the imaging lens 116 in the smartphone 10 increases, so that it is difficult to dispose a peripheral member or a protective glass. When Ha/Hb is smaller than the lower limit of Condition Expression (10), the imaging lens 116 becomes a so-called telephoto-type lens, and thus it becomes difficult to secure the peripheral illumination or the back focus as the angle of the imaging lens 116 becomes ultrawide.

In the imaging lenses 116 in FIGS. 15, 21, 27, 33, 39, 45, 51, 57, 63, 69, and 81, Ts/TL is 0.753, 0.801, 0.814, 0.807, 0.776, 0.955, 0.773, 0.957, 0.983, 0.843, 0.766, and 0.801, respectively. Hence, the imaging lenses 116 in FIGS. 15, 21, 27, 33, 39, 51, 69, 75, and 81 further satisfy the following Condition Expression (11).

$$0.7 3 \leq Ts / TL \leq 0.9 \qquad ( 11 )$$

When Ts/TL is larger than the upper limit of Condition Expression (11), it becomes difficult to secure the peripheral illumination or the back focus as the angle of the imaging lens 116 becomes ultrawide. When Ts/TL is smaller than the lower limit of Condition Expression (11), the total optical length TL becomes extremely long, or an entrance light amount becomes insufficient because it is difficult to appropriately perform the pupil correction by the on-chip lens 258, and the S/N ratio of the electrical signal deteriorates.

Note that the numerical values of the setting data and the aspherical data in the imaging lens 116 are not limited to the above-described numerical values.

The array of the pixels 160 is not limited to the array illustrated in FIG. 6.

### Other Examples of Pixel Array

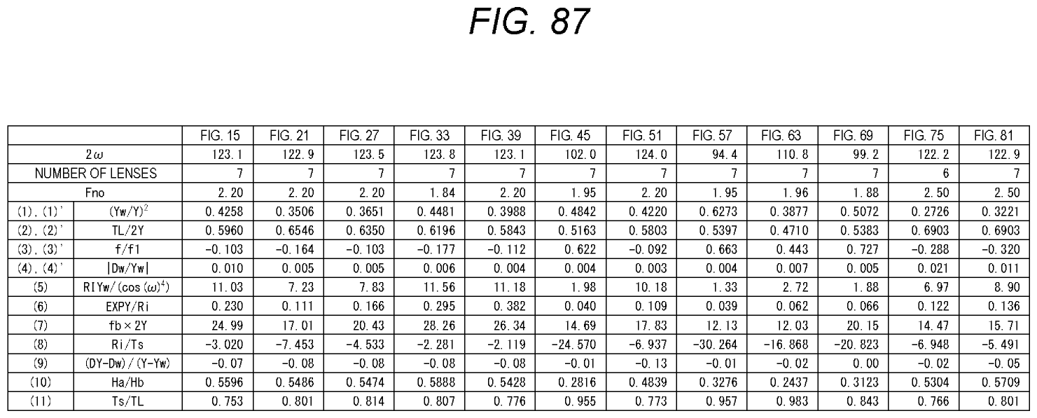

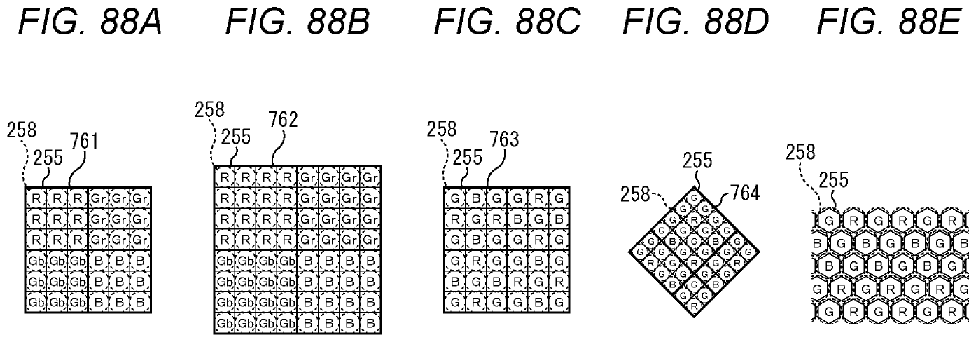

FIGS. 88A to 88E are top views of the imaging element 133 illustrating other examples of the array of pixels 160. Note that, in FIGS. 88A to 88E, in order to simplify the drawing, only a region of some pixels 160 in the imaging element 133 is illustrated, and the antireflection film 259 is omitted.

As illustrated in FIG. 88A, the pixels 160 can be arrayed such that the array of the 6×6 pixels 160 is a Bayer array of same-color pixel groups 761, each of the same-color pixel groups including 3×3 pixels 160. As illustrated in FIG. 88B, the array of the 8×8 pixels 160 can be a Bayer array of same-color pixel groups 762, each of the same-color pixel groups including 4×4 pixels 160. The arrays in FIGS. 88A and 88B differ from the array in FIG. 6 in that the same-color pixel groups 761 and 762 having the color filters 255 of the same color include the 3×3 pixels 160 and the 4×4 pixels 160, respectively. Except for that, the arrays are the same as the array in FIG. 6.

Furthermore, the array of the pixels 160 can also have a predetermined array for each unit pixel group 763 including 3×3 pixels 160 as illustrated in FIG. 88C. Specifically, in the unit pixel group 763, pixels 160 at the four corners and a pixel 160 at the center have the green color filters 255, the pixels 160 at central right and left end portions have one of the red and blue color filters 255, and the pixels 160 at the central upper and lower end portions have the other. Furthermore, one and the other color filters vary between adjacent unit pixel groups 763.

Furthermore, as illustrated in FIG. 88D, the pixels 160 can also be arranged in a matrix-like pattern in which a row direction is a direction inclined by 45 degrees with respect to a horizontal direction and a column direction is a direction inclined by 45 degrees with respect to a vertical direction. In the example of FIG. 88D, the pixel 160 has a predetermined array for each unit pixel group 764 including 4×4 pixels 160. Specifically, in the unit pixel group 764, the pixels 160 in the first and third rows from the top have the green color filters 255. The pixels 160 in the second row from the top alternately have green and red color filters 255, and the pixels 160 in the fourth row from the top alternately have green and blue color filters 255.

Furthermore, as illustrated in FIG. 88E, the pixels 160 can also be arranged in a matrix-like pattern in which a row direction is the horizontal direction and a column direction is a direction inclined by 45 degrees with respect to the vertical direction. In the example of FIG. 88E, columns of the pixels 160 having the green color filters 255 as a whole and columns of the pixels 160 alternately having the red and blue color filters 255 are alternately arranged in the row direction.

As illustrated in FIGS. 88A to 88E, in a case where colors of the color filters 255 of at least some adjacent pixels 160 are the same, it is effective to suppress the same-color sensitivity difference by the imaging element 133 described in FIG. 7. Note that, even in a case where the colors of the color filters 255 of the adjacent pixels 160 are not the same, sensitivity shading due to vignetting can be improved by the imaging element 133 having the curved shape.

The surface 437b (467b, 497b, 527b, 547b, 577b, 607b, 637b, 667b, 697b, 726b, or 757b) may be a spherical surface concave toward the object side.

The maximum angle of view 2ω is desirably 93 degrees or larger suitable for a group photograph or the like. As the maximum angle of view 2ω increases, the effect of shortening the total optical length TL becomes higher. Meanwhile, when the maximum angle of view 2ω is larger than 145 degrees, it is difficult to correct distortion. Furthermore, the effective pixel region in a case where a full angle of view with which imaging is most frequently performed is within 80 degrees relatively decreases, and the resolution is degraded as the number of effective pixels decreases. Hence, the maximum angle of view 2ω is desirably 93 degrees or larger and 145 degrees or smaller.

As described above, the imaging lens 116 includes the lenses 431 to 437 (461 to 467, 491 to 497, 521 to 527, 541 to 547, 571 to 577, 601 to 607, 631 to 637, 661 to 667, 691 to 697, 721 to 726, or 751 to 757) that form an optical image of an object on the imaging surface 133a. The imaging surface 133a has a curved shape. Then, the imaging lens 116 has the maximum angle of view 2ω of 90 degrees or larger and satisfies Condition Expressions (1) to (3) or (1), (2), and (4).

Hence, it is possible to achieve the height reduction and improve the performance while increasing the size (maximum imaging height Y) of the imaging element 133 of the ultrawide-angle camera 11 having the maximum angle of view 2ω of 90 degrees or larger. Specifically, the field curvature that is highly effectively corrected by the imaging surface 133a having a curved shape is proportional to the square of the angle of view with a third-order aberration coefficient. Hence, in the ultrawide-angle camera 11 having the maximum angle of view 2ω of 90 degrees or larger, it is preferable that the imaging surface 133a has a curved shape. The imaging lens 116 is configured to maximize the correction effect of the field curvature, thereby shortening the total optical length TL and realizing the height reduction while ensuring a high imaging height and high performance. As a result, the ultrawide-angle camera 11 can capture a high-quality ultrawide-angle image with height reduction.

Furthermore, the imaging lens 116 can also achieve both the ultrawide angle and good lens characteristics. Here, the good lens characteristics indicate improvement of the peripheral illumination or an image plane incident angle of the principal light, in addition to each aberration correction. The imaging lens 116 can ensure a large number of pixels as the number of pixels of the wide-angle image in which the full angle of view with which imaging is most frequently performed is within 80 degrees.

In the ultrawide-angle camera 11, the imaging surface 133a is curved concavely toward the object side, and the last surface is a spherical surface concave toward the object side or an aspherical surface concave toward the object side as a whole in which the sign of the inclination of the surface is not reversed as a distance from the optical axis increases. Hence, it is easy to ensure back focus or a manufacturing margin. As a result, it is possible to further shorten the total optical length TL.

In the ultrawide-angle camera 11, the imaging surface 133a is curved concavely toward the object side, so that the position of the aperture stop 422 (452, 482, 512, 532, 562, 592, 622, 652, 682, 712, or 742) and the center of curvature of the imaging surface 133a can be brought close to each other. Hence, the ultrawide-angle camera 11 is also advantageous in terms of improving the peripheral illumination or reducing a light beam incident angle on the imaging surface 133a, in addition to various aberration corrections.

Since the ultrawide-angle camera 11 changes a method of reading the electrical signal in the ultrawide-angle mode and the wide-angle mode, the electrical signal can be read by the method of reading the electrical signal most suitable for the characteristics of the imaging lens 116. Specifically, while characteristics such as aberration, peripheral illumination, or the light beam incident angle on the imaging surface 133a are very good in a central region that is a region from a central portion to an intermediate region of the imaging lens 116, these characteristics are relatively degraded in the peripheral region. Hence, in the case where the imaging mode is the wide-angle mode, the electrical signal is less likely to be affected by a decrease in light amount, and thus high resolution is ensured by reading the electrical signal per pixel. Meanwhile, in the case where the imaging mode is the ultrawide-angle mode, the light amount in the peripheral portion significantly decreases particularly at a dark place, and the noise of the electrical signal increases. Hence, the S/N ratio of the electrical signal is improved by adding and reading the electrical signals of the same-color pixel groups 271 (761 or 762). Note that, since the number of effective pixels in the ultrawide-angle mode is larger than the number of effective pixels in the wide-angle mode, an effect of a decrease in the number of pixels is relatively small due to the addition of the electrical signals (pixel addition).

### 2. Second Embodiment

### External Configuration Example of Smartphone

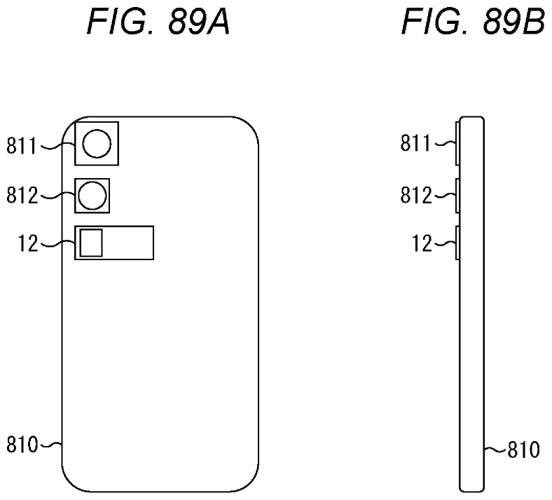

FIGS. 89A and 89B are views illustrating an external configuration example of a smartphone including an ultrawide-angle camera that is a second embodiment of the imaging apparatus to which the present technology is applied.

FIG. 89A is a rear view of a smartphone 810, and FIG. 89B is a side view of the smartphone 810.

In the smartphone 810 in FIGS. 89A and 89B, components corresponding to those of the smartphone 10 in FIGS. 1A and 1B are assigned with the same reference numerals. Hence, the description of the components will be appropriately omitted, and the following description will be provided focusing on components different from those of the smartphone 10. The smartphone 810 differs from the smartphone 10 in that an ultrawide-angle camera and a wide-angle camera are separately provided. Except for that, the smartphone 810 is configured similarly to the smartphone 10 in FIGS. 1A and 1B.

Specifically, the smartphone 810 includes a wide-angle camera 811, an ultrawide-angle camera 812, and a telephoto camera 12 as a multi-lens camera. The wide-angle camera 811 images a wide-angle image. The ultrawide-angle camera 812 differs from the ultrawide-angle camera 11 in that the imaging mode is only the ultrawide-angle mode and that a method of reading the electrical signal in the ultrawide-angle mode is a method of individually reading the electrical signals of the respective pixels 160. Except for that, the ultrawide-angle camera 812 is configured similarly to the ultrawide-angle camera 11. Hence, the ultrawide-angle camera 812 can realize imaging of, with height reduction, a high-quality ultrawide-angle image, similarly to the ultrawide-angle camera 11.

### 3. Third Embodiment

### Configuration Example of Ultrawide-Angle Sensor

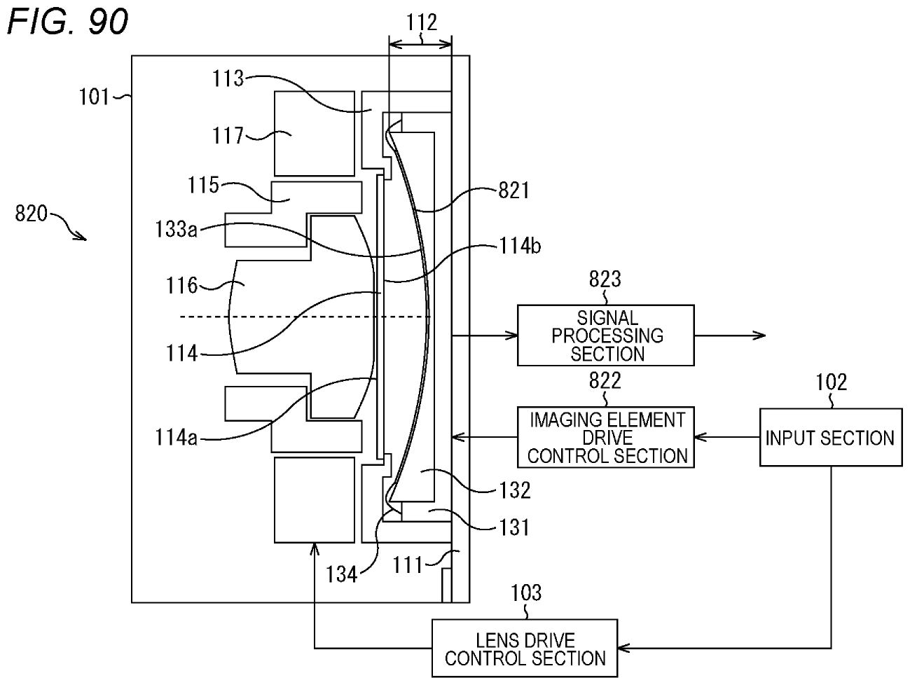

FIG. 90 is a diagram illustrating a configuration example of an ultrawide-angle sensor that is a third embodiment of the imaging apparatus to which the present technology is applied.

In an ultrawide-angle sensor 820 in FIG. 90, components corresponding to those of the ultrawide-angle camera 11 in FIG. 2 are assigned by the same reference numerals. Hence, the description of the components will be appropriately omitted, and the following description will be provided focusing on components different from those of the ultrawide-angle camera 11. The ultrawide-angle sensor 820 differs from the ultrawide-angle camera 11 in that, instead of the ultrawide-angle image, an ultrawide-angle phase-contrast image indicating phase contrast of an ultrawide-angle image is generated. Except for that, the ultrawide-angle sensor 820 is configured similarly to the ultrawide-angle camera 11.

Specifically, the ultrawide-angle sensor 820 differs from the ultrawide-angle camera 11 in that the ultrawide-angle sensor 820 includes an imaging element 381, an imaging element drive control section 822, and a signal processing section 823 instead of the imaging element 133, the imaging element drive control section 104, and the signal processing section 105. Except for that, the ultrawide-angle sensor 820 is configured similarly to the ultrawide-angle camera 11.

The imaging element 381 differs from the imaging element 133 in that a pixel has one or more photoelectric conversion units, an on-chip lens is formed for each phase pixel block including pixels corresponding to a plurality of adjacent photoelectric conversion units, and an image signal is generated per photoelectric conversion unit. Except for that, the imaging element 381 is configured similarly to the imaging element 133.

The imaging element drive control section 822 differs from the imaging element drive control section 104 in that the imaging element drive control section 822 generates, as an imaging element drive control signal, a signal indicating an effective pixel. Except for that, and the imaging element drive control section 822 is configured similarly to the imaging element drive control section 104.

The signal processing section 823 stores, in a built-in memory as necessary, the image signal output per photoelectric conversion unit from the imaging element 381. For each phase pixel block, the signal processing section 823 (phase contrast detection unit) detects phase contrast of an image signal with parallax of a plurality of photoelectric conversion units constituting the phase pixel block and generates an ultrawide-angle phase-contrast image indicating the phase contrast. The signal processing section 823 calculates and outputs a distance to a subject on the basis of the ultrawide-angle phase-contrast image.

### Configuration Example of Imaging Element

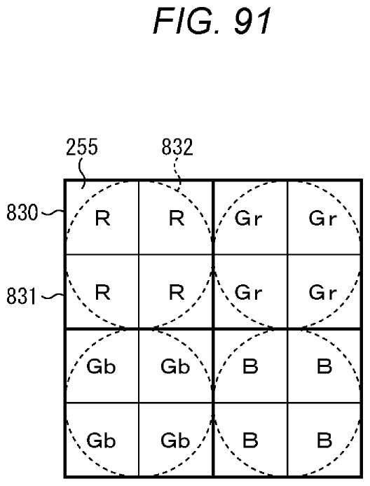

FIG. 91 is a top view illustrating a configuration example of the imaging element 381 in FIG. 90.

Note that, in FIG. 91, in order to simplify the drawing, only a region of 4×4 pixels 830 including four pixels arranged in a horizontal direction and four pixels arranged in a vertical direction in the imaging element 381 is illustrated, and the antireflection film 259 is omitted. In FIG. 91, portions corresponding to those in FIG. 6 are assigned with the same reference numerals. Therefore, the description of the portions will be appropriately omitted, and the following description will be provided focusing on portions different from those in FIG. 6.

In the example of FIG. 91, the array of 4×4 pixels 830 is a Bayer array of phase pixel blocks 831, that is, a Quad Bayer array, in which each phase pixel block 831 includes 2×2 pixels 830 having the color filters 255 of the same color. The pixel 830 is configured similarly to the pixel 160.

An on-chip lens 832 formed on the color filter 255 of each pixel 830 is formed per phase pixel block 831. Therefore, parallax occurs between two adjacent pixels 830 in the phase pixel block 831. Hence, the signal processing section 823 detects the phase contrast between the image signals of the two pixels 830. Note that the pixels 830 in the phase pixel block 831 may share the charge holding unit 202.

### Description of Effects of Imaging Element

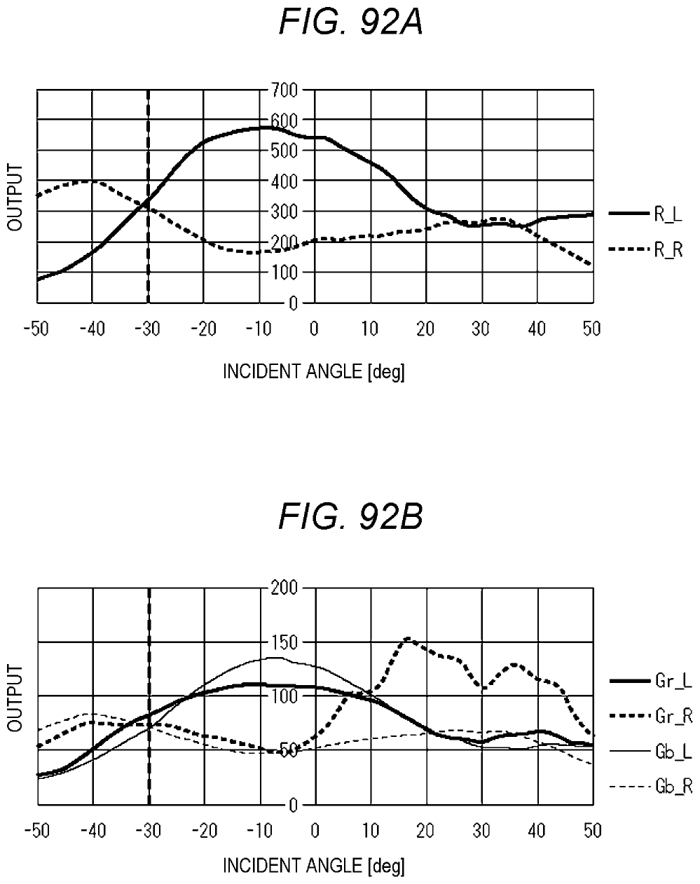

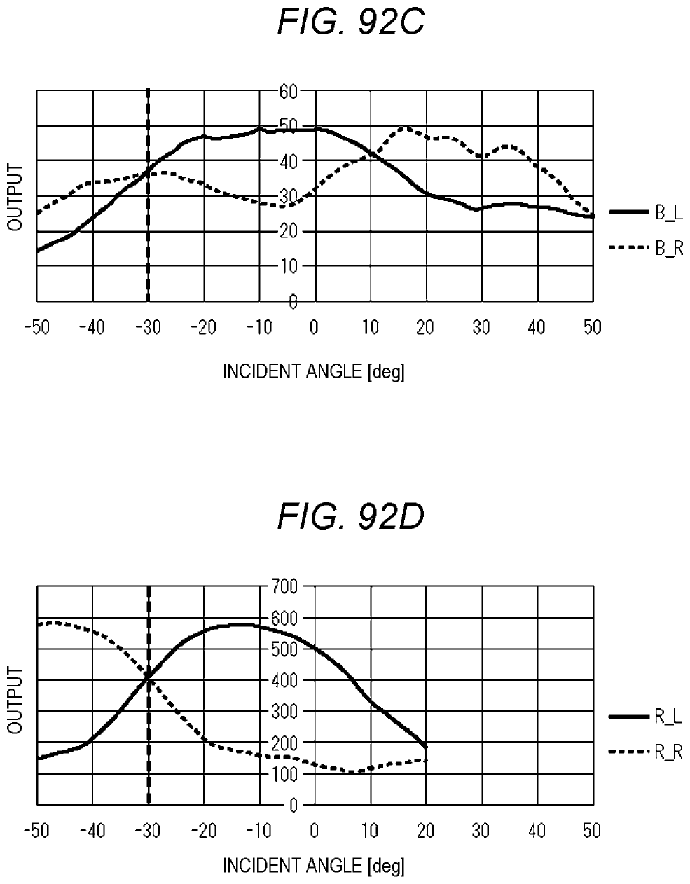

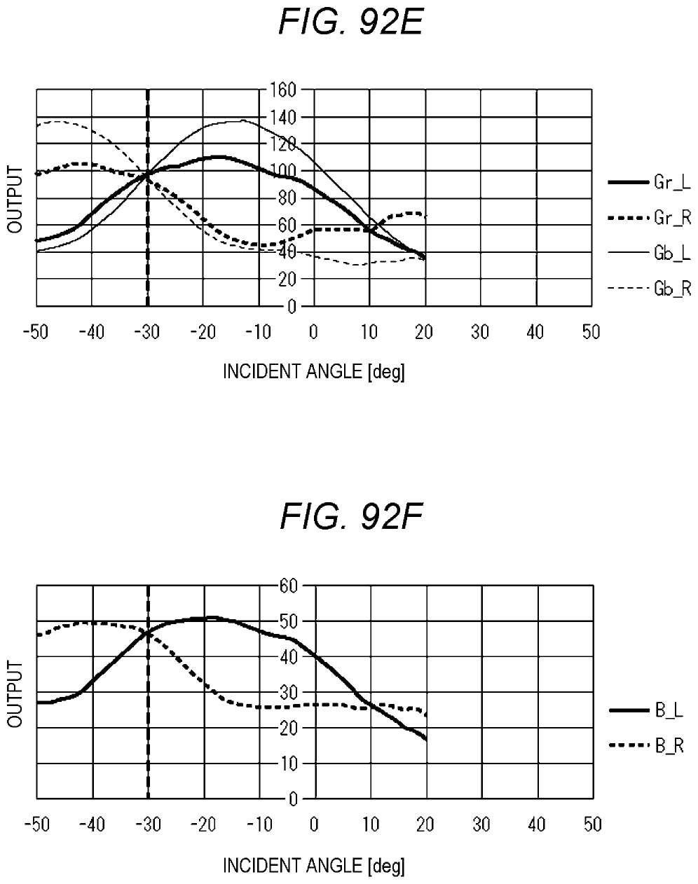

FIGS. 92A to 92F are graphs illustrating effects of the imaging element 381.

FIGS. 92A to 92C are respective graphs illustrating light reception angle distributions of pixels having red, green, and blue color filters adjacent on the right and left sides in a phase pixel block of an imaging element having a pupil correction function and a flat imaging surface and having the configuration of the pixel illustrated in FIG. 91. The light reception angle distribution is a distribution representing incident angle dependence of an image signal output when parallel light is incident. FIGS. 92D to 92F are respective graphs illustrating light reception angle distributions of the pixels 830 having the red, green, and blue color filters 255 adjacent on the right and left sides in the phase pixel block 831 of the imaging element 381 which does not have the pupil correction function.

In FIGS. 92A to 92F, the horizontal axis represents an incident angle (deg) of parallel light having a wavelength of 650 nm incident on the pixel, and the vertical axis represents an output value of an image signal. In FIGS. 92A, 92C, 92D, and 92F, a solid line represents a light reception angle distribution of left pixels, and a dotted line represents a light reception angle distribution of right pixels. In FIGS. 92B and 92E, a thick solid line represents a light reception angle distribution of the left pixels in a phase pixel block having the green (Gr) color filter at the upper right portion of the Quad Bayer array, and a thick dotted line represents a light reception angle distribution of the right pixels therein. In FIGS. 92B and 92E, a thin solid line represents a light reception angle distribution of the left pixels in the phase pixel block having the green (Gr) color filter at the lower left portion of the Quad Bayer array, and a thin dotted line represents a light reception angle distribution of the right pixels therein. Note that, in FIGS. 92A to 92F, the CRA at an end portion of the maximum angle of view is −30 deg.

As illustrated in FIGS. 92A to 92C, in the imaging element having the flat imaging surface, the light reception angle distribution is distorted due to the anisotropy of vignetting and mixed colors even in a case where the pupil correction is performed on obliquely incident light. As a result, at the time of detecting the phase contrast, a mismatch between image signals of pixels having different parallaxes occurs, and the distance measurement accuracy is degraded.

On the other hand, as illustrated in FIGS. 92D to 92F, in the imaging element 381 having a curved shape, a light reception angle distribution having better symmetry without anisotropy of vignetting or mixed colors is obtained as compared with FIGS. 92A to 92C. Hence, separation of the image signals is high between the left pixels 830 and the right pixels 830 in the phase pixel block 831. As a result, good distance measurement accuracy can be obtained.

Note that, in a green (Gb) pixel 830 and a green (Gr) pixel 830, a change in the image signal due to the incident angle varies depending on a difference in mixed colors leaking from a red pixel 830. However, since cross points of the image signals of the right and left green (Gb) pixels 830 and cross points of the image signals of the right and left green (Gr) pixels 830 coincide with each other and symmetry in the right and left pixels 830 is maintained, there is no problem in the distance measurement accuracy.

### Other Configuration Examples of Imaging Element

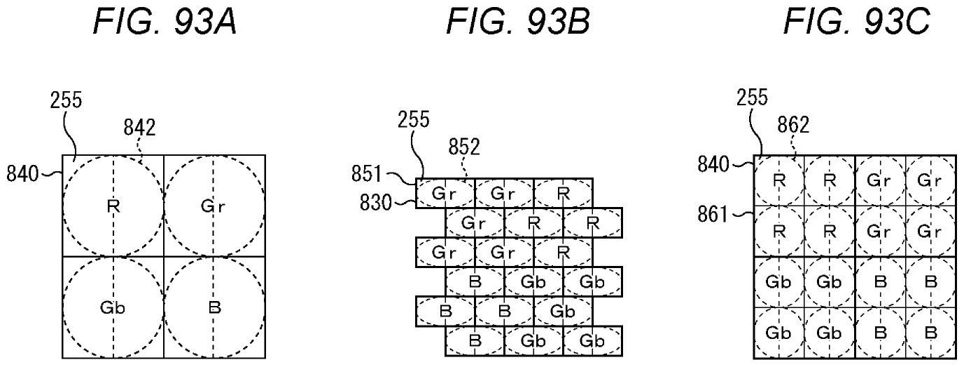

FIGS. 93A to 93C are top views illustrating other configuration examples of the imaging element 381.

Note that, in FIGS. 93A to 93C, in order to simplify the drawing, only a region of some pixels in the imaging element 381 is illustrated, and the antireflection film 259 is omitted. In FIGS. 93A to 93C, portions corresponding to those in FIG. 91 are assigned with the same reference numerals. Therefore, the description of the portions will be appropriately omitted, and the following description will be provided focusing on portions different from those in FIG. 91.

In the example of FIG. 93A, the imaging element 381 has a plurality of pixels 840, and an array of 2×2 pixels 840 is a Bayer array. A configuration of the pixel 840 differs from the configuration of the pixel 160 in that the pixel 840 has two photoelectric conversion units adjacent in the horizontal direction. Except for that, the pixel 840 is configured similarly to the pixel 160. The pixel 840 corresponding to the two horizontally adjacent photoelectric conversion units having the color filters 255 of the same color is set in a phase pixel block, and an on-chip lens 842 is formed per pixel 840. In the example of FIG. 93A, phase contrast of the image signals due to the parallax between the two photoelectric conversion units included in the pixel 840 is detected. In the example of FIG. 93B, the imaging element 381 has a plurality of pixels 830, and an array of the pixels 830 is a Bayer array of a red pixel group, a green pixel group, and a blue pixel group. The red pixel group includes pixels 830 of three rows having the red color filters 255. The pixels 830 in a first row and a third row from the top of three rows are 1×2 pixels 830, and the pixels 830 in a second row are 1×4 pixels 830 shifted by one pixel in the left direction with respect to the first row. The green pixel group includes pixels 830 of three rows having the green color filters 255. The pixels 830 in first and third rows from the top of the three rows are 1×4 pixels 830, and the pixels 830 in the second row are 1×2 pixels 830 shifted by one pixel in the right direction with respect to the first row. The blue pixel group differs from the red pixel group in that the color of the color filters 255 is blue. Except for that, the blue pixel group is configured similarly to the red pixel group.

The 1×2 pixels 830 corresponding to the two horizontally adjacent photoelectric conversion units having the color filters 255 of the same color are set in a phase pixel block 851, and the color filter 255 is formed per pixel block 851. In the example of FIG. 93A, the phase contrast of the image signals due to parallax between the two pixels 830 constituting the phase pixel block 851 is detected.

In the example of FIG. 93C, the imaging element 381 has a plurality of pixels 840, and an array of 4×4 pixels 840 is a Bayer array, that is, a Quad Bayer array, of same-color pixel groups 861, each of the same-color pixel groups including 2×2 pixels 840 having the color filters 255 of the same color. The pixel 840 corresponding to the two horizontally adjacent photoelectric conversion units having the color filters 255 of the same color is set in the phase pixel block, and an on-chip lens 862 is formed per pixel 840. In the example of FIG. 93C, phase contrast of the image signals due to the parallax between the two photoelectric conversion units included in the pixel 840 is detected. As described above, the signal processing section 823 detects the phase contrast of the image signal due to the parallax of a plurality of adjacent photoelectric conversion units in the phase pixel block. Hence, the signal processing section 823 can measure a distance to a subject on the basis of the phase contrast. At this time, since the imaging element 381 has a curved shape, good distance measurement accuracy can be obtained as described with reference to FIGS. 92A to 92F.

Note that, the infrared cut filter 114 may be curved instead of being formed of a parallel flat plate. In this case, it is easy to ensure a distance between the lens 437 (467, 497, 527, 547, 577, 607, 637, 667, 697, 726, or 757) or the imaging surface 133a and the infrared cut filter 114, so that the total optical length TL can be further shortened. In addition, similarly to the effect of the curvature of the imaging surface 133a, it is possible to reduce a light beam incident angle of off-axis light to the infrared cut filter 114.

Types of colors of the color filter 255 are not limited to the three colors of red, green, and blue. For example, the colors of the color filters 255 may be three colors of cyan, magenta, and yellow or white.

The number of lenses of the imaging lens 116 is not limited to the above-described number as long as the number of lenses is one or more. The number of lenses is desirably seven or more. In a case where the number of lenses is seven or more, the F value is 2.2 or less. Therefore, it is possible to perform good aberration correction to the peripheral portion while shortening the total optical length TL.

A metalens having a nanostructure may be disposed on the object side with respect to the imaging surface 133a. In general, since the metalens has low light use efficiency at oblique incidence, it is preferable to combine the metalens with the curved imaging surface 133a.

The metalens can have, for example, a pupil correction function of efficiently allowing a light beam reaching the imaging surface 133a to be incident on the pixel 160 (330 or 340), a color separation function as a substitute for the color filter 255, or the like. The metalens can also have an antireflection function excellent in angle characteristics, a function of increasing a focal depth by arranging minimum lenses in parallel, or the like.

It is desirable to divide a region on the imaging surface 133a into a central region and a peripheral region, form a metalens having a pupil correction function in the central region, and form a metalens having a color separation function in the peripheral region. A range of an intermediate region or the peripheral region can be appropriately set according to a purpose of use. For example, the intermediate region can be a region having the half angle of view of 40 degrees, and the peripheral region can be a region having the half angle of view of 60 degrees.

While the light use efficiency is significantly improved in the metalens having the color separation function as compared with the color filter 255, the resolution is degraded. Hence, by forming the metalens having the pupil correction function in the central region and forming the metalens having the color separation function in the peripheral region, it is possible to ensure the resolution in the intermediate region and improve the light use efficiency in the peripheral region. The forming of the metalens having the pupil correction function in the central region and the forming of the metalens having the color separation function in the peripheral region can be integrally performed in a semiconductor process. Hence, the imaging surface 133a having such a metalens can be manufactured to have a large area at low costs.

Redundant light and degradation of the resolution caused by the metalens and a change in an image at a boundary portion of the metalens are desirably corrected by the signal processing section 105 (323) or the like in the subsequent stage.

### 4. Example of Application to Mobile Body

The technology according to the present disclosure (the present technology) can be applied to various products. For example, the technology according to the present disclosure may be implemented as a device mounted on any type of mobile body such as an automobile, an electric vehicle, a hybrid electric vehicle, a motorcycle, a bicycle, a personal mobility, an airplane, a drone, a ship, or a robot.

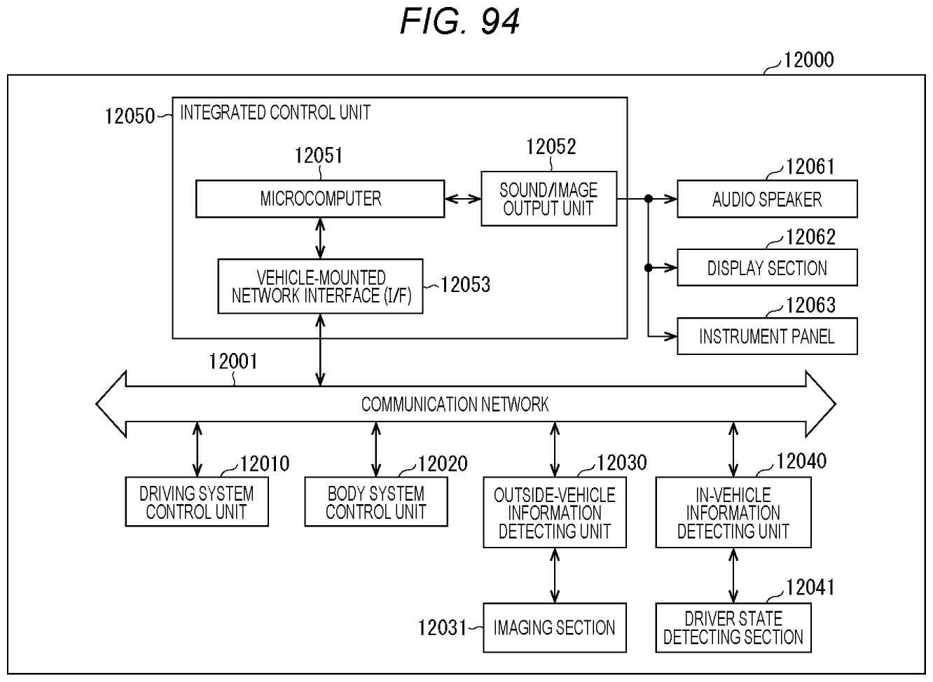

FIG. 94 is a block diagram illustrating a schematic configuration example of a vehicle control system which is an example of a mobile body control system to which the technology according to the present disclosure can be applied.

The vehicle control system 12000 includes a plurality of electronic control units connected to each other via a communication network 12001. In the example illustrated in FIG. 94, the vehicle control system 12000 includes a driving system control unit 12010, a body system control unit 12020, an outside-vehicle information detection unit 12030, an in-vehicle information detection unit 12040, and an integrated control unit 12050. Furthermore, a microcomputer 12051, a sound/image output section 12052, and a vehicle-mounted network interface (I/F) 12053 are illustrated as a functional configuration of the integrated control unit 12050.

The driving system control unit 12010 controls operations of devices related to a driving system of the vehicle in accordance with various kinds of programs. For example, the driving system control unit 12010 functions as a control device for a driving force generating device for generating a driving force of the vehicle, such as an internal combustion engine, a driving motor, or the like, a driving force transmitting mechanism for transmitting the driving force to wheels, a steering mechanism for adjusting a steering angle of the vehicle, a braking device for generating a braking force of the vehicle, and the like.

The body system control unit 12020 controls operations of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detection unit 12030 detects information about the outside of the vehicle including the vehicle control system 12000. For example, the outside-vehicle information detection unit 12030 is connected with an imaging section 12031. The outside-vehicle information detection unit 12030 makes the imaging section 12031 image an image of the outside of the vehicle, and receives the imaged image. On the basis of the received image, the outside-vehicle information detection unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electrical signal corresponding to a received light amount of the light. The imaging section 12031 can output the electrical signal as an image, or can output the electrical signal as information about a measured distance. Furthermore, the light received by the imaging section 12031 may be visible light, or may be invisible light such as infrared rays or the like.

The in-vehicle information detection unit 12040 detects information about the inside of the vehicle. The in-vehicle information detection unit 12040 is, for example, connected with a driver state detecting section 12041 that detects the state of a driver. The driver state detecting section 12041 includes, for example, a camera that images the driver. On the basis of detection information input from the driver state detecting section 12041, the in-vehicle information detection unit 12040 may calculate a degree of fatigue of the driver or a degree of concentration of the driver, or may discriminate whether the driver is dozing.

The microcomputer 12051 can calculate a control target value for the driving force generating device, the steering mechanism, or the braking device on the basis of the information about the inside or outside of the vehicle obtained by the outside-vehicle information detection unit 12030 or the in-vehicle information detection unit 12040, and can output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

Furthermore, the microcomputer 12051 can perform cooperative control intended for automated driving, which makes the vehicle to travel automatedly without depending on the operation of the driver, or the like, by controlling the driving force generating device, the steering mechanism, the braking device, or the like on the basis of the information about the outside or inside of the vehicle which information is obtained by the outside-vehicle information detection unit 12030 or the in-vehicle information detection unit 12040.

Furthermore, the microcomputer 12051 can output a control command to the body system control unit 12020 on the basis of the information about the outside of the vehicle obtained by the outside-vehicle information detection unit 12030. For example, the microcomputer 12051 can perform cooperative control intended to prevent a glare by controlling the headlamp to change from a high beam to a low beam, for example, in response to the position of a preceding vehicle or an oncoming vehicle detected by the outside-vehicle information detection unit 12030.

The sound/image output section 12052 transmits an output signal of at least one of a sound and an image to an output device capable of visually or auditorily notifying information to an occupant of the vehicle or the outside of the vehicle. In the example of FIG. 94, an audio speaker 12061, a display section 12062, and an instrument panel 12063 are exemplified as the output device. The display section 12062 may, for example, include at least one of an on-board display and a head-up display.

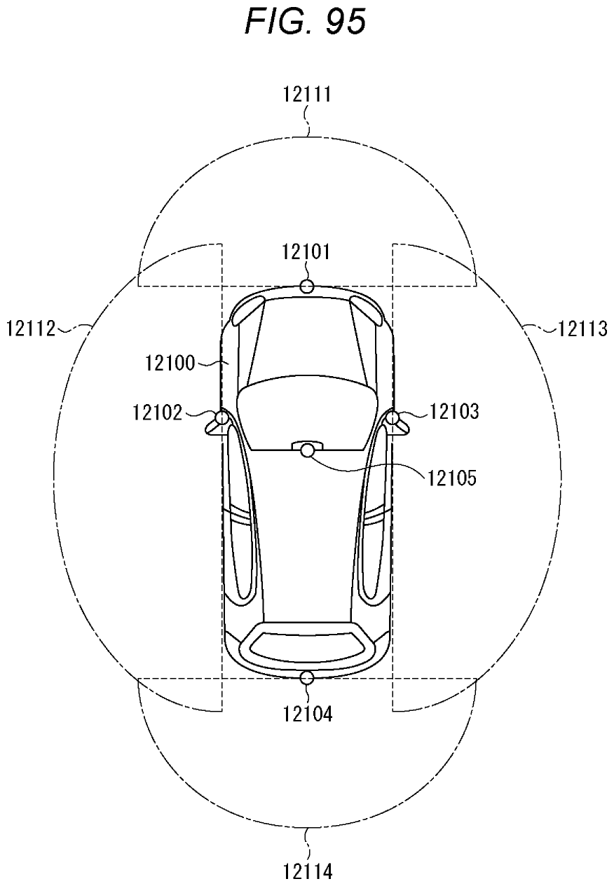

FIG. 95 is a diagram illustrating an example of an installation position of the imaging section 12031.

In FIG. 95, a vehicle 12100 includes imaging sections 12101, 12102, 12103, 12104, and 12105 as the imaging section 12031.

The imaging sections 12101, 12102, 12103, 12104, 12105 are provided, for example, at positions such as a front nose, a side mirror, a rear bumper, a back door, and an upper portion of a windshield in the interior of a vehicle 12100. The imaging section 12101 provided to the front nose and the imaging section 12105 provided to the upper portion of the windshield within the interior of the vehicle obtain mainly an image of the front of the vehicle 12100. The imaging sections 12102, 12103 provided at the side mirrors obtain mainly images of the sides of the vehicle 12100. The imaging section 12104 provided to the rear bumper or the back door obtains mainly an image of the rear of the vehicle 12100. The forward images obtained by the imaging sections 12101 and 12105 are used mainly to detect a preceding vehicle, a pedestrian, an obstacle, a traffic signal, a traffic sign, a lane, or the like.

Note that FIG. 95 illustrates an example of photographing ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase contrast detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed to be superimposed on the recognized pedestrian. Furthermore, the sound/image output section 12052 may also control the display section 12062 so that an icon or the like representing the pedestrian is displayed at a desired position.

An example of the vehicle control system to which the technology according to the present disclosure can be applied has been described above. The technique according to the present disclosure can be applied to the imaging section 12031 and the like in the configuration described above. Specifically, the ultrawide-angle camera 11 (312) and the ultrawide-angle sensor 820 can be applied to the imaging section 12031. By applying the technology according to the present disclosure to the imaging section 12031, it is possible to realize imaging of, with height reduction, an ultrawide-angle image or an ultrawide-angle phase-contrast image with high image quality. As a result, a driver's fatigue can be reduced without impairing design of the vehicle 12100.

Embodiments of the present technology are not limited to the above-described embodiments, and various modifications may be made without departing from the gist of the present technology.

For example, it is possible to adopt a mode obtained by combining all or some of the plurality of embodiments described above. Specifically, the ultrawide-angle camera 11 (312) can also generate a wide-angle phase-contrast image or an ultrawide-angle phase-contrast image indicating phase contrast of a wide-angle image, or the ultrawide-angle sensor 820 can also generate an ultrawide-angle image or a wide-angle image.

Note that, the effects described in the present specification are merely examples and are not limited, and there may be effects other than those described in the present specification.

The present technology can have the following configurations.

(1)

An imaging lens including:
a lens group of one or more lenses which forms an optical image of an object on an imaging surface having a curved shape, in which
a maximum angle of view is 90 degrees or larger, and when a first imaging height that is an imaging height in a case where a half angle of view is 40 degrees is denoted by Yw, a second imaging height that is an imaging height in a case of a maximum half view angle which is a half of the maximum angle of view is denoted by Y, a total optical length that is a distance on an optical axis from an object-side surface of a lens closest to an object in the lens group to the imaging surface is denoted by TL, a focal length of the entire imaging lens is denoted by f, and a focal length of the lens closest to the object is denoted by f1, the following expressions are satisfied

$$0.27 \leq {( Yw / Y )}^{2} \leq 0.7$$

$$0.3 \leq TL / 2 Y \leq 0 \text{.695}$$

$$- 0.3 \; 5 \leq f / f 1 \leq 0.73 .$$

(2)

The imaging lens according to (1), in which
the lens group includes six or more lenses including at least one aspherical lens, and
an F value is 2.5 or smaller.
   (3)

The imaging lens according to (1) or (2), in which, when a peripheral illumination ratio with respect to a center of the imaging surface in a case where the half angle of view is 40 degrees is denoted by RIYw and the maximum half view angle is denoted by ω, the following expression is satisfied

$$1. 2 \leq R IYw / {cos ( ω )}^{4} ) \leq 35.$$

(4)

The imaging lens according to any one of (1) to (3), in which, when a distance of a light beam having the second imaging height on an optical axis from the imaging surface to an exit pupil is denoted by EXPY and a curvature radius of a center of the imaging surface is denoted by Ri, the following expression is satisfied

$$0. 01 \leq EXPY / Ri \leq 0.39 .$$

(5)

The imaging lens according to any one of (1) to (4), in which, when the second imaging height is denoted by Y, and a distance on an optical axis from an imaging-surface-side surface of a lens closest to the imaging surface in the lens group to the imaging surface is denoted by fb, the following expression is satisfied

$$9.7 \leq fb \times 2 Y \leq 28.4 .$$

(6)

The imaging lens according to any one of (1) to (5) further including
an aperture stop, in which
when a curvature radius of a center of the imaging surface is denoted by Ri and a distance on an optical axis from the aperture stop to the imaging surface is denoted by Ts, the following expression is satisfied

$$- 50 \leq Ri / Ts \leq - 1.95 .$$

(7)

The imaging lens according to any one of (1) to (6), in which
the imaging surface is concavely curved toward the object side, and
an imaging-surface-side surface of a lens closest to the imaging surface in the lens group is a spherical surface concave toward the object side or an aspherical surface concave toward the object side as a whole in which a sign of an inclination of the surface is not reversed while a distance from the optical axis increases.
   (8)

The imaging lens according to any one of (1) to (7), in which
the imaging surface has an aspherical shape curved concavely toward the object side, and
a displacement amount of the imaging surface with respect to a spherical surface increases in a direction in which the imaging surface is away from the imaging lens while a distance from the optical axis increases.
   (9)

The imaging lens according to any one of (1) to (8), in which, when optical distortion at the second imaging height is denoted by DY, optical distortion at the first imaging height is denoted by Dw, the second imaging height is denoted by Y, and the first imaging height is denoted by Yw, the following expression is satisfied

$$- 0.16 \leq ( DY - Dw ) / ( Y - Yw ) \leq 0.16 .$$

(10)

The imaging lens according to any one of (1) to (9), in which, when a maximum effective radius of the object-side surface of the lens closest to the object is denoted by Ha and a maximum effective radius of an imaging-surface-side surface of a lens closest to the imaging surface in the lens group is denoted by Hb, the following expression is satisfied

$$0.47 5 \leq Ha / Hb \leq 0.68 .$$

(11)

The imaging lens according to any one of (1) to (5) and (7) to (10), further including
an aperture stop, in which
when a distance on the optical axis from the aperture stop to the imaging surface is denoted by Ts and the total optical length is denoted by TL, the following expression is satisfied

$$0.7 3 \leq Ts / TL \leq 0.9 .$$

(12)

An imaging apparatus including:
an imaging lens configured to
include a lens group of one or more lenses which forms an optical image of an object on an imaging surface having a curved shape,
have a maximum angle of view of 90 degrees or larger, and satisfy the following expressions, when a first imaging height that is an imaging height in a case where a half angle of view is 40 degrees is denoted by Yw, a second imaging height that is an imaging height in a case of a maximum half view angle which is a half of the maximum angle of view is denoted by Y, a total optical length that is a distance on an optical axis from an object-side surface of a lens closest to an object in the lens group to the imaging surface is denoted by TL, a focal length of the entire imaging lens is denoted by f, and a focal length of the lens closest to the object is denoted by f1; and

$$0.27 \leq {( Yw / Y )}^{2} \leq 0.7$$

$$0.3 \leq TL / 2 Y \leq 0.6 \; 95$$

$$- 0.3 \; 5 \leq f / f 1 \leq 0.73$$

an imaging element having the imaging surface, in which the imaging surface has a pixel array portion formed to include a plurality of pixels, and
each of the pixels has one or more photoelectric conversion units that convert light corresponding to the optical image formed on the imaging surface into a charge and outputs an electrical signal corresponding to the charge.
   (13)

The imaging apparatus according to (12) further including an image generating section that generates, based on the electrical signal read from each of the pixels, an ultrawide-angle image that is an image having an angle of view in a range from the maximum angle of view to a predetermined angle, or a wide-angle image that is an image having an angle of view smaller than the predetermined angle.

(14)

The imaging apparatus according to (13), in which an ultrawide-angle reading method which is a method of reading the electrical signal at a time of generating the ultrawide-angle image differs from a wide-angle reading method which is a method of reading the electrical signal at a time of generating the wide-angle image.

(15)

The imaging apparatus according to (14) further including color filters formed on the imaging lens side of the pixels, in which
the ultrawide-angle reading method is a method of adding and reading the electrical signal of each of the pixels having the color filters of respective colors for each pixel block including a plurality of the pixels, and the wide-angle reading method is a method of individually reading the electrical signal for each of the pixels.
   (16)

The imaging apparatus according to (15), in which
the pixels having the color filters for the same color in the pixel block share a charge holding unit that holds the charge, and
the ultrawide-angle reading method is a method of reading the electrical signal corresponding to the charge held in the charge holding unit.
   (17)

The imaging apparatus according to any one of (12) to (16), further including
a phase contrast detection unit that detects a phase contrast of the electrical signal due to parallax of a plurality of the adjacent photoelectric conversion units.
   (18)

An imaging lens including
a lens group of one or more lenses which forms an optical image of an object on an imaging surface having a curved shape, in which
a maximum angle of view is 90 degrees or larger, and when a first imaging height that is an imaging height in a case where a half angle of view is 40 degrees is denoted by Yw, a second imaging height that is an imaging height in a case of a maximum half view angle which is a half of the maximum angle of view is denoted by Y, a total optical length that is a distance on an optical axis from an object-side surface of a lens closest to an object in the lens group to the imaging surface is denoted by TL, and optical distortion at the first imaging height is denoted by Dw, the following expressions are satisfied

$$0.27 \leq {( Yw / Y )}^{2} \leq 0.7$$

$$3 \leq TL / 2 Y \leq 0.6 \; 95$$

$$0.001 \leq \vert Dw / Yw \vert \leq 0.08 .$$

(19)

The imaging lens according to (18), in which the lens group includes six or more lenses including at least one aspherical lens, and an F value is 2.5 or smaller.

(20)

The imaging lens according to (18) or (19), in which, when a peripheral illumination ratio with respect to a center of the imaging surface in a case where the half angle of view is 40 degrees is denoted by RIYw and the maximum half view angle is denoted by ω, the following expression is satisfied

$$1. 2 \leq R IYw / {cos ( ω )}^{4} ) \leq 35.$$

(21)

The imaging lens according to any one of (18) to (20), in which, when a distance of a light beam having the second imaging height on an optical axis from the imaging surface to an exit pupil is denoted by EXPY and a curvature radius of a center of the imaging surface is denoted by Ri, the following expression is satisfied

$$0. 01 \leq EXPY / Ri \leq 0.39 .$$

(22)

The imaging lens according to any one of (18) to (21), in which, when the second imaging height is denoted by Y, and a distance on an optical axis from an imaging-surface-side surface of a lens closest to the imaging surface in the lens group to the imaging surface is denoted by fb, the following expression is satisfied

$$9.7 \leq fb \times 2 Y \leq 28.4 .$$

(23)

The imaging lens according to any one of (18) to (22) further including
an aperture stop, in which
when a curvature radius of a center of the imaging surface is denoted by Ri and a distance on an optical axis from the aperture stop to the imaging surface is denoted by Ts, the following expression is satisfied

$$- 50 \leq Ri / Ts \leq - 1.95 .$$

(24)

The imaging lens according to any one of (18) to (23), in which
the imaging surface is concavely curved toward the object side, and
an imaging-surface-side surface of a lens closest to the imaging surface in the lens group is a spherical surface concave toward the object side or an aspherical surface concave toward the object side as a whole in which a sign of an inclination of the surface is not reversed while a distance from the optical axis increases.
   (25)

The imaging lens according to any one of (18) to (24), in which
the imaging surface has an aspherical shape curved concavely toward the object side, and
a displacement amount of the imaging surface with respect to a spherical surface increases in a direction in which the imaging surface is away from the imaging lens while a distance from the optical axis increases.
   (26)

The imaging lens according to any one of (18) to (25), in which, when optical distortion at the second imaging height is denoted by DY, optical distortion at the first imaging height is denoted by Dw, the second imaging height is denoted by Y, and the first imaging height is denoted by Yw, the following expression is satisfied

$$- 0.16 \leq ( DY - Dw ) / ( Y - Yw ) \leq 0.16 .$$

(27)

The imaging lens according to any one of (18) to (26), in which, when a maximum effective radius of the object-side surface of the lens closest to the object is denoted by Ha and a maximum effective radius of an imaging-surface-side surface of a lens closest to the imaging surface in the lens group is denoted by Hb, the following expression is satisfied

$$0.475 \leq Ha / Hb \leq 0.68 .$$

(28)

The imaging lens according to any one of (18) to (22) and (24) to (27), further including
an aperture stop, in which
when a distance on the optical axis from the aperture stop to the imaging surface is denoted by Ts and the total optical length is denoted by TL, the following expression is satisfied

$$0.73 \leq Ts / TL \leq 0.9 .$$

(29)

An imaging apparatus including:
an imaging lens configured to include a lens group of one or more lenses which forms an optical image of an object on an imaging surface having a curved shape,
have a maximum angle of view of 90 degrees or larger, and satisfy the following expressions, when a first imaging height that is an imaging height in a case where a half angle of view is 40 degrees is denoted by Yw, a second imaging height that is an imaging height in a case of a maximum half view angle which is a half of the maximum angle of view is denoted by Y, a total optical length that is a distance on an optical axis from an object-side surface of a lens closest to an object in the lens group to the imaging surface is denoted by TL, and optical distortion at the first imaging height is denoted by Dw; and

$$0.27 \leq {( Yw / Y )}^{2} \leq 0.7 \\ 0.3 \leq TL / 2 Y \leq 0.695 \\ 0.001 \leq \vert Dw / Yw \vert \leq 0.08$$

an imaging element having the imaging surface, in which the imaging surface has a pixel array portion formed to include a plurality of pixels, and
each of the pixels has one or more photoelectric conversion units that convert light corresponding to the optical image formed on the imaging surface into a charge and outputs an electrical signal corresponding to the charge.
   (30)

The imaging apparatus according to (29) further including an image generating section that generates, based on the electrical signal read from each of the pixels, an ultrawide-angle image that is an image having an angle of view in a range from the maximum angle of view to a predetermined angle, or a wide-angle image that is an image having an angle of view smaller than the predetermined angle.

(31)

The imaging apparatus according to (30), in which an ultrawide-angle reading method which is a method of reading the electrical signal at a time of generating the ultrawide-angle image differs from a wide-angle reading method which is a method of reading the electrical signal at a time of generating the wide-angle image.

(32)

The imaging apparatus according to (31) further including color filters formed on the imaging lens side of the pixels, in which
the ultrawide-angle reading method is a method of adding and reading the electrical signal of each of the pixels having the color filters of respective colors for each pixel block including a plurality of the pixels, and the wide-angle reading method is a method of individually reading the electrical signal for each of the pixels.
   (33)

The imaging apparatus according to (32), in which
the pixels having the color filters for the same color in the pixel block share a charge holding unit that holds the charge, and
the ultrawide-angle reading method is a method of reading the electrical signal corresponding to the charge held in the charge holding unit.
   (34)

The imaging apparatus according to any one of (29) to (33), further including
a phase contrast detection unit that detects a phase contrast of the electrical signal due to parallax of a plurality of the adjacent photoelectric conversion units. It should be understood by those skilled in the art that various modifications, combinations, sub-combinations and alterations may occur depending on design requirements and other factors insofar as they are within the scope of the appended claims or the equivalents thereof.

### REFERENCE SIGNS LIST

11 Ultrawide-angle camera
105 Signal processing section
116 Imaging lens
133 Imaging element
133a Imaging surface
151 Pixel array portion
160 Pixel
201 Photoelectric conversion unit
202 Charge holding unit
255 Color filter
421 Lens group
422 Aperture stop
431 Lens
431a Surface
432 to 437 Lens
437a Surface
451 Lens group
452 Aperture stop
461 Lens
461a Surface
462 to 467 Lens
467a Surface
481 Lens group
482 Aperture stop
491 Lens
491a Surface
492 to 497 Lens
497a Surface
511 Lens group
512 Aperture stop
521 Lens
521a Surface
522 to 527 Lens
522a Surface
531 Lens group
532 Aperture stop
541 Lens
541a Surface
542 to 547 Lens
547a Surface
561 Lens group
562 Aperture stop
571 Lens
571a Surface
572 to 577 Lens
577a Surface
591 Lens group
592 Aperture stop
601 Lens
601a Surface
602 to 607 Lens
607a Surface
621 Lens group
622 Aperture stop
631 Lens
631a Surface
632 to 637 Lens
637a Surface
651 Lens group
652 Aperture stop
661 Lens
661a Surface
662 to 667 Lens
667a Surface
681 Lens group
682 Aperture stop
691 Lens
691a Surface
692 to 697 Lens
697a Surface
711 Lens group
712 Aperture stop
721 Lens
721a Surface
722 to 726 Lens
726a Surface
741 Lens group
742 Aperture stop
751 Lens
751a Surface
752 to 757 Lens
757a Surface
812 Ultrawide-angle camera
820 Ultrawide-angle sensor
821 Imaging element
823 Signal processing section
830, 840 Pixel

What is claimed is:

1. An imaging lens, comprising:
a lens group of one or more lenses which forms an optical image of an object on an imaging surface having a curved shape, wherein
a maximum angle of view is 90 degrees or larger, and
when a first imaging height that is an imaging height in a case where a half angle of view is 40 degrees is denoted by Yw, a second imaging height that is an imaging height in a case of a maximum half view angle which is a half of the maximum angle of view is denoted by Y, a total optical length that is a distance on an optical axis from an object-side surface of a lens closest to an object in the lens group to the imaging surface is denoted by TL, a focal length of the entire imaging lens is denoted by f, and a focal length of the lens closest to the object is denoted by f1, the following expressions are satisfied
$$0.27 \leq {( Yw / Y )}^{2} \leq 0.7 \\ 0.3 \leq TL / 2 Y \leq 0.695 \\ - 0.35 \leq f / f 1 \leq 0.73 .$$

2. The imaging lens according to claim 1, wherein
the lens group includes six or more lenses including at least one aspherical lens, and
an F value is 2.5 or smaller.

3. The imaging lens according to claim 1, wherein, when a peripheral illumination ratio with respect to a center of the imaging surface in a case where the half angle of view is 40 degrees is denoted by RIYw and the maximum half view angle is denoted by ω, the following expression is satisfied
$$1.2 \leq RIYw / ( {cos ( ω )}^{4} ) \leq 35.$$

4. The imaging lens according to claim 1, wherein, when a distance of a light beam having the second imaging height on an optical axis from the imaging surface to an exit pupil is denoted by EXPY and a curvature radius of a center of the imaging surface is denoted by Ri, the following expression is satisfied
$$0.01 \leq EXPY / Ri \leq 0.39 .$$

5. The imaging lens according to claim 1, wherein, when the second imaging height is denoted by Y, and a distance on an optical axis from an imaging-surface-side surface of a lens closest to the imaging surface in the lens group to the imaging surface is denoted by fb, the following expression is satisfied
$$9.7 \leq fb \times 2 Y \leq 28.4 .$$

6. The imaging lens according to claim 1, further comprising:
an aperture stop, wherein
when a curvature radius of a center of the imaging surface is denoted by Ri and a distance on an optical axis from the aperture stop to the imaging surface is denoted by Ts, the following expression is satisfied
$$- 50 \leq Ri / Ts \leq - 1.95 .$$

7. The imaging lens according to claim 1, wherein
the imaging surface is concavely curved toward the object side, and
an imaging-surface-side surface of a lens closest to the imaging surface in the lens group is a spherical surface concave toward the object side or an aspherical surface concave toward the object side as a whole in which a sign of an inclination of the surface is not reversed while a distance from the optical axis increases.

8. The imaging lens according to claim 1, wherein
the imaging surface has an aspherical shape curved concavely toward the object side, and
a displacement amount of the imaging surface with respect to a spherical surface increases in a direction in which the imaging surface is away from the imaging lens while a distance from the optical axis increases.

9. The imaging lens according to claim 1, wherein, when optical distortion at the second imaging height is denoted by DY, optical distortion at the first imaging height is denoted by Dw, the second imaging height is denoted by Y, and the first imaging height is denoted by Yw, the following expression is satisfied
$$- 0.16 \leq ( DY - Dw ) / ( Y - Yw ) \leq 0.16 .$$

10. The imaging lens according to claim 1, wherein, when a maximum effective radius of the object-side surface of the lens closest to the object is denoted by Ha and a maximum effective radius of an imaging-surface-side surface of a lens closest to the imaging surface in the lens group is denoted by Hb, the following expression is satisfied
$$0.475 \leq Ha / Hb \leq 0.68 .$$

11. The imaging lens according to claim 1, further comprising:
an aperture stop, wherein
when a distance on the optical axis from the aperture stop to the imaging surface is denoted by Ts and the total optical length is denoted by TL, the following expression is satisfied
$$0.73 \leq Ts / TL \leq 0.9 .$$

12. An imaging apparatus, comprising:
an imaging lens configured to
include a lens group of one or more lenses which forms an optical image of an object on an imaging surface having a curved shape,
have a maximum angle of view of 90 degrees or larger, and
satisfy the following expressions, when a first imaging height that is an imaging height in a case where a half angle of view is 40 degrees is denoted by Yw, a second imaging height that is an imaging height in a case of a maximum half view angle which is a half of the maximum angle of view is denoted by Y, a total optical length that is a distance on an optical axis from an object-side surface of a lens closest to an object in the lens group to the imaging surface is denoted by TL, a focal length of the entire imaging lens is denoted by f, and a focal length of the lens closest to the object is denoted by f1; and
$$0.27 \leq {( Yw / Y )}^{2} \leq 0.7 \\ 0.3 \leq TL / 2 Y \leq 0.695 \\ - 0.35 \leq f / f 1 \leq 0.73$$
an imaging element having the imaging surface, wherein
the imaging surface has a pixel array portion formed to include a plurality of pixels, and
each of the pixels has one or more photoelectric conversion units that convert light corresponding to the optical image formed on the imaging surface into a charge and outputs an electrical signal corresponding to the charge.

13. The imaging apparatus according to claim 12, further comprising
an image generating section that generates, based on the electrical signal read from each of the pixels, an ultrawide-angle image that is an image having an angle of view in a range from the maximum angle of view to a predetermined angle, or a wide-angle image that is an image having an angle of view smaller than the predetermined angle.

14. The imaging apparatus according to claim 13, wherein
an ultrawide-angle reading method which is a method of reading the electrical signal at a time of generating the ultrawide-angle image differs from a wide-angle reading method which is a method of reading the electrical signal at a time of generating the wide-angle image.

15. The imaging apparatus according to claim 14, further comprising
color filters formed on the imaging lens side of the pixels, wherein
the ultrawide-angle reading method is a method of adding and reading the electrical signal of each of the pixels having the color filters of respective colors for each pixel block including a plurality of the pixels, and
the wide-angle reading method is a method of individually reading the electrical signal for each of the pixels.

16. The imaging apparatus according to claim 15, wherein
the pixels having the color filters for the same color in the pixel block share a charge holding unit that holds the charge, and
the ultrawide-angle reading method is a method of reading the electrical signal corresponding to the charge held in the charge holding unit.

17. The imaging apparatus according to claim 12, further comprising
a phase contrast detection unit that detects a phase contrast of the electrical signal due to parallax of a plurality of the adjacent photoelectric conversion units.

18. An imaging lens, comprising:
a lens group of one or more lenses which forms an optical image of an object on an imaging surface having a curved shape, wherein
a maximum angle of view is 90 degrees or larger, and
when a first imaging height that is an imaging height in a case where a half angle of view is 40 degrees is denoted by Yw, a second imaging height that is an imaging height in a case of a maximum half view angle which is a half of the maximum angle of view is denoted by Y, a total optical length that is a distance on an optical axis from an object-side surface of a lens closest to an object in the lens group to the imaging surface is denoted by TL, and optical distortion at the first imaging height is denoted by Dw, the following expressions are satisfied
$$0.27 \leq {( Yw / Y )}^{2} \leq 0.7 \\ 0.3 \leq TL / 2 Y \leq 0.695 \\ 0.001 \leq \vert Dw / Yw \vert \leq 0.08 .$$

19. An imaging apparatus, comprising:
an imaging lens configured to
include a lens group of one or more lenses which forms an optical image of an object on an imaging surface having a curved shape,
have a maximum angle of view of 90 degrees or larger, and
satisfy the following expressions, when a first imaging height that is an imaging height in a case where a half angle of view is 40 degrees is denoted by Yw, a second imaging height that is an imaging height in a case of a maximum half view angle which is a half of the maximum angle of view is denoted by Y, a total optical length that is a distance on an optical axis from an object-side surface of a lens closest to an object in the lens group to the imaging surface is denoted by TL, and optical distortion at the first imaging height is denoted by Dw; and
$$0.27 \leq {( Yw / Y )}^{2} \leq 0.7 \\ 0.3 \leq TL / 2 Y \leq 0.695 \\ 0.001 \leq \vert Dw / Yw \vert \leq 0.08$$
an imaging element having the imaging surface, wherein
the imaging surface has a pixel array portion formed to include a plurality of pixels, and
each of the pixels has one or more photoelectric conversion units that convert light corresponding to the optical image formed on the imaging surface into a charge and outputs an electrical signal corresponding to the charge.
